(19) United States
(12) Patent Application Publication
(10) Pub. No.: US 2026/0278014 A1
(43) Pub. Date: Sep. 17, 2026

(54) Agentic Information Retrieval And Synthesis

(71) Applicant: Glean Technologies, Inc., San Francisco, CA (US)

(72) Inventors: Abhilash Samantapudi, San Francisco, CA (US); Rohan Dhoopar, New York, NY (US); Thai Tran, Palo Alto, CA (US); Matthew Zhao, San Jose, CA (US); Arvind Jain, Los Altos, CA (US)

(21) Appl. No.: 19/681,811

(22) Filed: May 19, 2026

Related U.S. Application Data
(63) Continuation-in-part of application No. 18/664,014, filed on May 14, 2024, now Pat. No. 12,681,999.
Application No. 18/664,014 is a continuation of application No. 17/179,352, filed on Feb. 18, 2021, now Pat. No. 11,995,135.
(60) Provisional application No. 63/757,760, filed on Feb. 12, 2025.
(60) Provisional application No. 63/775,868, filed on Mar. 21, 2025.
(60) Provisional application No. 63/794,652, filed on Apr. 25, 2025.
(60) Provisional application No. 63/798,431, filed on May 1, 2025.
(60) Provisional application No. 63/800,594, filed on May 6, 2025.
(60) Provisional application No. 63/804,412, filed on May 12, 2025.
(60) Provisional application No. 63/804,456, filed on May 12, 2025.
(60) Provisional application No. 63/808,426, filed on May 19, 2025.
(60) Provisional application No. 63/847,022, filed on Jul. 19, 2025.
(60) Provisional application No. 63/863,242, filed on Aug. 13, 2025.
(60) Provisional application No. 63/878,363, filed on Sep. 9, 2025.
(60) Provisional application No. 63/878,395, filed on Sep. 9, 2025.
(60) Provisional application No. 63/878,430, filed on Sep. 9, 2025.
(60) Provisional application No. 63/887,343, filed on Sep. 24, 2025.
(60) Provisional application No. 63/896,505, filed on Oct. 9, 2025.
(60) Provisional application No. 63/902,089, filed on Oct. 20, 2025.
(60) Provisional application No. 63/912,689, filed on Nov. 6, 2025.
(60) Provisional application No. 63/954,987, filed on Jan. 6, 2026.
(60) Provisional application No. 63/961,108, filed on Jan. 15, 2026.
(60) Provisional application No. 63/966,816, filed on Jan. 23, 2026.
(60) Provisional application No. 63/971,182, filed on Jan. 29, 2026.

(51) Int. Cl. G06F 16/951; G06F 16/903; G06F 16/9032; G06F 16/9035; G06F 16/93

(52) U.S. Cl. CPC G06F 16/951; G06F 16/90328; G06F 16/90344; G06F 16/9035; G06F 16/93

(57) ABSTRACT

Systems, methods, and products for agentic information retrieval and synthesis, including: receiving, by an artificial intelligence (AI) agent, a research task specifying an objective requiring synthesis of information from multiple sources; retrieving, by the AI agent, information responsive to the research task from a plurality of data sources; generating, by the AI agent, a research output that synthesizes content derived from the retrieved information; associating content of the research output with citation data that identifies corresponding retrieved information from the plurality of data sources; and outputting, by the AI agent, the research output including the citation data.

### CROSS REFERENCE TO RELATED APPLICATIONS

This is a continuation in-part application for patent entitled to a filing date and claiming the benefit of U.S. patent application Ser. No. 18/664,014, filed May 14, 2024, which is a continuation of U.S. patent application Ser. No. 17/179,352, filed Feb. 18, 2021, issued as U.S. Pat. No. 11,995,135 on May 28, 2024. This application also claims the benefit of earlier-filed: U.S. Provisional application No. 63,757,760, filed Feb. 12, 2025, U.S. Provisional application No. 63,775,868, filed Mar. 21, 2025, U.S. Provisional application No. 63,794,652, filed Apr. 25, 2025, U.S. Provisional application No. 63,798,431, filed May 1, 2025, U.S. Provisional application No. 63,800,594, filed May 6, 2025, U.S. Provisional application No. 63,804,412, filed May 12, 2025, U.S. Provisional application No. 63,804,456, filed May 12, 2025, U.S. Provisional application No. 63,808,426, filed May 19, 2025, U.S. Provisional application No. 63,847,022, filed Jul. 19, 2025, U.S. Provisional application No. 63,863,242, filed Aug. 13, 2025, U.S. Provisional application No. 63,878,363, filed Sep. 9, 2025, U.S. Provisional application No. 63,878,395, filed Sep. 9, 2025, U.S. Provisional application No. 63,878,430, filed Sep. 9, 2025, U.S. Provisional application No. 63,887,343, filed Sep. 24, 2025, U.S. Provisional application No. 63,896,505, filed Oct. 9, 2025, U.S. Provisional application No. 63,902,089, filed Oct. 20, 2025, U.S. Provisional application No. 63,912,689, filed Nov. 6, 2025, U.S. Provisional application No. 63,954,987, filed Jan. 6, 2026, U.S. Provisional application No. 63,961,108, filed Jan. 15, 2026, U.S. Provisional application No. 63,966,816, filed Jan. 23, 2026, and U.S. Provisional application No. 63/971,182, filed Jan. 29, 2026. Each of the above-listed applications are herein incorporated by reference in their entirety.

### BRIEF DESCRIPTION OF THE DRAWINGS

Like-numbered elements may refer to common components in the different figures.

FIG. 1 depicts one embodiment of a networked computing environment.

FIG. 2A depicts one embodiment of a search and knowledge management system in communication with one or more data sources.

FIG. 2B depicts one embodiment of the search and knowledge management system of FIG. 2A.

FIGS. 2C-2D depict embodiments of various components of a search and knowledge management system.

FIG. 3A depicts one embodiment of a mobile device providing a user interface for interacting with a permissions-aware search and knowledge management system.

FIG. 3B depicts one embodiment of the mobile device in FIG. 3A providing a user interface for interacting with the permissions-aware search and knowledge management system.

FIG. 3C depicts one embodiment of the mobile device in FIG. 3B after the user has selected and viewed content.

FIG. 3D depicts one embodiment of the mobile device in FIG. 3C after the user has starred a search result and submitted a verification request.

FIG. 3E depicts one embodiment of the mobile device in FIG. 3D after the user has pinned content to a user-specified search query.

FIG. 3F depicts one embodiment of the mobile device in FIG. 3E after the user has pinned the content for a first search result to a user-specified search query.

FIGS. 4A-4C depict a flowchart describing one embodiment of a process for aggregating, indexing, storing, and updating digital content that is searchable using a permissions-aware search and knowledge management system.

FIG. 5A depicts one embodiment of a directed graph with nodes corresponding with members or individuals of an organization.

FIG. 5B depicts one embodiment of an undirected graph with nodes corresponding with the employees E1 through E15 and managers M1 through M3.

FIG. 5C depicts one embodiment of a plurality of people clusters.

FIG. 5D depicts one embodiment of a staged approach for identifying sets of relevant documents for a given search query.

FIG. 5E depicts a flowchart describing one embodiment of a process for generating and displaying search results for a given search query.

FIG. 5F depicts a flowchart describing an alternative embodiment of a process for generating and displaying search results for a given search query.

FIG. 6 illustrates a multi-layered computing architecture representing a context-aware action orchestration system.

FIG. 7 illustrates an environment for collecting and organizing data from multiple sources and constructing contextual and predictive models derived from that data.

FIG. 8 illustrates a framework for coordinating predictive analysis, reasoning, and orchestration of processes to transform contextual data into recommendations or actions.

FIG. 9 illustrates an orchestration framework for managing event detection, planning, and execution within a continuously adaptive computing environment.

FIG. 10 illustrates a predictive-analysis framework configured to evaluate contextual information and predict likely future events, actions, or outcomes.

FIG. 11 illustrates a reasoning and planning framework for generating execution plans from task predictions.

FIG. 12 sets forth a flowchart of an example method of agentic information retrieval and synthesis in accordance with some embodiments of the present disclosure.

FIG. 13 sets forth a flowchart of an additional example method of agentic information retrieval and synthesis in accordance with some embodiments of the present disclosure.

FIG. 14 sets forth a flowchart of an additional example method of agentic information retrieval and synthesis in accordance with some embodiments of the present disclosure.

FIG. 15 sets forth a flowchart of an additional example method of agentic information retrieval and synthesis in accordance with some embodiments of the present disclosure.

FIG. 16 sets forth a flowchart of an additional example method of agentic information retrieval and synthesis in accordance with some embodiments of the present disclosure.

FIG. 17 sets forth a flowchart of an additional example method of agentic information retrieval and synthesis in accordance with some embodiments of the present disclosure.

FIG. 18 illustrates an exemplary computing device that may be specifically configured to perform one or more of the processes described herein.

FIG. 19 sets forth a block diagram of a cloud service provider service architecture in accordance with some embodiments of the present disclosure.

### DETAILED DESCRIPTION

Technology described herein dynamically generates and applies automated search evaluation sets to improve search results and to automatically detect and correct search system issues over time. A search evaluation set may comprise a set of search evaluation vectors that each map a search query and corresponding properties of the search query to a canonical search result. A search evaluation vector may be associated with a degree of confidence in a canonical search result based on one or more click quality metrics used for determining the canonical search result. The one or more click quality metrics may measure how relevant a search user found a clicked search result to be and may include a number of times that a search result was selected from a search results page, a page ranking of the search result when the search result was selected, and a length of time that a user spent viewing and/or editing a document corresponding with the selected search result. The canonical search result may be deemed the correct search result for the search query and the corresponding properties of the search query. The properties of the search query may include a group identifier (or group ID) assigned to one or more search users, a username associated with a search user who submitted the search query, a timestamp associated with when the search query was last submitted to the search system, a number of times that the search query (or a semantically equivalent search query) was submitted to the search system within a threshold period of time (e.g., within the past two weeks), a language in which the search query was entered (e.g., in English or Spanish), and a location or region associated with where the search query was entered (e.g., a city region or country).

In some cases, a search evaluation vector may comprise a search evaluation triplet comprising a search query, a group identifier (or group ID) associated with the search query, and a canonical search result for the search query and the group ID. In one example, a first search evaluation vector associated with a first group ID for the search query “quarterly goals” may map to a first canonical search result (e.g., linking to a first document) and a second search evaluation vector associated with a second group ID different from the first group ID for the same search query “quarterly goals” may map to a second canonical search result (e.g., linking to a second document) different from the first canonical search result. In other cases, a search evaluation vector may comprise a search query, a group ID corresponding with a user or group of users of a search system, a canonical search result for the search query and the group ID, and a timestamp corresponding with a date and time at which the canonical search result was determined or set. The timestamp may be used to determine an age of a search evaluation vector and the search system may use the timestamp to detect when a canonical search result should be renewed based upon updated feedback from search users. The canonical search result for a search query and a group ID may be determined based on implicit and/or explicit feedback from one or more search users of the search system.

Implicit feedback may include a click history, a document viewing history, and/or a document editing history of search results. A search user may click on a search result to open a document linked from the search result and to edit the document. From the displayed search results for a submitted search query, a search user may view and/or edit a particular document referenced by the search results for at least a threshold period of time (e.g., may view or edit a referenced document for at least two minutes). The search system may track the length of time that the particular document remained open, the amount of scrolling within the particular document, and the number of changes made to the particular document. In one embodiment, if the same search user or another user within the same group as the search user (e.g., both users have been assigned the same group ID) views and edits the particular document (e.g., makes at least one change to the particular document) after two different searches for the same search query (or semantically equivalent search queries), then the particular document may be identified as a canonical search result for the search query. In another embodiment, if a search user and another search user that have both been assigned the same group ID view and edit a particular document within search results for the same search query (or semantically equivalent search queries), then the particular document may be identified as a canonical search result for the search query. In another embodiment, if a search user views or edits a particular document within search results for a search query and another user had created an answer for a question that is semantically equivalent to the search query that included the particular document, then the particular document may be identified as a canonical search result for the search query.

Explicit feedback may include user suggested results, such as user “starring” in which a search user may select from a list of search results what their preferred search result is for a given search query. In some cases, if two or more search users within the same group (or assigned the same group ID) select the same search result (e.g., a link to the same document) for the same search query (or semantically equivalent search queries), then the search result may be identified as a canonical search result for the search query. In one embodiment, a canonical search result may be identified if a plurality of different search users (e.g., at least two different search users) assigned to the same group ID “star” the same search result for the same search query (or semantically equivalent search queries). Explicit feedback from one or more search users may also include document pinning, in which a user or a document owner of a document “pins” a user-specified search query to the document for a user-specified period of time (e.g., for two months). In one embodiment, a canonical search result may be identified if a first search user pins a search query to a particular document and a second search user views and/or edits the particular document in response to search results for the same search query (or semantically equivalent search queries). In another embodiment, a canonical search result may be identified if a first search user stars a search result in response to search results for a search query and a second search user views and/or edits a particular document referenced by the starred search result in response to search results for the same search query (or semantically equivalent search queries).

Explicit search user feedback via pinning and/or starring by a single user (or a group of users) may be used to identify the canonical search result for search queries that are semantically equivalent on a per user basis or a per group basis. In some cases, a canonical search result may be identified after a threshold number of search users (e.g., more than two search users assigned to the same group ID) “star” a particular search result for the same (or semantically equivalent) search query. In one example, the resulting search query, group ID, and canonical search result may form a search evaluation triplet (search query, group ID, canonical search result) that is added to a set of search evaluation triplets that may be used to automatically detect and correct search system issues over time.

In some embodiments, in order to detect search system issues over time, baseline search result rankings may be periodically generated (e.g., determined and stored every 24 hours) or automatically generated after code updates have been made. Two consecutive baseline search result rankings using the same search evaluation set may then be compared to detect result deviations in search result rankings. In one example, the “starring” feature that moves or boosts “starred” search results towards the top search result may be disabled, a first search may be performed for a first search query associated with a first search evaluation vector, a first search result rank (or position within an ordered list of search results) for the canonical search result associated with the first search evaluation vector may be identified, search system code and/or resources may be updated or modified, a second search may then be performed for the first search query associated with the first search evaluation vector, a second search result rank for the canonical search result associated with the first search evaluation vector may be identified, and a comparison between the first search result rank and the second search result rank may be performed to detect a deviation (e.g., a positive or negative deviation) in search result rankings.

A positive deviation may occur when the position of a search result improves or moves towards a higher ranking search result. For example, if the first search result rank generated from the first search corresponded with the second highest ranking search result (e.g., the second search result in an ordered list of search results) and the second search result rank generated from the second search corresponded with the highest ranking search result (e.g., the top search result in an ordered list of search results), then a positive deviation has occurred. Conversely, a negative deviation may occur when the position of a search result declines or moves towards a lower ranking search result. For example, if the first search result rank generated from the first search corresponded with the highest ranking search result (e.g., the top search result in an ordered list of search results) and the second search result rank generated from the second search corresponded with the second highest ranking search result (e.g., the second search result below the top search result in an ordered list of search results), then a negative deviation has occurred.

A search system may generate a first baseline search result ranking before updating or modifying software for the search system and then generate a second baseline search result ranking after the software for the search system has been updated or modified. A result deviation may be computed for each canonical search result associated with a search evaluation vector within a set of search evaluation vectors. For example, if the set of search evaluation vectors comprises ten thousand search evaluation vectors, then ten thousand result deviations may be computed. If the search system detects that at least a threshold number of result deviations have exceeded a specified deviation amount (e.g., at least fifty result deviations correspond with a ranking position change of more than three positions), then the search system may detect that a search system anomaly has occurred and perform subsequent actions to automatically detect and correct search system issues. In one embodiment, the number of result deviations may correspond with either positive or negative deviations. In another embodiment, the number of result deviations may correspond with only negative deviations.

In some embodiments, upon detection that a search system anomaly has occurred, the search system may first determine a number of software or code changes that occurred since a first baseline search result rankings was generated, undo (or reverse) the software or code changes that were made since the first baseline search result ranking was generated, generate a third baseline search result ranking, and compute result deviations using the first baseline search result ranking and the third baseline search result ranking. In some cases, as canonical search results may age over time, the search system may remove all search evaluation vectors with canonical search results that were set more than a threshold period of time in the past (e.g., were set more than one month ago) and/or all search evaluation vectors with canonical search results corresponding with documents that were updated subsequent to the canonical search result being set, generate a third baseline search result ranking, and then compute result deviations for the remaining search evaluation vectors using a subset of the first baseline search result ranking and a subset of the third baseline search result ranking.

If the search system detects that less than a threshold number of result deviations exceed the specified deviation amount (e.g., less than fifty result deviations correspond with a ranking position change of more than three positions), then the search system may determine that the software or code changes were the source of the result deviations and may output an alert that the software or code changes caused a search system malfunction and maintain the rolled back state of the search software. Otherwise, if the search system detects that at least a threshold number of result deviations still exceed the specified deviation amount (e.g., at least fifty result deviations correspond with a ranking position change of more than three positions), then the search system may determine that the software or code changes were not the source of the result deviations and may automatically check for the loss of a data source, check for the loss of access to a data source, check for the removal of a data source data from a search index for the search system, and/or automatically generate and transit an alert message that at least a threshold number of result deviations exceed the specified deviation amount. The search system may automatically check data source connections in response to detecting that a software or code change was not the root cause of the threshold number of result deviations occurring. The search system may automatically update a search evaluation set in response to detecting that a software or code change was not the root cause of the threshold number of result deviations occurring. In one example, the search system may test that each document associated with a canonical search result is still accessible or retrievable and if a document is no longer accessible or retrievable, then a corresponding search evaluation vector may be removed from the search evaluation set.

In some embodiment, comparing baseline search result rankings may be used for regression testing purposes to confirm that a particular software or code change did not adversely affect search system performance and/or to confirm that a particular system change (e.g., the addition of a new server, data repository, data store, database, application, or software tool) did not adversely affect search system performance. In some cases, baseline search result rankings may be determined daily or hourly and compared with prior baseline search result rankings in order to detect significant changes in search result rankings for search queries within a search evaluation set. In some embodiments, comparing baseline search result rankings may be used to detect that a software or code change has improved search results by detecting that at least a threshold number of positive deviations have occurred (e.g., at least fifty result deviations correspond with an increase in the ranking position).

One technical benefit of a search system periodically comparing baseline search result rankings and/or comparing baseline search result rankings before and after software or code changes is that the search system may automatically detect and correct search system issues (e.g., repairing failed network connections to data sources or automatically rolling back software updates that cause unexpected issues), thereby improving search engine performance and improving the quality and relevance of search results provided to users of the search system. Moreover, periodically generating and applying search evaluation sets to automatically detect and correct search system issues leads to more efficient use of computer and memory resources as fewer searches may be required by users of the search system in order to located information.

One technical issue with ranking and displaying the most relevant search results for a user's search query is that content within an organization may be unique to the organization or to a particular group within the organization (e.g., containing words or phrases that are unique to the organization and/or that are undecipherable outside of the organization) and the corpus of documents that includes content unique to the organization or the particular group may be small in number (e.g., less than 200 documents). In some cases, different groups within an organization may work with different documents and use language that is group specific (e.g., acronyms and project codenames that are specific to a group within the organization). Moreover, unlike shared web pages on the Internet that may be searched and viewed by billions of people, documents and content within an organization may be searched and viewed by only a small number of users (e.g., less than 500 people within an organization) who are looking for specific, unrepeated information related to the organization. The presence of unique content and the limited number of search interactions from a small number of users within an organization makes learning from usage patterns and user feedback difficult.

In some embodiments, to test the performance of a first search algorithm (e.g., the current algorithm) and a second search algorithm (e.g., an algorithm with proposed updates), a search evaluation set may be used to calculate scores for how well the two search ranking algorithms performed. For a given search query from the search evaluation set, the first search algorithm may rank the “canonical result” document at position 5 while the second search algorithm may rank the “canonical result” document at position 3. To analyze the search results for a particular deployment or customer, the average ranked position of canonical search results, the ratio of wins to losses, as well as the number of big wins and big losses (e.g., ranking position changes of more than five positions) may be computed and compared. One technical issue is that some search users may select a high ranking result merely because it is listed as a top result. To mitigate this search placement bias, a degree of confidence in a canonical search result that isn't a high ranking result (e.g., below the 5th position) or that required user effort for selection (e.g., page scrolling) may be boosted. Moreover, customized search evaluation sets may be developed to test the performance of long queries (e.g., with more than 5 terms) or for queries with proper nouns.

In some cases, the permissions-aware search and knowledge management system may customize search results for each user or for a particular subset of users less than all of the users (e.g., for each member of a group) using deep learning models that take into account the work functions of each user (e.g., whether a user is a code developer or a member of an accounting team), the working relationships between each user and other people within an organization (e.g., the members of an organization within a particular relationship distance of the user), the work history of each user (e.g., which projects or teams that the user has worked with in the past), a physical and geographical location of the user, and/or the terms and phrases unique to an organization or group to which the user is assigned. For example, the rankings and search results for a search query of “quarterly goals for ACME” may be customized per user to take into account whether the user is a software engineer within an engineering group located in Canada or a sales account executive within a sales and marketing group located within India. The deep learning models may be trained using a set of labeled training data and neural network architectures that contain many layers. In some cases, deep learning models may be referred to as deep neural networks. The term “deep” in “deep learning” may refer to the number of layers through which data is transformed or the number of hidden layers within a neural network (e.g., more than three hidden layers).

The permissions-aware search and knowledge management system may enable digital content (or content) stored across a variety of local and cloud-based data stores to be indexed, searched, and displayed to authorized users. The searchable content may comprise data or text embedded within electronic documents, hypertext documents, text documents, web pages, electronic messages, instant messages, database fields, digital images, and wikis. An enterprise or organization may restrict access to the digital content over time by dynamically restricting access to different sets of data to different groups of people using access control lists (ACLs) or authorization lists that specify which users or groups of users of the permissions-aware search and knowledge management system may access, view, or alter particular sets of data. A user of the permissions-aware search and knowledge management system may be identified via a unique username or a unique alphanumeric identifier. In some cases, an email address or a hash of the email address for the user may be used as the primary identifier for the user. To determine whether a user executing a search query has sufficient access rights to view particular search results, the permissions-aware search and knowledge management system may determine the access rights via ACLs for sets of data (e.g., for multiple electronic documents) underlying the particular search results at the time that the search is executed by the user or prior to the display of the particular search results to the user (e.g., the access rights may have been set when the sets of data underlying the particular search results were indexed).

To determine the most relevant search results for the user's search query, the permissions-aware search and knowledge management system may identify a number of relevant documents within a search index for the searchable content that satisfy the user's search query. The relevant documents (or items) may then be ranked by determining an ordering of the relevant documents from the most relevant document to the least relevant document. A document may comprise any piece of digital content that can be indexed, such as an electronic message or a hypertext document. A variety of different ranking signals or ranking factors may be used to rank the relevant documents for the user's search query. In some embodiments, the identification and ranking of the relevant documents for the user's search query may take into account user suggested results from the user and/or other users (e.g., from co-workers within the same group as the user or co-located at the same level within a management hierarchy), the amount of time that has elapsed since a user suggested result was established, whether the underlying content was verified by a content owner of the content as being up-to-date or approved content, the amount of time that has elapsed since the underlying content was verified by the content owner, and the recent activity of the user and/or related group members (e.g., a co-worker within the same group as the user recently discussed a particular subject related to the executed search query within a messaging application within the past week).

One type of user suggested result comprises a document pinning, in which a user or a document owner “pins” a user-specified search query to a document for a user-specified period of time. In one example, a user Sally may attach a user-specified search query, such as “my favorite cookie recipe,” to a particular document for one month. In some cases, the permissions-aware search and knowledge management system may identify possessive pronouns and/or possessive adjectives within the user-specified search query (e.g., via a list of common possessive pronouns and adjectives) and replace the possessive pronouns and possessive adjectives with corresponding user identifiers (e.g., replacing “my” with “SallyB123-45-6789”). In another example, a document owner of a recipe document may pin the user-specified search query of “Sally's cookies from summer camp” to the recipe document for a three-month time period. In some cases, the permissions-aware search and knowledge management system may identify personal names within the user-specified search query and replace the personal names with corresponding user identifiers (e.g., replacing “Sally” with “SallyB123-45-6789”). The user-specified search query for the pinned document specified by the document owner may include terms that do not appear within the pinned document. Therefore, document pinning allows a user or document owner to add searchable context to the pinned document that cannot be derived from the document itself. For example, the user-specified search query for the pinned document may include a term that comprises neither a word match nor a synonym for any word within the pinned document. One technical benefit of allowing a user of the permissions-aware search and knowledge management system or a document owner to pin a user-specified search query to a document for a particular period of time (e.g., for the next three months) is that terms that are not found in the document or that cannot be derived from the contents of the document may be specified and subsequently searched in order to find the document, thereby improving the quality and relevance of search results.

In some embodiments, the permissions-aware search and knowledge management system may allow a user to search for content and resources across different workplace applications and data sources that are authorized to be viewed by the user. The permissions-aware search and knowledge management system may include a data ingestion and indexing path that periodically acquires content and identity information from different data sources and then adds them to a search index. The data sources may include databases, file systems, document management systems, cloud-based file synchronization and storage services, cloud-based applications, electronic messaging applications, and workplace collaboration applications. In some cases, data updates and new content may be pushed to the data ingestion and indexing path. In other cases, the data ingestion and indexing path may utilize a site crawler or periodically poll the data sources for new, updated, and deleted content. As the content from different data sources may contain different data formats and document types, incoming documents may be converted to plain text or to a normalized data format. The search index may include portions of text, text summaries, unique words, terms, and term frequency information per indexed document. In some cases, the text summaries may only be provided for documents that are frequently searched or accessed. A text summary may include the most relevant sentences, key words, personal names, and locations that are extracted from a document using natural language processing (NLP). The search index may include enterprise specific identifiers, such as employee names, employee identification numbers, and workplace group names, related to the searchable content per indexed document. The search index may also store user permissions or access rights information for the searchable content per indexed document.

The permissions-aware search and knowledge management system may aggregate ranking signals across the different workplace applications and data sources. The ranking signals may include recent search and messaging activity of co-workers of a search user. The ranking signals may also include user suggested results, such as document “pinning” in which an electronic document or message is pinned to a particular search query (e.g., a user-specified set of relevant key words) for a specified period of time (e.g., the document pin will expire after 60 days). The pin may automatically renew if the electronic document or message is accessed at least at a threshold number of times within the specified period of time or if the electronic document or message has been set into a verified state by an owner of the electronic document or message. The user suggested results may also include user “starring” in which a search user may select from a displayed search results page what their preferred search result is for a given search query. The user suggested results including user pinning and user starring may be used to boost the ranking of search results for a particular user, as well as to boost the ranking of search results for others within the same workgroup as the particular user. The permissions-aware search and knowledge management system may utilize natural language processing (NLP) and deep-learning models in order to identify semantic meaning within documents and search queries.

In some embodiments, the permissions-aware search and knowledge management system may identify user activity information associated with searchable content, such as the number of recent edits, downloads, likes, shares, accesses, and views for the searchable content. For a searchable document, the popularity of the document based on the user activity information may be time dependent and may be determined on a per group basis. The recent activity of a user and fellow group members (e.g., co-workers within the same department or group as the user) may be used to compute a document popularity for the group (or sub-group). A user may be a member of a child group (e.g., an engineering sub-group) that is a member of a parent group (e.g., a group comprising all engineering sub-groups). The document popularity values per group may be stored within the search index and the determination of the appropriate document popularity value to apply during ranking may be determined at search time. In some cases, the time period for gathering user activity statistics may be adjusted based on group size. For example, the time period for gathering user activity statistics may be adjusted from 60 days to 30 days if a sub-group is more than ten people; in this case, smaller groups of less than ten people will utilize user activity statistics over a longer time duration. The level of granularity for the user activity statistics applied to scoring a document may be determined based on the number of people within the sub-group or the number of searches performed by the sub-group.

The permissions-aware search and knowledge management system may also incorporate crosslinking by leveraging an organization's communications channel to generate ranking signals for documents (e.g., using whether a document was referenced or linked in an electronic message or posting as a user activity signal for the document). In one example, the message text for a message within a persistent chat channel may comprise user generated content that is linked with a referenced document that is referenced within the message to improve search results for the referenced document. In some cases, the crosslinking of the user generated content comprising the message text with the referenced document may only be created if the message text was generated by the document owner or someone within the same group as the document owner. In one example, a document owner may provide message text (e.g., a description of a referenced document) within a persistent chat channel along with a link to the referenced document; in this case, a crosslinking of the message text with the referenced document may be created because the message text was submitted by the document owner. In some cases, a document owner may be more knowledgeable about the contents of a document and may be more likely to provide a reliable description for the contents of the document. In other cases, the crosslinking of the user generated content comprising the message text with the referenced document may be created irrespective of document ownership of the referenced document.

There are several search user interactions that may be used to establish associations between search queries and corresponding searchable documents for ranking purposes. The associations between a search query and one or more searchable documents may be stored within a table, database, or search index. If a semantically similar search query is subsequently issued, then the ranking of searchable documents with previously established associations may be boosted. These search user interactions may include a user pinning the document to a search query, a user starring a document as the best search result for a search query, a user clicking on a search result link to a document after submitting a search query, and a user discussing a document or linking to the document during a question and answer exchange within a communication channel (e.g., within a persistent chat channel or an electronic messaging channel). If the answer to a question during a conversation exchange within the communication channel included a link or other reference to a document, then the message text associated with the question may be associated with the referenced document.

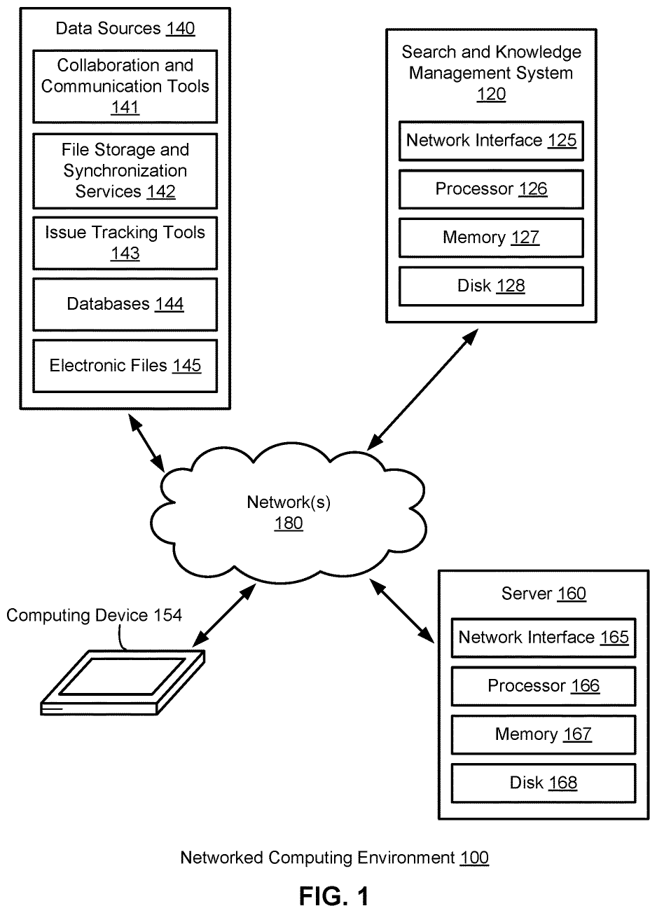

FIG. 1 depicts one embodiment of a networked computing environment 100 in which the disclosed technology may be practiced. The networked computing environment 100 includes a search and knowledge management system 120, one or more data sources 140, server 160, and a computing device 154 in communication with each other via one or more networks 180. The networked computing environment 100 may include a plurality of computing devices interconnected through one or more networks 180. The networked computing environment 100 may correspond with or provide access to a cloud computing environment providing Software-as-a-Service (SaaS) or Infrastructure-as-a-Service (IaaS) services. The one or more networks 180 may allow computing devices and/or storage devices to connect to and communicate with other computing devices and/or other storage devices. In some cases, the networked computing environment 100 may include other computing devices and/or other storage devices not shown. The other computing devices may include, for example, a mobile computing device, a non-mobile computing device, a server, a workstation, a laptop computer, a tablet computer, a desktop computer, or an information processing system. The other storage devices may include, for example, a storage area network storage device, a networked-attached storage device, a hard disk drive, a solid-state drive, a data storage system, or a cloud-based data storage system. The one or more networks 180 may include a cellular network, a mobile network, a wireless network, a wired network, a secure network such as an enterprise private network, an unsecure network such as a wireless open network, a local area network (LAN), a wide area network (WAN), the Internet, or a combination of networks.

In some embodiments, the computing devices within the networked computing environment 100 may comprise real hardware computing devices or virtual computing devices, such as one or more virtual machines. The storage devices within the networked computing environment 100 may comprise real hardware storage devices or virtual storage devices, such as one or more virtual disks. The read hardware storage devices may include non-volatile and volatile storage devices.

The search and knowledge management system 120 may comprise a permissions-aware search and knowledge management system that utilizes user suggested results, document verification, and user activity tracking to generate or rank search results. The search and knowledge management system 120 may enable content stored in storage devices throughout the networked computing environment 100 to be indexed, searched, and displayed to authorized users. The search and knowledge management system 120 may index content stored on various computing and storage devices, such as data sources 140 and server 160, and allow a computing device, such as computing device 154, to input or submit a search query for the content and receive authorized search results with links or references to portions of the content. As the search query is being typed or entered into a search bar on the computing device, potential additional search terms may be displayed to help guide a user of the computing device to enter a more refined search query. This autocomplete assistance may display potential word completions and potential phrase completions within the search bar.

As depicted in FIG. 1, the search and knowledge management system 120 includes a network interface 125, processor 126, memory 127, and disk 128 all in communication with each other. The network interface 125, processor 126, memory 127, and disk 128 may comprise real components or virtualized components. In one example, the network interface 125, processor 126, memory 127, and disk 128 may be provided by a virtualized infrastructure or a cloud-based infrastructure. Network interface 125 allows the search and knowledge management system 120 to connect to one or more networks 180. Network interface 125 may include a wireless network interface and/or a wired network interface. Processor 126 allows the search and knowledge management system 120 to execute computer readable instructions stored in memory 127 in order to perform processes described herein. Processor 126 may include one or more processing units, such as one or more CPUs and/or one or more GPUs. Memory 127 may comprise one or more types of memory (e.g., RAM, SRAM, DRAM, EEPROM, Flash, etc.). Disk 128 may include a hard disk drive and/or a solid-state drive. Memory 127 and disk 128 may comprise hardware storage devices.

In one embodiment, the search and knowledge management system 120 may include one or more hardware processors and/or one or more control circuits for performing a permissions-aware search in which a ranking of search results is outputted or displayed in response to a search query. The search results may be displayed using snippets or summaries of the content. In some embodiments, the search and knowledge management system 120 may be implemented using a cloud-based computing platform or cloud-based computing and data storage services.

The data sources 140 include collaboration and communication tools 141, file storage and synchronization services 142, issue tracking tools 143, databases 144, and electronic files 145. The data sources 140 may include a communication platform not depicted that provides online chat, threaded conversations, videoconferencing, file storage, and application integration. The data sources 140 may comprise software and/or hardware used by an organization to store its data. The data sources 140 may store content that is directly searchable, such as text within text files, word processing documents, presentation slides, and spreadsheets. For audio files or audiovisual content, the audio portion may be converted to searchable text using an audio to text converter or transcription application. For image files and videos, text within the images may be identified and extracted to provide searchable text. The collaboration and communication tools 141 may include applications and services for enabling communication between group members and managing group activities, such as electronic messaging applications, electronic calendars, and wikis or hypertext publications that may be collaboratively edited and managed by the group members. The electronic messaging applications may provide persistent chat channels that are organized by topics or groups. The collaboration and communication tools 141 may also include distributed version control and source code management tools. The file storage and synchronization services 142 may allow users to store files locally or in the cloud and synchronize or share the files across multiple devices and platforms. The issue tracking tools 143 may include applications for tracking and coordinating product issues, bugs, and feature requests. The databases 144 may include distributed databases, relational databases, and NoSQL databases. The electronic files 145 may comprise text files, audio files, image files, video files, database files, electronic message files, executable files, source code files, spreadsheet files, and electronic documents that allow text and images to be displayed consistently independent of application software or hardware.

The computing device 154 may comprise a mobile computing device, such as a tablet computer, that allows a user to access a graphical user interface for the search and knowledge management system 120. A search interface may be provided by the search and knowledge management system 120 to search content within the data sources 140. A search application identifier may be included with every search to preserve contextual information associated with each search. The contextual information may include the data sources and search rankings that were used for the search using the search interface.

A server, such as server 160, may allow a client device, such as the computing device 154, to download information or files (e.g., executable, text, application, audio, image, or video files) from the server or to enable a search query related to particular information stored on the server to be performed. The search results may be provided to the client device by a search engine or a search system, such as the search and knowledge management system 120. The server 160 may comprise a hardware server. In some cases, the server may act as an application server or a file server. In general, a server may refer to a hardware device that acts as the host in a client-server relationship or to a software process that shares a resource with or performs work for one or more clients. The server 160 includes a network interface 165, processor 166, memory 167, and disk 168 all in communication with each other. Network interface 165 allows server 160 to connect to one or more networks 180. Network interface 165 may include a wireless network interface and/or a wired network interface. Processor 166 allows server 160 to execute computer readable instructions stored in memory 167 in order to perform processes described herein. Processor 166 may include one or more processing units, such as one or more CPUs and/or one or more GPUs. Memory 167 may comprise one or more types of memory (e.g., RAM, SRAM, DRAM, EEPROM, Flash, etc.). Disk 168 may include a hard disk drive and/or a solid-state drive. Memory 167 and disk 168 may comprise hardware storage devices.

The networked computing environment 100 may provide a cloud computing environment for one or more computing devices. In one embodiment, the networked computing environment 100 may include a virtualized infrastructure that provides software, data processing, and/or data storage services to end users accessing the services via the networked computing environment. In one example, networked computing environment 100 may provide cloud-based work productivity applications to computing devices, such as computing device 154. The networked computing environment 100 may provide access to protected resources (e.g., networks, servers, storage devices, files, and computing applications) based on access rights (e.g., read, write, create, delete, or execute rights) that are tailored to particular users of the computing environment (e.g., a particular employee or a group of users that are identified as belonging to a particular group or classification). An access control system may perform various functions for managing access to resources including authentication, authorization, and auditing. Authentication may refer to the process of verifying that credentials provided by a user or entity are valid or to the process of confirming the identity associated with a user or entity (e.g., confirming that a correct password has been entered for a given username). Authorization may refer to the granting of a right or permission to access a protected resource or to the process of determining whether an authenticated user is authorized to access a protected resource. Auditing may refer to the process of storing records (e.g., log files) for preserving evidence related to access control events. In some cases, an access control system may manage access to a protected resource by requiring authentication information or authenticated credentials (e.g., a valid username and password) before granting access to the protected resource. For example, an access control system may allow a remote computing device (e.g., a mobile phone) to search or access a protected resource, such as a file, web page, application, or cloud-based application, via a web browser if valid credentials can be provided to the access control system.

In some embodiments, the search and knowledge management system 120 may utilize processes that crawl the data sources 140 to identify and extract searchable content. The content crawlers may extract content on a periodic bases from files, websites, and databases and then cause portions of the content to be transferred to the search and knowledge management system 120. The frequency at which the content crawlers extract content may vary depending on the data source and the type of data being extracted. For example, a first update frequency (e.g., every hour) at which presentation slides or text files with infrequent updates are crawled may be less than a second update frequency (e.g., every minute) at which some websites or blogging services that publish frequent updates to content are crawled. In some cases, files, websites, and databases that are frequently searched or that frequently appear in search results may be crawled at the second update frequency (e.g., every two minutes) while other documents that have not appeared in search results within the past two days may be crawled at the first update frequency (e.g., once every two hours). The content extracted from the data sources 140 may be used to build a search index using portions of the content or summaries of the content. The search and knowledge management system 120 may extract metadata associated with various files and include the metadata within the search index. The search and knowledge management system 120 may also store user and group permissions within the search index. The user permissions for a document with an entry in the search index may be determined at the time of a search query or at the time that the document was indexed. A document may represent a single object that is an item in the search index, such as a file, folder, or a database record.

After the search index has been created and stored, then search queries may be accepted and ranked search results to the search queries may be generated and displayed. Only documents that are authorized to be accessed by a user may be returned and displayed. The user may be identified based on a username or email address associated with the user. The search and knowledge management system 120 may acquire one or more ACLs or determine access permissions for the documents underlying the ranked search results from the search index that includes the access permissions for the documents. The search and knowledge management system 120 may process a search query by passing over the search index and identifying content information that matches the search terms of the search query and synonyms for the search terms. The content associated with the matched search terms may then be ranked taking into account user suggested results from the user and others, whether the underlying content was verified by a content owner within a past threshold period of time (e.g., was verified within the past week), and recent messaging activity by the user and others within a common grouping. The authorized search results may be displayed with links to the underlying content or as part of personalized recommendations for the user (e.g., displaying an assigned task or a highly viewed document by others within the same group).

To generate the search index, a full crawl in which the entire content from a data source is fetched may be performed upon system initialization or whenever a new data source is added. In some cases, registered applications may push data updates; however, because the data updates may not be complete, additional full crawls may be performed on a periodic basis (e.g., every two weeks) to make sure that all data changes to content within the data sources are covered and included within the search index. In some cases, the rate of the full crawl refreshes may be adjusted based on the number of data update errors detected. A data update error may occur when documents associated with search results are out of date due to content updates or when documents associated with search results have had content changes that were not reflected in the search index at the time that the search was performed. Each data source may have a different full crawl refresh rate. In one example, full crawls on a database may be performed at a first crawl refresh rate and full crawls on files associated with a website may be performed at a second crawl refresh rate greater than the first crawl refresh rate.

An incremental crawl may fetch only content that was modified, added, or deleted since a particular time (e.g., since the last full crawl or since the last incremental crawl was performed). In some cases, incremental crawls or the fetching of only a subset of the documents from a data source may be performed at a higher refresh rate (e.g., every hour) on the most searched documents or for documents that have been flagged as having a at least a threshold number of data update errors, or that have been newly added to the organization's corpus that are searchable. In other cases, incremental crawls may be performed at a higher refresh rate (e.g., content changes are fetched every ten minutes) on a first set of documents within a data source in which content deletion occurs at a first deletion rate (e.g., some content is deleted at least every hour) and performed at a lower refresh rate (e.g., content changes are fetched every hour) on a second set of documents within the data source in which content deletion occurs at a second deletion rate (e.g., content deletions occur on a weekly basis). One technical benefit of performing incremental crawls on a subset of documents within a data source that comprise frequently searched documents or documents that have a high rate of data deletions is that the load on the data source may be reduced and the number of application programming interface (API) calls to the data source may be reduced.

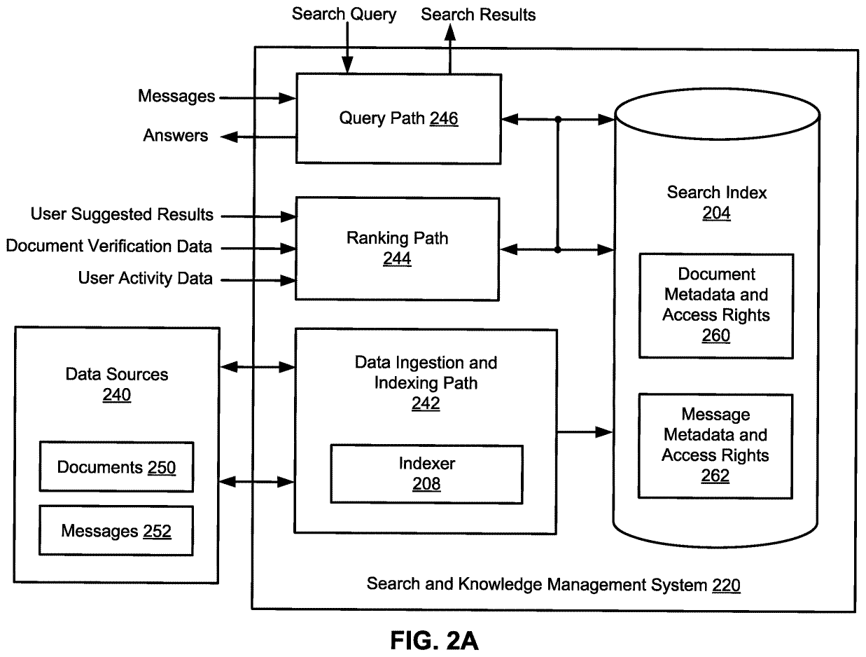

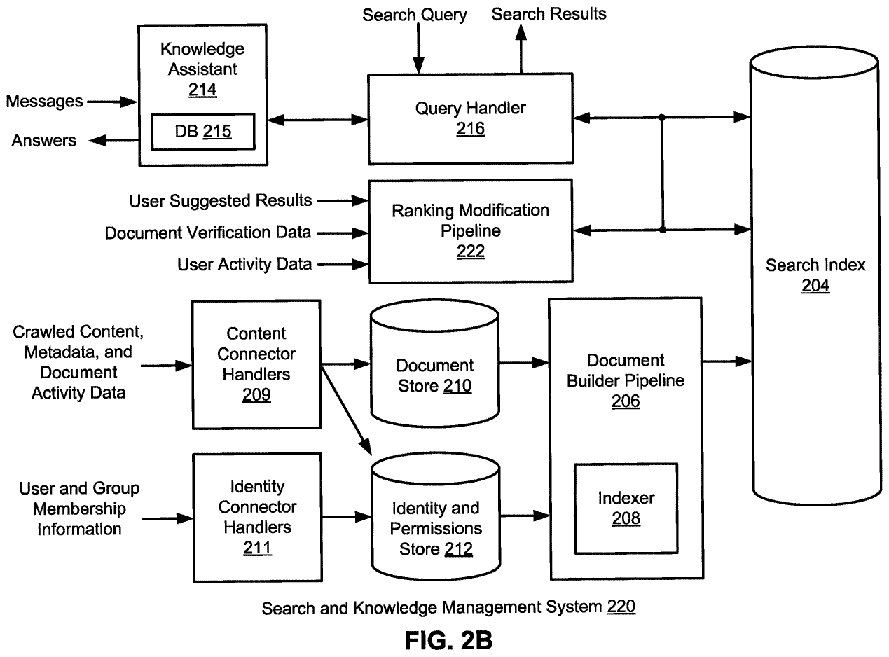

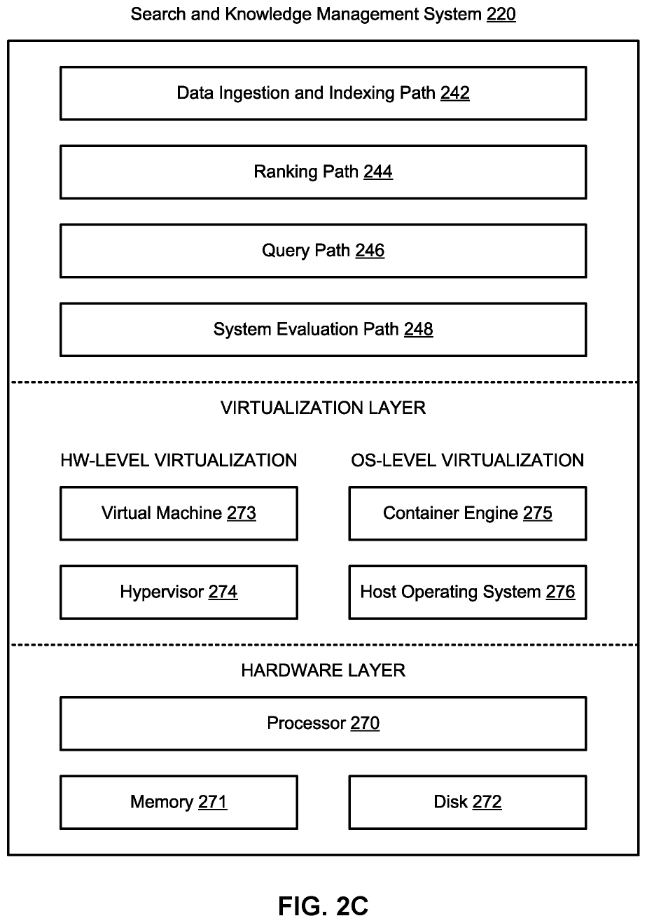

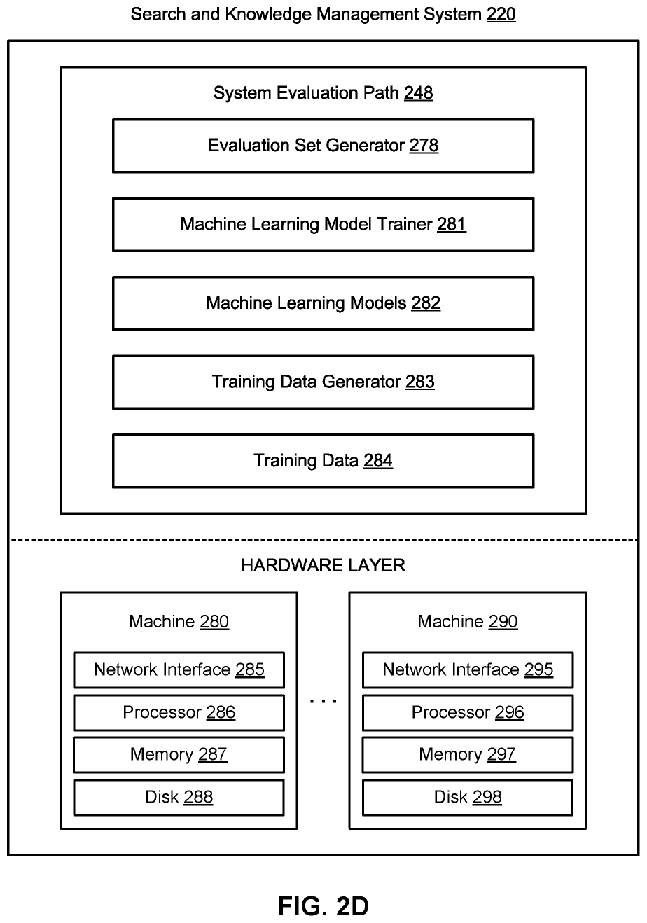

FIG. 2A depicts one embodiment of a search and knowledge management system 220 in communication with one or more data sources 240. In one embodiment, the search and knowledge management system 220 may comprise one implementation of the search and knowledge management system 120 in FIG. 1 and the data sources 240 may correspond with the data sources 140 in FIG. 1. The data sources 240 may include one or more electronic documents 250 and one or more electronic messages 252 that are stored over various networks, document and content management systems, file servers, database systems, desktop computers, portable electronic devices, mobile phones, cloud-based applications, and cloud-based services.

The search and knowledge management system 220 may comprise a cloud-based system that includes a data ingestion and index path 242, a ranking path 244, a query path 246, and a search index 204. The search index 204 may store a first set of index entries for the one or more electronic documents 250 including document metadata and access rights 260 and a second set of index entries for the one or more electronic messages 252 including message metadata and access rights 262. The data ingestion and index path 242 may crawl a corpus of documents within the data sources 240, index the documents and extract metadata for each document fetched from the data sources 240, and then store the metadata in the search index 204. An indexer 208 within the data ingestion and index path 242 may write the metadata to the search index 204. In one example, if a fetched document comprises a text file, then the metadata for the document may include information regarding the file size or number of words, an identification of the author or creator of the document, when the document was created and last modified, key words from the document, a summary of the document, and access rights for the document. The query path 246 may receive a search query from a user computing device, such as the computing device 154 in FIG. 1, and compare the search query and terms derived from the search query (e.g., synonyms and related terms) with the search index 204 to identify relevant documents for the search query. The query path 246 may also include or interface with an automated digital assistant that may interact with a user of the user computing device in a conversational manner in which answers are outputted in response to messages or questions provided to the automated digital assistant.

The relevant documents may be ranked using the ranking path 244 and then a set of search results responsive to the search query may be outputted to the user computing device corresponding with the ranking or ordering of the relevant documents. The ranking path 244 may take into consideration a variety of signals to score and rank the relevant documents. The ranking path 244 may determine the ranking of the relevant documents based on the number of times that a search query term appears within the content or metadata for a document, whether the search query term matches a key word for a document, and how recently a document was created or last modified. The ranking path 244 may also determine the ranking of the relevant documents based on user suggested results from an owner of a relevant document or the user executing the search query, the amount of time that has passed since the user suggested result was established, whether a document was verified by a content owner, the amount of time that has passed since the relevant document was verified by the content owner, and the amount and type of activity performed with a past period of time (e.g., within the past hour) by the user executing the search query and related group members.

FIG. 2B depicts one embodiment of the search and knowledge management system 220 of FIG. 2A. The search and knowledge management system 220 may comprise a cloud-based system that includes a data ingestion and indexing path, a ranking path, a query path, and a search index 204. The components of the search and knowledge management system 220 may be implemented using software, hardware, or a combination of hardware and software. In some cases, a cloud-based task service for asynchronous execution, cloud-based task handlers, or a cloud-based system for managing the execution, dispatch, and delivery of distributed tasks may be used to implement the fetching and processing of content from various data sources, such as data sources 240 in FIG. 2A. In some cases, a cloud-based task service or a cloud-based system for managing the execution, dispatch, and delivery of distributed tasks may be used to acquire and synchronize user and group identifications associated with content fetched from the various data sources. The data sources may have dedicated task queues or shared task queues depending on the size of the data source and the rate requirements for fetching the content. In one example, a data source may have a dedicated task queue if the data source stores more than a threshold number of documents or more than a threshold amount of content (e.g., stores more than 100 GB of data).

The data ingestion and indexing path is responsible for periodically acquiring content and identity information from the data sources 240 in FIG. 2A and adding the content and identity information or portions thereof to the search index 204. The data ingestion and indexing path includes content connector handlers 209 in communication with document store 210. The document store 210 may comprise a key value store database or a cloud-based database service. The content connector handlers 209 may comprise software programs or applications that are used to traverse and fetch content from one or more data sources. The content connector handlers 209 may make API calls to various data sources, such as the data sources 240 in FIG. 2A, to fetch content and data updates from the data sources. Each data source may be associated with one content connector for that data source. The content connector handlers 209 may acquire content, metadata, and activity data corresponding with the content. For example, the content connector handlers 209 may acquire the text of a word processing document, metadata for the word processing document, and activity data for the word processing document. The metadata for the word processing document may include an identification of the owner of the document, a timestamp associated with when the document was last modified, a file size for the document, and access permissions for the document. The activity data for the word processing document may include the number of views for the document within a threshold period of time (e.g., within the past week or since the last update to the document occurred), the number of likes for the document, the number of downloads for the document, and the number of shares associated with the document. The content connector handlers 209 may store the fetched content, metadata, and activity data in the document store 210 and publish the fetch event to a publish-subscribe (pubsub) system not depicted so that the document builder pipeline 206 may be notified that the fetch event has occurred. In response to the notification, the document builder pipeline 206 may process the fetched content and add the fetched content and information derived from the fetched content to the search index 204. The document builder pipeline 206 may transform or augment the fetched content prior to storing the information derived from the fetched content in the search index 204. In one example, the document builder pipeline 206 may augment the fetched content with identity information and synonyms.

Some data sources may utilize APIs that provide notification (e.g., via webhook pings) to the content connector handlers 209 that content within a data source has been modified, added, or deleted. For data sources that are not able to provide notification that content updates have occurred or that cannot push content changes to the content connector handlers 209, the content connector handlers 209 may perform periodic incremental crawls in order to identify and acquire content changes. In some cases, the content connector handlers 209 may perform periodic incremental crawls or full crawls even if a data source has provided webhook pings in the past in order to ensure the integrity of the acquired content and that the search and knowledge management system 220 is consistent with the actual state of the content stored in the data source. Some data sources may allow applications to register for callbacks or push notifications whenever content or identity information has been updated at the data source.

As depicted in FIG. 2B, the data ingestion and indexing path also includes identity connector handlers 211 in communication with identity and permissions store 212. The identity and permissions store 212 may comprise a key value store database or a cloud-based database service. The identity connector handlers 211 may acquire user and group membership information from one or more data sources and store the user and group membership information in the identity and permissions store 212 to enable search results that respect data source specific privacy settings for the content stored using the one or more data sources. The user information may include data source specific user information, such as a data source specific user identification or username. The identity connector handlers 211 may comprise software programs or applications that are used to acquire and synchronize user and/or group identities to a primary identity used by the search and knowledge management system 220 to uniquely identify a user. Each user of the search and knowledge management system 220 may be canonically represented via a unique primary identity, which may comprise a hash of an email address for the user. In some cases, the search and knowledge management system 220 may map an email address that is used as the primary identity for a user to an alphanumeric username used by a data source to identify the same user. In other cases, the search and knowledge management system 220 may map a unique alphanumeric username that is used as the primary identity for a user to two different usernames that are used by a data source to identify the same user, such as one username associated with regular access permissions and another username associated with administrative access permissions. If a data source does not identify a user by the user's primary identity within the search and knowledge management system 220, then an external identity that identifies the user for that data source may be determined by the search and knowledge management system 220 and mapped to the primary identity.

In some cases, the content connector handlers 209 may fetch access rights and permissions settings associated with the fetched content during the content crawl and store the access rights and permission settings using the identity and permissions store 212. For some data sources, the identity crawl to obtain user and group membership information may be performed before the content crawl to obtain content associated with the user and group membership information. When a document is fetched during the content crawl, the content connector handlers 209 may also fetch the ACL for the document. The ACL may specify the allowed users with the ability to view or access the document, the disallowed users that do not have access rights to view or access the document, allowed groups with the ability to view or access the document, and disallowed groups that do not have access rights to view or access the document. The ACL for the document may indicate access privileges for the document including which individuals or groups have read access to the document.

In some cases, a particular set of data may be associated with an ACL that determines which users within an organization may access the particular set of data. In one example, to ensure compliance with data security and retention regulations, the particular set of data may comprise sensitive or confidential information that is restricted to viewing by only a first group of users. In another example, the particular set of data may comprise source code and technical documentation for a particular product that is restricted to viewing by only a second group of users.

As depicted in FIG. 2B, the document store 210 may store crawled content from various data sources, along with any transformation or processing of the content that occurs prior to indexing the crawled content. Every piece of content acquired from the data sources may correspond with a row in the document store 210. For example, when the content connector handlers 209 fetch a spreadsheet or word processing document from a data source, the raw content for the spreadsheet or word processing document may be stored as a row in the document store 210. In addition to the raw content, a row in the document store 210 may also include interaction or activity data associated with the content, such as the number of views, the number of comments, the number of likes, and the number of users who interacted with the content along with their corresponding user identifications. A row in the document store 210 may also include document metadata for the stored content, such as keywords or classification information, and permissions or access rights information for the stored content.

The identity and permissions store 212 may store the primary identity for a user (e.g., a hash of an email address) within the search and knowledge management system 220 and corresponding usernames or data source identifiers used by each data source for the same user. A row in the identity and permissions store 212 may include a mapping from the user identifier used by a data source to the corresponding primary identity for the user for the search and knowledge management system 220. The identity and permissions store 212 may also store identifications for each user assigned to a particular group or associated with a particular group membership. The ACLs that are associated with a fetched document may include allowed user identifications and allowed group identifications. Each user of the search and knowledge management system 220 may correspond with a unique primary identity and each primary identity may be mapped to all groups that the user is a member of across all data sources.

As depicted in FIG. 2B, the data ingestion and indexing path includes document builder pipeline 206 in communication with search index 204. The document builder pipeline 206 may comprise software programs or applications that are used to transform or augment the crawled content to generate searchable documents that are then stored within the search index 204. The document builder pipeline 206 may include an indexer 208 that writes content derived from the fetched content, structured metadata for the fetched content, and access rights for the fetched content to the search index 204.

The searchable documents generated by the document builder pipeline 206 may comprise portions of the crawled content along with augmented data, such as access right information, document linking information, search term synonyms, and document activity information. In one example, the document builder pipeline 206 may transform the crawled content by extracting plain text from a word processing document, a hypertext markup language (HTML) document, or a portable document format (PDF) document and then directing the indexer 208 to write the plain text for the document to the search index 204. A document parser may be used to extract the plain text for the document or to generate clean text for the document that can be indexed (e.g., with HTML tags or text formatting tags removed). The document builder pipeline 206 may also determine access rights for the document and write the identifications for the users and groups with access rights to the document to the search index 204. The document builder pipeline 206 may determine document linking information for the crawled document, such as a list of all the documents that reference the crawled document and their anchor descriptions, and store the document linking information in the search index 204. The document linking information may be used to determine document popularity (e.g., based on how many times a document is referenced or the number of outlinks from the document) and preserve searchable anchor text for target documents that are referenced. The words or terms used to describe an outgoing link in a source document may provide an important ranking signal for the linked target document if the words or terms accurately describe the target document. The document builder pipeline 206 may also determine document activity information for the crawled document, such as the number of document views, the number of comments or replies associated with the document, and the number of likes or shares associated with the document, and store the document activity information in the search index 204.

The document builder pipeline 206 may be subscribed to publish-subscribe events that get written by the content connector handlers 209 every time new documents or updates are added to the document store 210. Upon notification that the new documents or updates have been added to the document store 210, the document builder pipeline 206 may perform processes to transform or augment the new documents or portions thereof prior to generating the searchable documents to be stored within the search index 204.

As depicted in FIG. 2B, the query path includes a query handler 216 in communication with the search index 204 and the ranking modification pipeline 222. A knowledge assistant 214 interacts with the query handler 216 to provide a real-time automated digital assistant that may interact with a user of the search and knowledge management system 220 via a graphical user interface in a conversational manner using natural language dialog. The automated digital assistant may comprise a computer-implemented assistant that may access and display only information that a user's access rights permit. The knowledge assistant 214 may include a frequently asked questions (FAQ) database that includes question and answer pairs for questions identified within a chat channel that were classified as factual questions. The FAQ database may be stored in database DB 215 or in a solid-state memory not depicted.

The query handler 216 may comprise software programs or applications that detect that a search query has been submitted by an authenticated user identity, parse the search query, acquire query metadata for the search query, identify a primary identity for the authenticated user identity, acquire ranked search results that satisfy the search query using the primary identity and the parsed search query, and output (e.g., transfer or display) the ranked search results that satisfy the search query or that comprise the highest ranking of relevant information for the search query and the query metadata. The search query may be parsed by acquiring an inputted search query string for the search query and identifying root terms or tokenized terms within the search query string, such as unigrams and bigrams, with corresponding weights and synonyms. In some cases, natural language processing algorithms may be used to identify terms within a search query string for the search query. The search query may be received as a string of characters and the natural language processing algorithms may identify a set of terms (or a set of tokens) from the string of characters. Potential spelling errors for the identified terms may be detected and corrected terms may be added or substituted for the potentially misspelled terms.

The query metadata may include synonyms for terms identified within the search query and nearest neighbors with semantic similarity (e.g., with semantic similarity scores above a threshold that indicate their similarity to each other at the semantic level). The semantic similarity between two texts (e.g., each comprising one or more words) may refer to how similar the two texts are in meaning. A supervised machine learning approach may be used to determine the semantic similarity between the two texts in which training data for the supervised step may include sentence or phrase pairs and the associated labels that represent the semantic similarly between the sentence or phrase pairs. The query handler 216 may consume the search query as a search query string, and then construct and issue a set of queries related to the search query based on the terms identified within the search query string and the query metadata. In response to the set of queries being issued, the query handler 216 may acquire a set of relevant documents for the set of queries from the search index 204. The set of relevant documents may be provided to the ranking modification pipeline 222 to be scored and ranked for relevance to the search query. After the set of relevant documents have been ranked, a subset of the set of relevant documents may be identified (e.g., the top thirty ranked documents) based on the ranking and summary information or snippets may be acquired from the search index 204 for each document of the subset of the set of relevant documents. The query handler 216 may output the ranked subset of the set of relevant documents and their corresponding snippets to a computing device used by the authenticated user, such as the computing device 154 in FIG. 1.

Moreover, when a user issues a search query, the query handler 216 may determine the primary identity for the authenticated user and then query the identity and permissions store 212 to acquire all groups that the user is a member of across all data sources. The query handler 216 may then query the search index 204 with a filter that restricts the retrieved set of relevant documents such that the ACLs for the retrieved documents permit the user to access or view each of the retrieved set of relevant documents. In this case, each ACL should either specify that the user comprises an allowed user or that the user is a member of an allowed group.

The search index 204 may comprise a database that stores searchable content related to documents stored within the data sources 240 in FIG. 2A. The search index 204 may store text, title strings, chat message bodies, metadata, and access rights related to searchable content. For each searchable document, portions of text associated with the document, extracted key words, document classifications, and document summaries may be stored within the search index 204. For searchable electronic messages (e.g., searchable chat messages or email messages), the title, the message body of the original message, and the message bodies of related messages may be stored within the search index 204. For searchable question and answer responses, the message body of the question and the message body of the answer may be stored within the search index 204. A question and answer pair may derive from questions and answers made by the user or made by other users (e.g., co-workers) during a conversation exchange within a persistent chat channel or from dialog between an artificial intelligence powered digital assistant and the user within a chat channel. One example of an artificial intelligence powered digital assistant is the knowledge assistant 214 that may automatically output answers to messages or questions provided to the digital assistant. Text associated with other documents linked to or referenced by a searchable document, electronic message, or question and answer pair may also be stored within the search index 204 to provide context for the searchable content. Content access rights including which users and groups are allowed to access the content may be stored within the search index 204 for each piece of searchable content.

As depicted in FIG. 2B, the ranking modification pipeline 222 may comprise software programs or applications that are used to score and rank documents and portions of documents. The scoring of a set of relevant documents may weight different attributes of the documents differently. In one example, literal matches or lexical matches of search query terms within the body of a message or document may correspond with a first weighting while semantic matches of the search query terms may correspond with a second weighting different from the first weighting (e.g., greater than the first weighting). The matching of search query terms or their synonyms within a message body may be given a first weighting while the matching of the search query terms within a title field or within the text of a referencing document (e.g., anchor text within a source document) may be given a second weighting different from the first weighting (e.g., greater than the first weighting). The scoring and ranking of a set of relevant documents may take into consideration document popularity, which may change over time as a document ages or as the number of views for a document within a past period of time (e.g., within the past week) increases or decreases. A higher document popularity score may increase the ranking of a document, while a lower document popularity score may signal that the document has become stale and that its importance should be demoted. The ranking modification pipeline 222 may score and rank a set of relevant documents based on user suggested results submitted by owners of the relevant documents, the document verification statuses of the relevant documents, and the amount and type of user activity performed within a past period of time (e.g., within the past 24 hours) by the user executing a search query and others that are part of a common grouping with the user (e.g., co-workers on the same team or group).

FIG. 2C depicts an embodiment of various components of the search and knowledge management system 220 of FIG. 2A. As depicted, the search and knowledge management system 220 includes hardware-level components and software-level components. The hardware-level components may include one or more processors 270, one or more memory 271, and one or more disks 272. The software-level components may include software applications and computer programs. In some embodiments, the data ingestion and index path 242, the ranking path 244, the query path 246, and the system evaluation path 248 may be implemented using software or a combination of hardware and software. In some cases, the software-level components may be run using a dedicated hardware server. In other cases, the software-level components may be run using a virtual machine or containerized environment running on a plurality of machines. In various embodiments, the software-level components may be run from the cloud (e.g., the software-level components may be deployed using a cloud-based compute and storage infrastructure).

In some embodiments, the system evaluation path 248 may periodically generate search evaluation sets based on implicit and/or explicit feedback from one or more search users of the search and knowledge management system 220. The system evaluation path 248 may then apply the search evaluation sets to detect and correct search system issues periodically or after software and/or hardware updates to the search and knowledge management system 220 have occurred. In one example, the system evaluation path 248 may check for search result deviations every hour and automatically detect and correct search system issues in response to detecting search result deviations. The search system may detect a software update issue and automatically rollback the problematic software updates. The search system may detect loss of access to a data source and automatically reestablish communication with the data source or access to a document residing on the data source.

As depicted in FIG. 2C, the software-level components may also include virtualization layer processes, such as virtual machine 273, hypervisor 274, container engine 275, and host operating system 276. The hypervisor 274 may comprise a native hypervisor (or bare-metal hypervisor) or a hosted hypervisor (or type 2 hypervisor). The hypervisor 274 may provide a virtual operating platform for running one or more virtual machines, such as virtual machine 273. A hypervisor may comprise software that creates and runs virtual machine instances. Virtual machine 273 may include a plurality of virtual hardware devices, such as a virtual processor, a virtual memory, and a virtual disk. The virtual machine 273 may include a guest operating system that has the capability to run one or more software applications, such as applications for the data ingestion and index path 242, the ranking path 244, and the query path 246. The virtual machine 273 may run the host operation system 276 upon which the container engine 275 may run.

A container engine 275 may run on top of the host operating system 276 in order to run multiple isolated instances (or containers) on the same operating system kernel of the host operating system 276. Containers may facilitate virtualization at the operating system level and may provide a virtualized environment for running applications and their dependencies. Containerized applications may comprise applications that run within an isolated runtime environment (or container). The container engine 275 may acquire a container image and convert the container image into running processes. In some cases, the container engine 275 may group containers that make up an application into logical units (or pods). A pod may contain one or more containers and all containers in a pod may run on the same node in a cluster. Each pod may serve as a deployment unit for the cluster. Each pod may run a single instance of an application.

In some embodiments, a virtualized infrastructure manager not depicted may run on the search and knowledge management system 220 in order to provide a centralized platform for managing a virtualized infrastructure for deploying various components of the search and knowledge management system 220. The virtualized infrastructure manager may manage the provisioning of virtual machines, containers, and/or pods. In some cases, the virtualized infrastructure manager may perform various virtualized infrastructure related tasks, such as cloning virtual machines, creating new virtual machines, monitoring the state of virtual machines, and facilitating backups of virtual machines.

FIG. 2D depicts another embodiment of various components of the search and knowledge management system 220 of FIG. 2A. The search and knowledge management system 220 of FIG. 2A may utilize one or more machine learning models to determine a selection and ranking of relevant documents and/or to detect and correct search system issues using search evaluation sets. As depicted, the system evaluation path 248 includes evaluation set generator 278, machine learning model trainer 281, machine learning models 282, training data generator 283, and training data 284. The machine learning models 282 may comprise one or more machine learning models that are stored in a memory, such as memory 127 in FIG. 1 or memory 271 in FIG. 2C. The one or more machine learning models may be trained, executed, and/or deployed using one or more processors, such as processor 126 in FIG. 1 or processor 270 in FIG. 2C. The one or more machine learning models may include neural networks (e.g., deep neural networks), support vector machine models, decision tree-based models, k-nearest neighbor models, Bayesian networks, or other types of models such as linear models and/or non-linear models. A linear model may be specified as a linear combination of input features. A neural network may comprise a feed-forward neural network, recurrent neural network, or a convolutional neural network.

The search and knowledge management system 220 may also include a set of machines including machine 280 and machine 290. In some cases, the set of machines may be grouped together and presented as a single computing system. Each machine of the set of machines may comprise a node in a cluster (e.g., a failover cluster). The cluster may provide computing and memory resources for the search and knowledge management system 220. In one example, instructions and data (e.g., input feature data) may be stored within the memory resources of the cluster and used to facilitate operations and/or functions performed by the computing resources of the cluster. The machine 280 includes a network interface 285, processor 286, memory 287, and disk 288 all in communication with each other. Processor 286 allows machine 280 to execute computer readable instructions stored in memory 287 to perform processes described herein. Disk 288 may include a hard disk drive and/or a solid-state drive. The machine 290 includes a network interface 295, processor 296, memory 297, and disk 298 all in communication with each other. Processor 296 allows machine 290 to execute computer readable instructions stored in memory 297 to perform processes described herein. Disk 298 may include a hard disk drive and/or a solid-state drive. In some cases, disk 298 may include a flash-based SSD or a hybrid HDD/SSD drive.

In one embodiment, the depicted components of the search and knowledge management system 220 including the machine learning model trainer 281, machine learning models 282, training data generator 283, and training data 284 may be implemented using the set of machines. In another embodiment, one or more of the depicted components of the search and knowledge management system 220 may be run in the cloud or in a virtualized environment that allows virtual hardware to be created and decoupled from the underlying physical hardware.

The search and knowledge management system 220 may utilize the machine learning model trainer 281, machine learning models 282, training data generator 283, and training data 284 to implement supervised machine learning algorithms. Supervised machine learning may refer to machine learning methods where labeled training data is used to train or generate a machine learning model or set of mapping functions that maps input feature vectors to output predicted answers. The trained machine learning model may then be deployed to map new input feature vectors to predicted answers. Supervised machine learning may be used to solve regression and classification problems. A regression problem is where the output predicted answer comprises a numerical value. Regression algorithms may include linear regression, polynomial regression, and logistic regression algorithms. A classification problem is where the output predicted answer comprises a label (or an identification of a particular class). Classification algorithms may include support vector machine, decision tree, k-nearest neighbor, and random forest algorithms. In some cases, a support vector machine algorithm may determine a hyperplane (or decision boundary) that maximizes the distance between data points for two different classes. The hyperplane may separate the data points for the two different classes and a margin between the hyperplane and a set of nearest data points (or support vectors) may be determined to maximize the distance between the data points for the two different classes.

During a training phase, a machine learning model, such as one of the machine learning models 282, may be trained using the machine learning model trainer 281 to generate predicted answers using a set of labeled training data, such as training data 284. The training data 284 may be stored in a memory, such as memory 127 in FIG. 1 or memory 271 in FIG. 2C. In some cases, labeled data may be split into a training data set and an evaluation data set prior to or during the training phase. In some cases, the training data generator 283 may determine the training data set and the evaluation data set to be applied during the training phase. The training data set may correspond with historical data corresponding with a period of time (e.g., over the past year or month).

The machine learning model trainer 281 may implement a machine learning algorithm that uses a training data set from the training data 284 to train the machine learning model and uses the evaluation data set to evaluate the predictive ability of the trained machine learning model. The predictive performance of the trained machine learning model may be determined by comparing predicted answers generated by the trained machine learning model with the target answers in the evaluation data set (or ground truth values). For a linear model, the machine learning algorithm may determine a weight for each input feature to generate a trained machine learning model that can output a predicted answer. In some cases, the machine learning algorithm may include a loss function and an optimization technique. The loss function may quantify the penalty that is incurred when a predicted answer generated by the machine learning model does not equal the appropriate target answer. The optimization technique may seek to minimize the quantified loss. One example of an appropriate optimization technique is online stochastic gradient descent.

The programs within the system evaluation path 248 may configure one or more machine learning models to implement a machine learning classifier that categorizes input features into one or more classes (e.g., whether a search result deviation has been detected or not based on consecutive baseline search result rankings). The one or more machine learning models may be utilized to perform binary classification (assigning an input feature vector to one of two classes) or multi-class classification (assigning an input feature vector to one of three or more classes). The output of the binary classification may comprise a prediction score that indicates the probability that an input feature vector belongs to a particular class. In some cases, a binary classifier may correspond with a function that may be used to decide whether or not an input feature vector (e.g., a vector of numbers representing the input features) should be assigned to either a first class or a second class. The binary classifier may use a classification algorithm that outputs predictions based on a linear predictor function combining a set of weights with the input feature vector. For example, the classification algorithm may compute the scalar product between the input feature vector and a vector of weights and then assign the input feature vector to the first class if the scalar product exceeds a threshold value.

The number of input features (or input variables) of a labeled data set may be referred to as its dimensionality. In some cases, dimensionality reduction may be used to reduce the number of input features that are used for training a machine learning model. The dimensionality reduction may be performed via feature selection (e.g., reducing the dimensional feature space by selecting a subset of the most relevant features from an original set of input features) and feature extraction (e.g., reducing the dimensional feature space by deriving a new feature subspace from the original set of input features). With feature extraction, new features may be different from the input features of the original set of input features and may retain most of the relevant information from a combination of the original set of input features. In one example, feature selection may be performed using sequential backward selection and unsupervised feature extraction may be performed using principal component analysis.

In some embodiments, the machine learning model trainer 281 may train a first machine learning model with historical training data over a first time period (e.g., the past month) using a first number of input features and may train a second machine learning model with historical training data over a second time period greater than the first period of time (e.g., the past year) using a second number of input features less than the first number of input features. The machine learning model trainer 281 may perform dimensionality reduction to reduce the number of input features from a first number of input features (e.g., 500) to a second number of input features less than the first number of input features (e.g., 100).

The machine learning model trainer 281 may train the first machine learning model using one or more training or learning algorithms. For example, the machine learning model trainer 281 may utilize backwards propagation of errors (or backpropagation) to train a multi-layer neural network. In some cases, the machine learning model trainer 281 may perform supervised training techniques using a set of labeled training data. In other cases, the machine learning model trainer 281 may perform unsupervised training techniques using a set of unlabeled training data. The machine learning model trainer 281 may perform a number of generalization techniques to improve the generalization capability of the machine learning models being trained, such as weight-decay and dropout regularization.

In some embodiments, the training data 284 may include a set of training examples. In one example, each training example of the set of training examples may include an input-output pair, such as a pair comprising an input vector and a target answer (or supervisory signal). In another example, each training example of the set of training examples may include an input vector and a pair of outcomes corresponding with a first decision to perform a first action (e.g., to perform corrective actions because a search result deviation was detected) and a second decision to not perform the first action (e.g., to not perform corrective actions). In this case, each outcome of the pair of outcomes may be scored and a positive label may be applied to the higher scoring outcome while a negative label is applied to the lower scoring outcome.

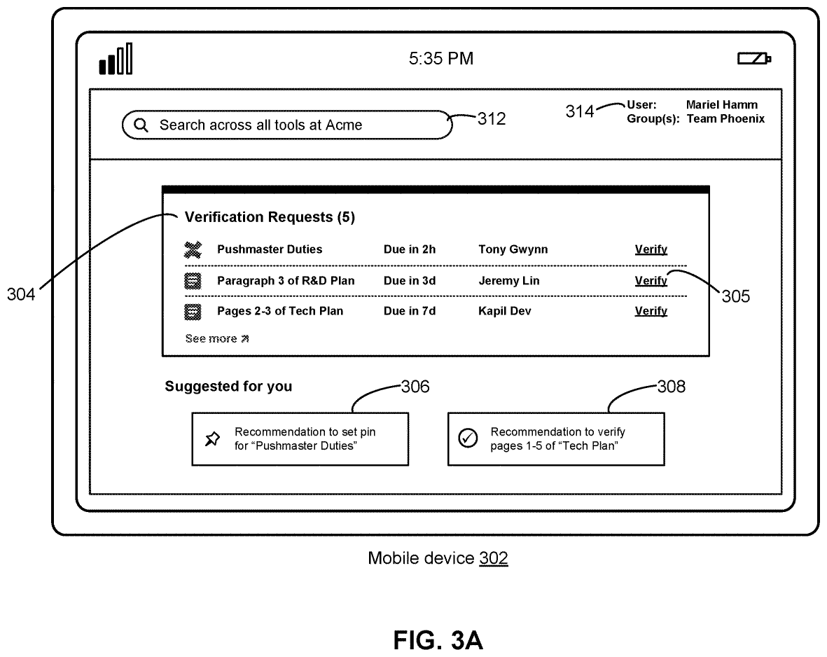

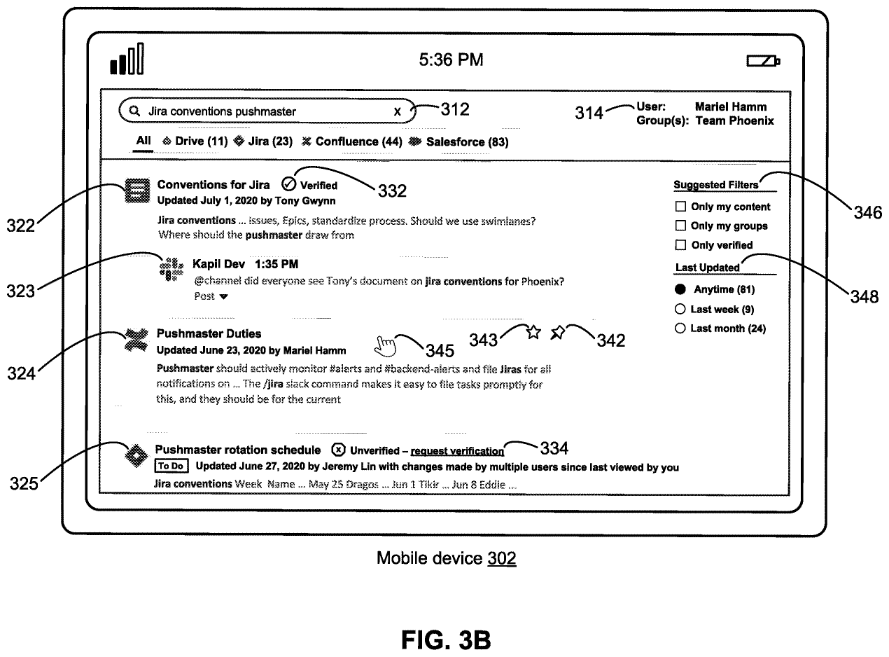

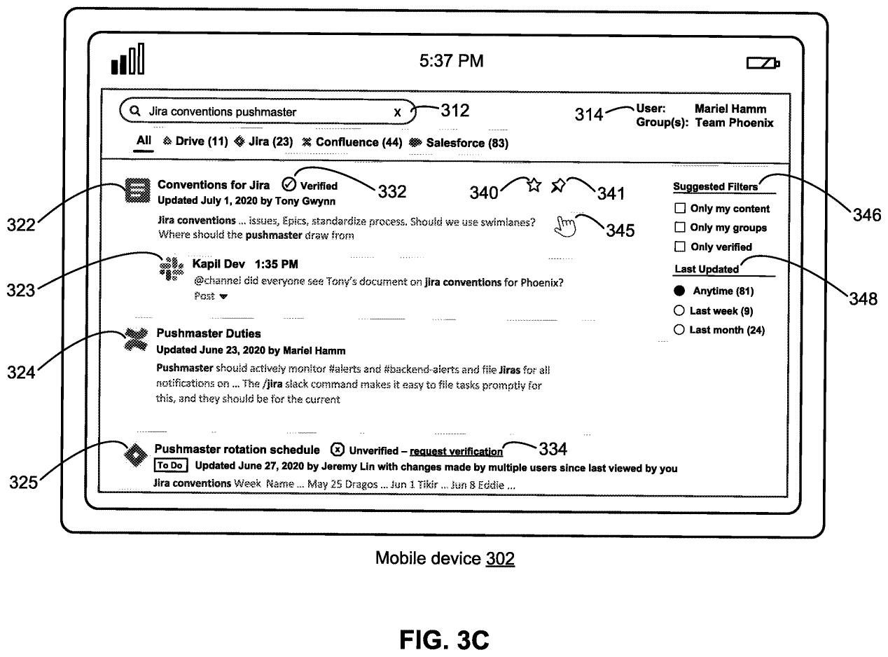

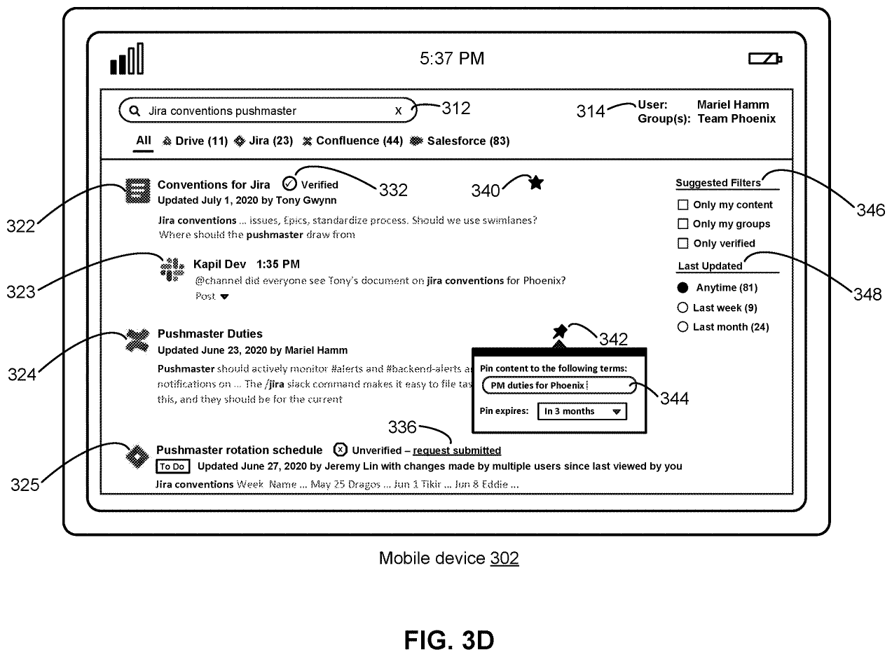

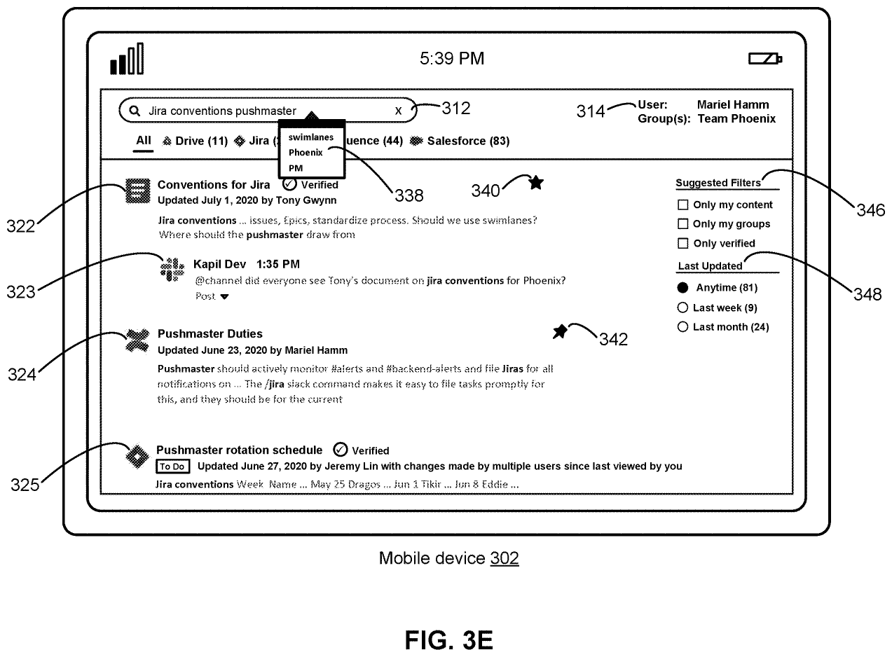

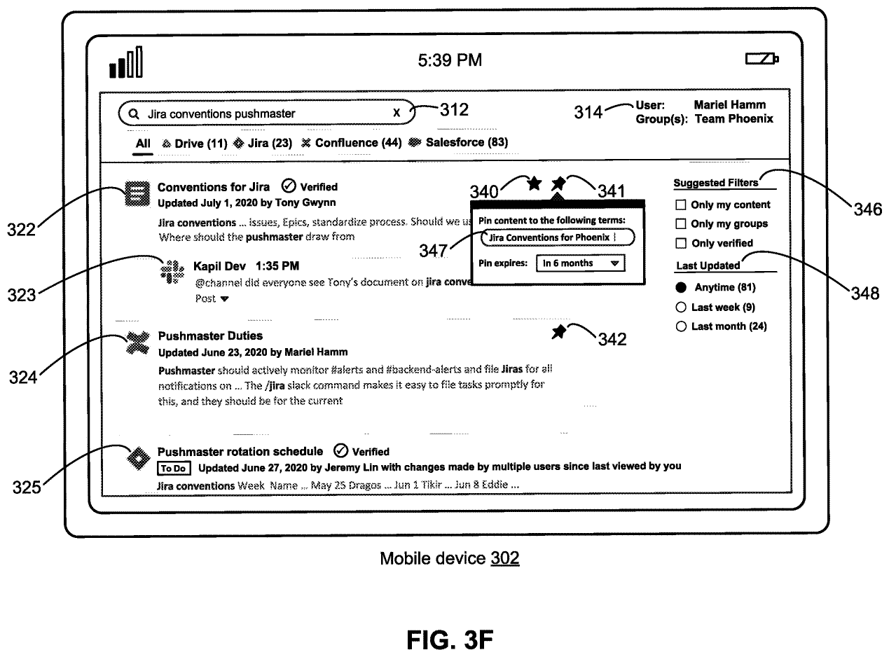

FIG. 3A depicts one embodiment of a mobile device 302 providing a user interface for interacting with a permissions-aware search and knowledge management system. In one example, the mobile device 302 may correspond with the computing device 154 in FIG. 1. The mobile device 302 may include a touchscreen display that displays a user interface to an end user of the mobile device 302. The mobile device 302 may display device status information regarding wireless signal strength, time, and battery life associated with the mobile device, as well as the user interface for controlling or interacting with the permissions-aware search and knowledge management system. The user interface may be provided via a web-browser or an application running on the mobile device. The user interface may include a search bar 312 that the end user of the mobile device 302 may use to enter and submit a search query with search terms and criteria for the permissions-aware search and knowledge management system. The end user of the mobile device 302 may be associated with a unique user identifier or username 314. The username 314 may map to one or more group identifiers or group names. For example, the username “Mariel Hamm” may map to a single group identifier “Team Phoenix.” A username may map to one or more group identifiers (e.g., a username may map to three different group identifiers associated with three different groups).

As depicted in FIG. 3A, a dashboard page may display a customized set of items that require urgent action by the user corresponding with the username 314 or that are commonly accessed by the user corresponding with the username 314. The customized set of items include verification requests 304 that comprise document verification requests from other users of the permissions-aware search and knowledge management system for particular documents that are owned by the username 314 to be verified as being up-to-date and approved by the user “Mariel Hamm.” The username 314 has ownership permissions or is deemed a document owner for the documents “Pushmaster Duties,” “R&D Plan,” and “Tech Plan.” The document verification requests may request that an entire document be verified or that a portion of a document be verified. For example, as depicted in FIG. 3A, the user “Jeremy Lin” has requested that only paragraph three of the document “R&D Plan” be verified and the user “Kapil Dev” has requested that pages two and three of the document “Tech Plan” be verified. The user of the graphical user interface may select to view and/or verify paragraph three of the document “R&D Plan” by selecting the verify widget or button 305. Along with the document verification requests submitted by the other users, suggested actions are displayed including a first suggested action 306 that provides an automated recommendation to set a document pin for the document “Pushmaster Duties” and a second suggested action 308 that provides an automated recommendation to verify pages 1-5 of the document “Tech Plan.”

In one embodiment, the first suggested action 306 to set a document pin may be automatically generated upon detection that at least a threshold number of other users have accessed (e.g., read or viewed) the document “Pushmaster Duties” and/or at least a threshold number of other users (e.g., at least ten other users) have starred the document “Pushmaster Duties” when performing searches. In another embodiment, the first suggested action 306 to set a document pin may be automatically generated upon detection that at least a threshold number of other users have starred the document “Pushmaster Duties” as their best search result for a given search query when the document “Pushmaster Duties” did not appear within a first number of the search results (e.g., did not appear within the first five search results). In one example, the first suggested action 306 to set a document pin for the document “Pushmaster Duties” may be automatically generated and displayed on the dashboard page in response to detecting that at least ten other users starred the document “Pushmaster Duties” when the document was not within the first three search results for their given search query.

In one embodiment, the second suggested action 308 to verify a portion of a document may be automatically generated upon detection that at least a threshold number of other users have accessed (e.g., read or viewed) the document “Tech Plan” or accessed a particular portion (e.g., a particular page) of the document “Tech Plan.” In another embodiment, the second suggested action 308 to verify pages one through five out of fifty total pages for the document “Tech Plan” may be automatically generated upon detection that at least a threshold number of data changes have occurred (e.g., that at least fifty words have been added, deleted, or altered) within pages one through five and/or at least a threshold number of other users have accessed the document “Tech Plan” within a past period of time (e.g., within the past three days).

FIG. 3B depicts one embodiment of the mobile device 302 in FIG. 3A providing a user interface for interacting with the permissions-aware search and knowledge management system. As depicted, the user corresponding with the username 314 has entered a search query with the search terms “Jira conventions pushmaster.” In response to the entered search query, the permissions-aware search and knowledge management system has generated and displayed four search results that comprise the four most relevant and highest ranked search results for the search query. Each search result may include a link to an underlying document, message, or web page and a snippet or summary of the relevant information found within the search result. Along with the displayed search results, the user interface also displays suggested filters 346 that allow the user to further narrow or filter the search results to only include “Only my content” content that comprises content that is owned or controlled by the user (e.g., only content for which the user has both read and write permissions), to only include “Only my groups” content that comprises content that is owned or controlled by either the user or other users who belong to the same groups as the user, or to only include “Only verified” content that comprises content that has been verified by the content owners or that has been set into a verified state by their content owners. The user interface also displays a last updated filter 348 that allows the user to further narrow or filter the search results based on when the content was last updated and/or created.

As depicted in FIG. 3B, the search results include a first search result 322 that includes a link to an electronic document “Conventions for Jira” that was last updated on Jul. 1, 2020 by another user “Tony Gwynn.” The electronic document “Conventions for Jira” was verified by the document owner and is currently in a verified state as indicated by the verified symbol 332. The search results include a second search result 323 that includes a link to an electronic message that was submitted by another user “Kapil Dev.” The electronic message references the electronic document “Conventions for Jira” from the first search result 322 and therefore the display of the second search result 323 is indented to indicate a relationship in which the second search result 323 references or links to the first search result 322. The search results include a third search result 324 that includes a link to a web-based wiki that is authored by the user “Mariel Hamm.” As the user has hovered over or positioned a mouse pointer 345 over the third search result 324, the user has the ability to select the pin icon 342 to “pin” the content to a particular search query or to select the star icon 343 to select the third search result 324 as the user's best search result for the entered search query. The particular search query specified by the user may be added to a search index as a key phrase for describing the content. As individuals within an organization may be deemed to be trustworthy, during subsequent searches, matching of the particular search query and/or the terms within the particular search query may cause boosted ranking scores even if the terms within the particular search query do not appear within the underlying content.

As depicted in FIG. 3B, the search results also include a fourth search result 325 that includes a link to an issue and project tracking entry. As the issue and project tracking entry has been visited or accessed by the user and/or other users within the same group “Team Phoenix” as the user at least a threshold number of times (e.g., at least five times), an automatic reminder that the link points to unverified content has been displayed and a verification request widget or button 334 has been provided to send a verification request to the content owners of the issue and project tracking entry. In some embodiments, an electronic document may comprise a collaborative document in which a plurality of users may have read and write access rights; in this case, a verification request may be automatically sent to each of the plurality of users or to only a single designated content owner.

FIG. 3C depicts one embodiment of the mobile device 302 in FIG. 3B after the user has selected and viewed content from the first search result 322 and the fourth search result 325. In some embodiments, after the user has selected a link and accessed the linked contents of a search result, the user interface may display a star icon, such as star icon 340 associated with the first search result 322. In other embodiments, the star icon 340 may be displayed if the search user has hovered over or positioned a mouse pointer 345 over the first search result 322. The user may select the star icon 340 in order to select the first search result 322 as the user's best search result for the entered search query. In one embodiment, the star icon 340 may be automatically selected if the user selected and followed the first search result 322 without returning to the search results page. In another embodiment, a star icon may be automatically selected if the user enters the same search query twice and subsequently follows the same search result twice without returning to the search results page.

FIG. 3D depicts one embodiment of the mobile device 302 in FIG. 3C after the user has selected the star icon 340 and selected the verification request widget or button 334 in FIG. 3C. In response, the user interface displays that the fourth search result 325 remains unverified and displays a verification request submission widget or button 336 to indicate that a verification request has been submitted to an owner of the content for the fourth search result 325. As depicted, the user has selected the pin icon 342 to pin the content underlying the third search result 324 to the user-specified search query 344 of “PM duties for Phoenix” for a period of three months. In some cases, the user may specify either a particular date or a particular period of time until the pin expires. The user-specified search query 344 includes the acronym “PM” and a term “Phoenix” that are not included within the linked content and that are not derivable from the linked content. The term “Phoenix” may be deemed to not be derivable from the linked content if a semantic match does not exist between the term and the linked content. In some embodiments, the content for the third search result 324 may be pinned to the user-specified search query through the search results page, the dashboard page, or applications for editing/displaying content.

FIG. 3E depicts one embodiment of the mobile device 302 in FIG. 3D after the user has pinned the content for the third search result 324 to the user-specified search query 344 in FIG. 3D. As depicted, the user interface may provide potential additional search terms 338 including “swimlanes,” “Phoenix,” and “PM” to be displayed such that the user may easily view and select a suggested search term to be included within the search terms in the search bar 312. The potential additional search terms 338 may include terms or words that appear in pinned search queries. For example, the acronym “PM” and the term “Phoenix” may be added as potential additional search terms because of the pinned user-specified search query 344 in FIG. 3D. The automatically suggested additional search terms may be customized on a per user or per group basis such that terms coined by the user and terms that are unique to the lexicography of the user's group associations are captured (e.g., acronyms that have meaning to members of Team Phoenix). The potential additional search terms 338 may include terms or words that are only derivable from pinned search queries, such as when those terms or words only appear in pinned search queries from either the user or group members (e.g., other users that are assigned to the same group or group identifier). The potential additional search terms 338 may include terms or words that do not appear or exist within either the underlying content or the metadata for the content. In one embodiment, the potential additional search terms 338 may include terms or words from pinned search queries only if the underlying content has been verified by the content owners.

FIG. 3F depicts one embodiment of the mobile device 302 in FIG. 3E after the user has pinned the content for the first search result 322 to the user-specified search query 347. As depicted, the user has selected the pin icon 341 to pin the content underlying the first search result 322 to the user-specified search query 347 of “Jira Conventions for Phoenix” for a period of six months. Thus, the search user may pin content to which they do not have ownership permissions to a user-specified search query.

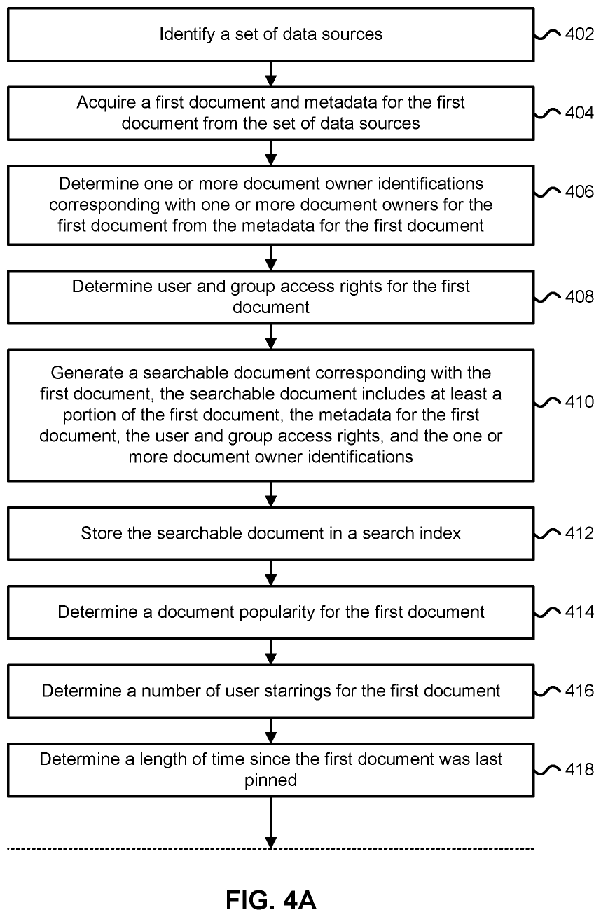

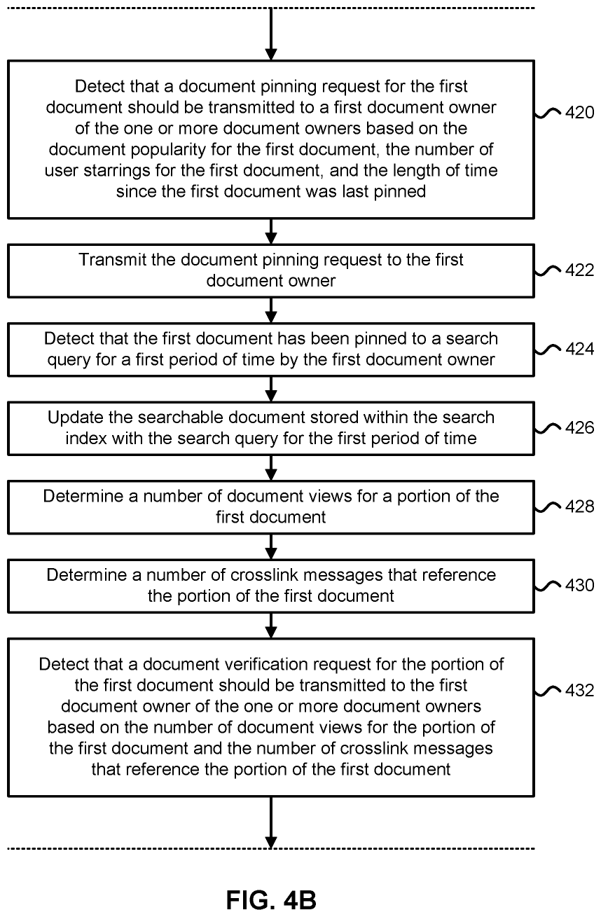

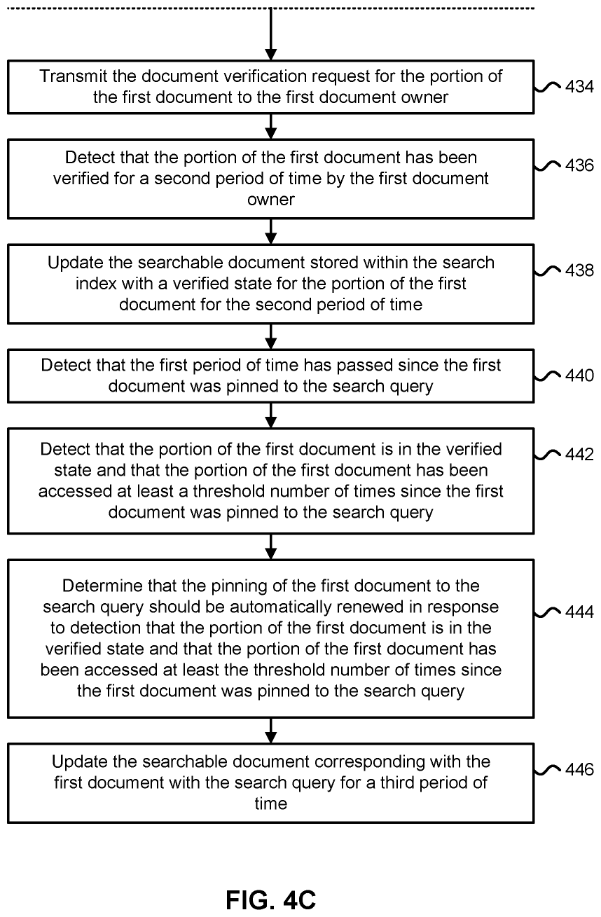

FIGS. 4A-4C depict a flowchart describing one embodiment of a process for aggregating, indexing, storing, and updating digital content that is searchable using a permissions-aware search and knowledge management system. Upon the detection of triggering conditions, the permissions-aware search and knowledge management system may automatically send or transmit document pinning requests and document verification requests to document owners to improve the quality of search results. In one embodiment, the process of FIGS. 4A-4C may be performed by a search and knowledge management system, such as the search and knowledge management system 120 in FIG. 1 or the search and knowledge management system 220 in FIG. 2A. In another embodiment, the process of FIGS. 4A-4C may be performed using a cloud-based computing platform or various cloud-based computing and data storage services.

In step 402, a set of data sources is identified. The set of data sources may correspond with data sources 140 in FIG. 1 or the data sources 240 in FIG. 2A. The set of data sources may comprise one or more sources of digital content including computers, servers, databases, document management systems, cloud-based file synchronization and storage services, cloud-based productivity applications, electronic messaging applications, and team collaboration applications. A search and knowledge management system, such as the search and knowledge management system 220 in FIG. 2A, may detect new data sources that are added to the set of data sources and periodically crawl or poll the set of data sources for new, updated, and deleted digital content. In step 404, a first document and metadata for the first document are acquired from the set of data sources. In one example, the first document may comprise an electronic document and the metadata may include data specifying the file size of the document, the number of words in the document, the number of pages in the document, an identification of the author of the document, a timestamp corresponding with when the document was last updated, and access rights or permissions for the document.

In step 406, one or more document owner identifications corresponding with one or more document owners for the first document are determined from the metadata for the first document. In one example, the one or more document owner identifications may comprise three different usernames associated with three users that have both read and write access to the first document. In another example, the one or more document owner identifications may comprise a single username associated with a user with ownership permissions for the first document. The one or more document owners for the first document may be specified in an access control list for the first document. In step 408, user and group access rights for the first document are determined. The access control list for the first document may specify the users and groups that have read access and write access to the first document. In step 410, a searchable document corresponding with the first document is generated. The searchable document may be generated by a document builder pipeline, such as the document builder pipeline 206 in FIG. 2B, that transforms or augments the first document. The searchable document may include portions of text from the first document, a summary of the contents of the first document, keywords from the first document, and a pinned search query for the first document. In the event that the first document includes two or more document owners, then two or more different pinned search queries corresponding with the two or more document owners may be written to the searchable document. In some cases, the searchable document may include at least a portion of the first document, the metadata for the first document, the user and group access rights for the first document, and the one or more document owner identifications corresponding with the one or more document owners for the first document.

In step 412, the searchable document is stored in a search index. In one example, the search index may correspond with the search index 204 in FIG. 2B. In step 414, a document popularity for the first document is determined. The document popularity may correspond with a number of different users that have accessed the first document within a particular period of time (e.g., within the past week). In step 416, a number of user starrings for the first document is determined. The number of user starrings may comprise the number of different users of the search and knowledge management system that have performed a search and then selected a star icon, such as the star icon 340 in FIG. 3D, to indicate the user's best search result for the entered search query for the search. In step 418, a length of time is determined since the first document was last pinned. In some cases, a document that has been recently pinned (e.g., within the past two days) may receive a boosted ranking or score.

In step 420, it is detected that a document pinning request for the first document should be transmitted to a first document owner of the one or more document owners based on the document popularity for the first document, the number of user starrings for the first document, and/or the length of time since the first document was last pinned. In one example, the document pinning request may correspond with the first suggested action 306 in FIG. 3A to set a document pin. In step 422, the document pinning request is transmitted to the first document owner. In step 424, it is detected that the first document has been pinned to a search query for a first period of time by the first document owner. In step 426, the searchable document stored within the search index is updated with the pinned search query for the first period of time. In one example, the first document may be pinned to a user-specified search query, such as the user-specified search query 344 in FIG. 3D, for a period of three months. In one embodiment, the pinned search query may include one or more terms that are added as heavily weighted keywords for the first document.

In step 428, a number of document views for a portion of the first document is determined. In one example, the number of document views for the portion of the first document may correspond with the number of document views (or document accesses) made by group members that belong to the same group as a user of the search and knowledge management system. In step 430, a number of crosslink messages that reference the portion of the first document is determined. In one example, the portion of the first document may correspond with one or more pages of the first document (e.g., pages two and three of the first document out of twenty pages total). In another example, the portion of the first document may correspond with one or more paragraphs of the first document less than all of the paragraphs within the first document. In step 432, it is detected that a document verification request for the portion of the first document should be transmitted to the first document owner of the one or more document owners based on the number of document views for the portion of the first document and/or the number of crosslink messages that reference the portion of the first document.

In step 434, the document verification request for the portion of the first document is transmitted to the first document owner. In step 436, it is detected that the portion of the first document has been verified for a second period of time by the first document owner. In one example, the document verification request may correspond with the second suggested action 308 in FIG. 3A to verify only a subset of pages of a document less than all of the pages of the document. In step 438, the searchable document stored within the search index is updated with a verified state for the portion of the first document for the second period of time. The portion of the first document may comprise one or more pages of the first document less than all the pages of the first document and the second period of time may comprise three weeks.

In step 440, it is detected that the first period of time has passed since the first document was pinned to the search query. In step 442, it is detected that the portion of the first document is in the verified state and that the portion of the first document has been accessed or viewed at least a threshold number of times since the first document was pinned to the search query. In one example, it may be detected that the portion of the first document has been accessed at least ten times by users with ten different usernames or user identifiers. In step 444, it is determined that the document pinning of the first document to the search query should be automatically renewed in response to detection that the portion of the first document is in the verified state and/or that the portion of the first document has been accessed at least a threshold number of times since the first document was pinned to the search query. In step 446, the searchable document corresponding with the first document is updated with the search query for a third period of time (e.g., for an additional week or a third period of time less than the first period of time). In this case, the updating of the first document with the pinned search query for the third period of time may correspond with the automatic renewal of the document pinning made in step 426.

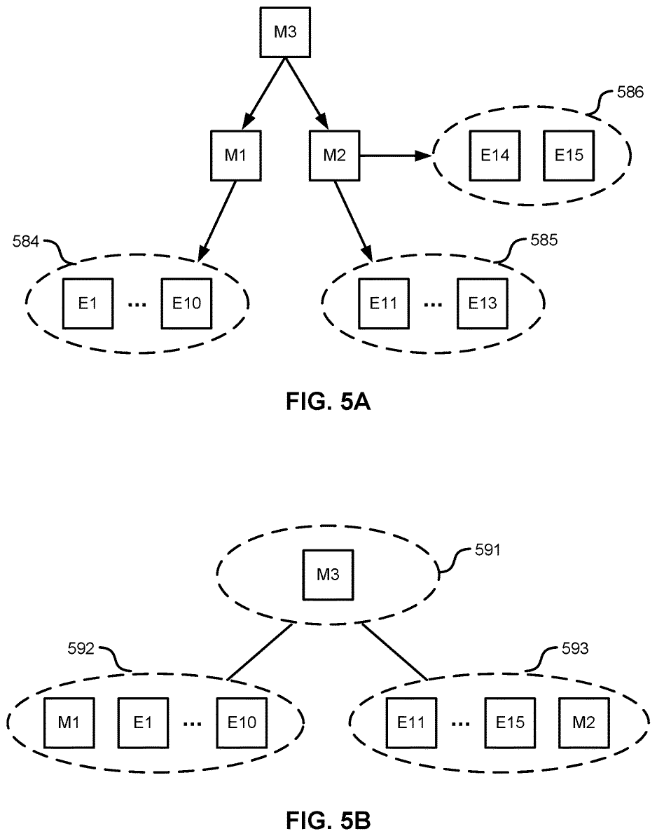

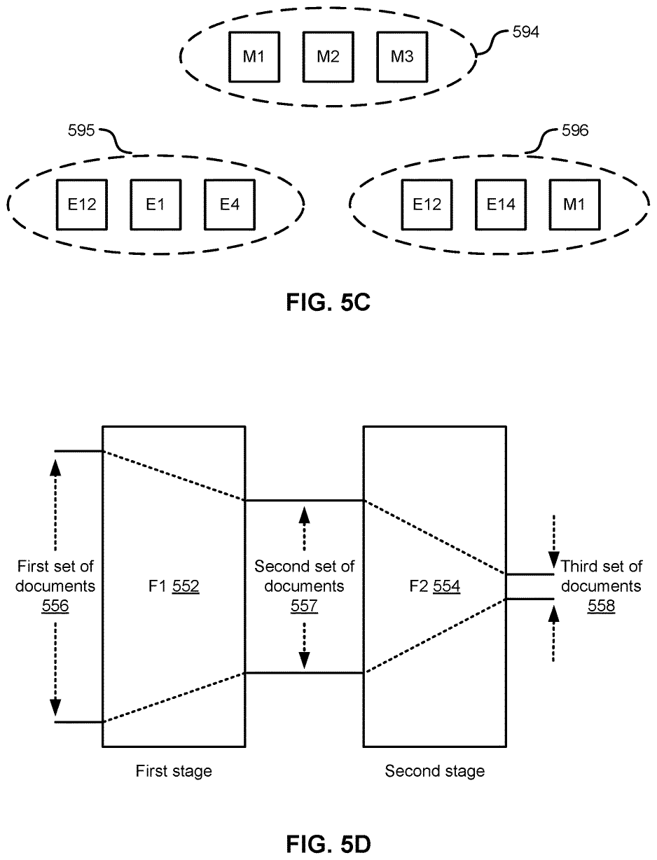

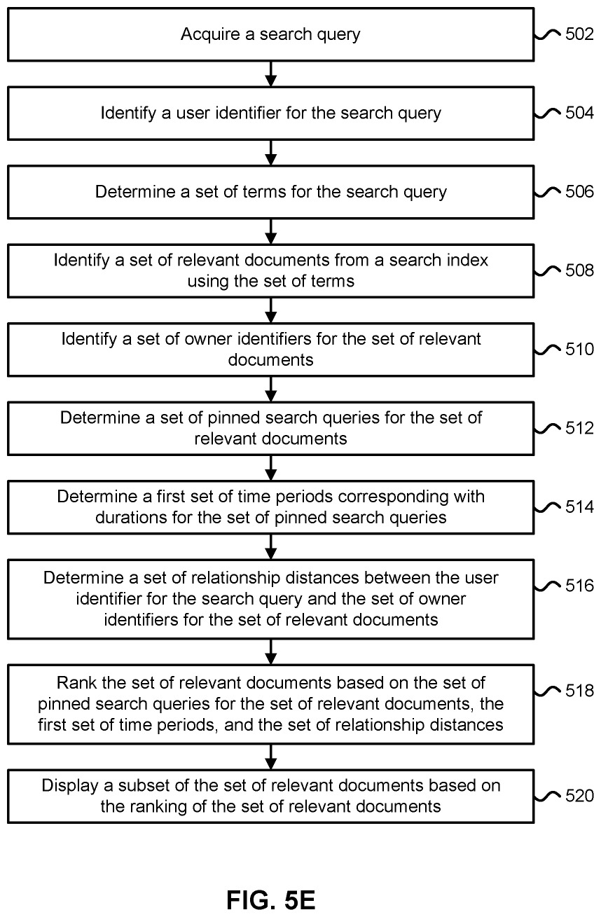

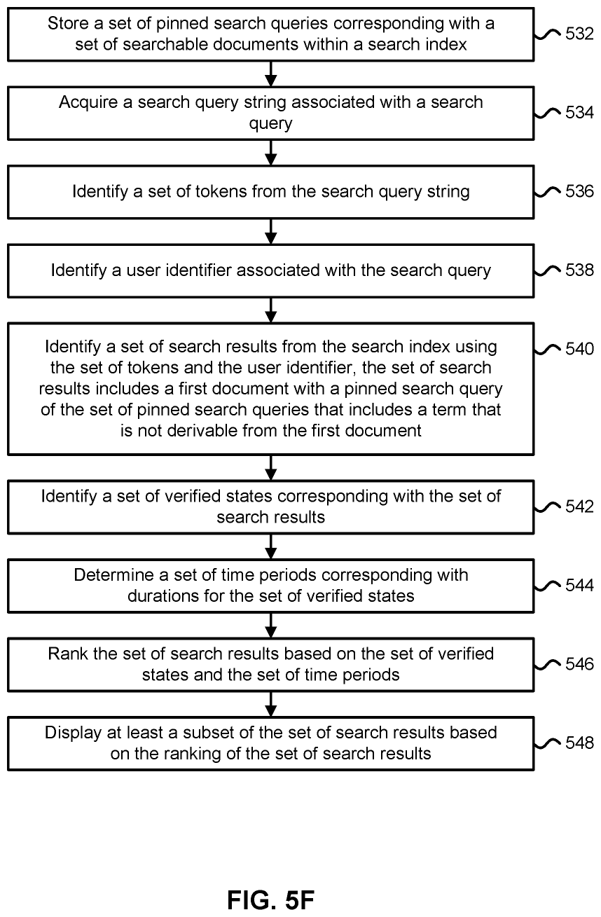

FIG. 5A depicts one embodiment of a directed graph with nodes corresponding with members or individuals of an organization. The organization may comprise different groups of individuals. The directed graph may represent a group hierarchy of those different groups. As depicted, the organization includes employees E1 through E15 and managers M1 through M3. The directed edges from manager M3 to managers M1 and M2 represent a hierarchical structure in which managers M1 and M2 report to manager M3. Similarly, employees E1 through E10 report to manager M1 and employees E11 through E15 report to manager M2. Employees E1 through E10 have been assigned to a first group 584. Employees E11 through E13 have been assigned to a second group 585. Employees E14 and E15 have been assigned to a third group 586. As depicted in FIG. 5A, the number of individuals assigned to the first group 584 comprises ten individuals, the number of individuals assigned to the second group 585 comprises three individuals, and the number of individuals assigned to the third group 586 comprises two individuals. A relationship distance between two individuals (e.g., between two different employees) may correspond with the number of edges between the two individuals within the directed graph. In one example, the relationship distance between employee E1 and manager M3 is two. In another example, the relationship distance between employee E1 and employee E11 is four. In another example, the relationship distance between employee E1 and employee E11 is four. In another example, the relationship distance between employee E1 and employee E10 is zero.

In one embodiment, the ranking of documents that have been verified by individuals within the same group as a search query submitter may be ranked above other documents that have not been verified, that have not been set into a verified state, or that have been only verified by individuals outside the group (e.g., by individuals that have not been assigned to the same group). In one example, search results for a search query submitted by employee E1 may rank documents verified by employees E2 through E10 above other documents verified by employees E11 through E15. In another embodiment, the ranking of documents that have been verified by individuals within the same group or that are within a relationship distance of one (e.g., at most one edge separates the individuals) as a search query submitter may be ranked above other documents that have not been set into a verified state or that have been verified by other individuals that have a relationship distance of two or more from the search query submitter.

In one embodiment, during the ranking of relevant documents for a search query, the weighting of documents that have pinned search queries from individuals within the same group as a search query submitter may be ranked above other documents that have not been pinned or that have pinned search queries from individuals that do not belong to the same group as the search query submitter. In one example, search results for a search query submitted by employee E1 may rank a first document with a matching pinned search query by employee E2 higher than a second document with a matching pinned search query by employee E14. The matching pinned search query may comprise a semantic match between the pinned search query and the submitted search query. In another embodiment, the ranking of documents that have pinned search queries from individuals within the same group or that are within a relationship distance of two (e.g., at most two edges separates the individuals) of the search query submitter may be ranked above other documents that do not have pinned search queries or that have pinned search queries from other individuals that have a relationship distance of three or more from the search query submitter.

FIG. 5B depicts one embodiment of an undirected graph with nodes corresponding with the employees E1 through E15 and managers M1 through M3. The undirected edges represent group relationships between different groups of individuals (e.g., project groupings of individuals). As depicted, manager M1 and employees E1 through E10 may be assigned to a first project group 592 and manager M2 and employees E11 through E15 may be assigned to a second project group 593. The number of individuals assigned to the first project group 592 comprises 11 individuals and the number of individuals assigned to the second project group 593 comprises six individuals. Both the first project group 592 and the second project group 593 may comprise children groups under a parent group 591 that comprises manager M3. In this case, a relationship distance between manager M1 and manager M2 may correspond with the two edges separating the first project group 592 from the second project group 593.

In some embodiments, for a searchable document stored within a search index, the popularity of the document as a function of user activity may be determined based on the user activity of the search query submitter and the user activity of fellow group members over a period of time (e.g., over the past two weeks). The period of time over which the document popularity is determined may be set based on the number of individuals within the group assigned to the search query submitter. In one embodiment, the time period for gathering user activity statistics may be adjusted from a first number of days (e.g., 30 days) to a second number of days (e.g., 60 days) greater than the first number of days if a group has less than ten individuals assigned to it. If the size of the group that the search query submitter belongs to is less than ten people, then the user activity statistics for calculating document popularity may be taken over a longer time duration. In reference to FIG. 5A, the time period for gathering user activity statistics for determining document popularity may be set to 30 days if employee E1 performs a search because the first group 584 has ten or more individuals and set to 60 days if employee E14 performs a search because the third group 586 has less than ten individuals assigned to it.

In another embodiment, the number of groups used to calculate document popularity may be determined based on the number of individuals within the group assigned to the search query submitter. In one example, if the group size of the group assigned to the search query submitter is greater than or equal to ten individuals, then the user activity statistics may be acquired from only the immediate group to which the search query submitter is assigned; however, if the group size of the group assigned to the search query submitter is less than ten individuals, then the user activity statistics may be acquired from the immediate group to which the search query submitter is assigned and from other groups that are closely related to the immediate group (e.g., that have a relationship distance that is two or less). In reference to FIG. 5A, document popularity may be determined using the user activity statistics from only the first group 584 if employee E1 performs a search because the first group 584 has ten or more individuals, whereas document popularity may be determined using the user activity statistics from the second group 585 and the third group 586 if employee E11 performs a search because the second group 585 has less than ten individuals. In this case, the second group 585 and the third group 586 have a relationship distance of two (e.g., are separated by two edges).

In another embodiment, the number of groups used to calculate document popularity may be determined based on the total number of searches over a period of time (e.g., within the past week) performed by individuals within the group assigned to the search query submitter and/or other groups within an organization. In reference to FIG. 5A, if a search is performed by employee E11 and the number of searches performed by the individuals in the second group 585 over the past week is greater than 400, then document popularity may be determined using the user activity statistics from only the second group 585; however, if a search is performed by employee E11 and the number of searches performed by the individuals in the second group 585 over the past week is not greater than 400, then document popularity may be determined using the user activity statistics from both the second group 585 and the third group 586 (e.g., taking into consideration the user activity from groups that have a relationship distance of two or less). In some cases, if a search is performed by employee E11 and the number of searches performed by the individuals in the second group 585 and the third group 586 over the past week is not greater than 400, then document popularity may be determined using the user activity statistics from the second group 585, the third group 586, and the first group 584 (e.g., taking into consideration the user activity from groups that have a relationship distance of four or less). The relationship distance may be increased and groups added until the number of searches performed by individuals within the groups over the past week is greater than 400 (or some other threshold number of searches).

In another embodiment, the number of groups used to calculate document popularity may be determined based on the amount of user activity over a period of time (e.g., over the past two weeks) performed by individuals within the group assigned to the search query submitter and/or other groups within an organization. The amount of user activity may be associated with a user activity score for a particular individual or individuals within the group assigned to the search query submitter. The user activity score may comprise a summation of various user activity metrics, such as the summation of a first number of recent document downloads, a second number of likes, a third number of shares, and a fourth number of comments. In one example, the second number of likes and the fourth number of comments may correspond with likes and comments made in a persistent chat channel by individuals within a group assigned to the search query submitter. In reference to FIG. 5A, if a search is performed by employee E11 and the user activity score for the individuals in the second group 585 over the past two weeks is greater than 2000, then document popularity may be determined using the user activity statistics from only the second group 585; however, if a search is performed by employee E11 and the user activity score for the individuals in the second group 585 over the past two weeks is not greater than 2000, then document popularity may be determined using the user activity statistics from both the second group 585 and the third group 586 (e.g., by increasing the maximum relationship distance to two and taking into consideration the user activity from groups that have a relationship distance of at most two from the group assigned to the search query submitter). The maximum relationship distance from the group assigned to the search query submitter may be incrementally increased and groups added until the user activity score for individuals within the groups over the past two weeks is greater than 2000.

FIG. 5C depicts one embodiment of a plurality of people clusters corresponding with subsets of the employees E1 through E15 and managers M1 through M3. The assignment of individuals to a particular people cluster may be determined based on collaboration activity. In some cases, a close working relationship may be inferred due to frequent collaboration on documents or tickets and/or frequent work-related communication within a communication channel. As depicted, managers M1-M3 have been assigned to a first people cluster 594 because they each co-edited or viewed a set of documents during a first time period. In one example, managers M1-M3 may have co-edited a spreadsheet for at least a week. Employees E12, E1, and E4 have been assigned to a second people cluster 595 because they have messaged each other within a persistent chat channel at least twenty times within the past three days. Manager M1, employee E12, and employee E14 have been assigned to a third people cluster 596 because they have co-edited a word processing document together for at least two weeks. Although the individuals within the third people cluster 596 do not all share the same manager or have not been assigned to the same group membership, the third people cluster 596 has been automatically created due to the degree of collaboration activity with the word processing document.

FIG. 5D depicts one embodiment of a staged approach for identifying sets of relevant documents for a given search query. The search query may include one or more search query terms. As depicted, a second set of documents 557 is selected from a first set of documents 556 using a first scoring function F1 552 to generate a first set of relevance scores for the first set of documents 556. The second set of documents 557 may comprise a subset of the first set of documents 556 that have relevance scores above a first threshold score. The first scoring function F1 552 may generate the first set of relevance scores using a first set of ranking factors, such as the presence of one or more search query terms within a title or summary of a document, how recently a document was updated with one or more search query terms, the term frequency or the number of times that one or more search query terms appear within a document, the source rating for a document, and a term proximity for one or more search query terms within a document. In one example, the first set of documents 556 may comprise searchable documents within a search index and a first set of relevance scores may be generated for the searchable documents within the search index using the first scoring function F1 552. The first set of documents 556 may then be ranked using the first set of relevance scores and a subset of the first set of documents 556 may be identified with at least the first threshold score. The first threshold relevance score may be set such that the second set of documents 557 comprises a particular percentage (e.g., ten percent) of the first set of documents 556.

Subsequently, a third set of documents 558 is selected from the second set of documents 557 using a second scoring function F2 554 to generate a second set of relevance scores for the second set of documents 557. The third set of documents 558 may comprise a subset of the second set of documents 557 that have relevance scores above a second threshold score. The second scoring function F2 554 may generate a second set of relevant scores using a second set of ranking factors. In one example, the number of ranking factors used for the second set of ranking factors may be greater than the number of ranking factors used for the first set of ranking factors. The second set of documents 557 may be ranked using the second set of relevance scores and a subset of the second set of documents 557 may be identified with at least the second threshold score.

In some embodiments, the first scoring function F1 552 may only consider a subset of the data associated with the first set of documents 556, such as a few lines of body text, titles, metadata descriptions, and incoming anchor text, while the second scoring function F2 554 may consider all data associated with the second set of documents 557. As the number of documents is reduced, the number of document elements or the amount of data associated with each document during application of a scoring function may be increased. In some cases, a third stage not depicted with a third scoring function may be used to further refine the third set of documents 558 to obtain a fourth set of relevant documents for the given search query.

FIG. 5E depicts a flowchart describing one embodiment of a process for generating and displaying search results for a given search query. In one embodiment, the process of FIG. 5E may be performed by a search and knowledge management system, such as the search and knowledge management system 120 in FIG. 1 or the search and knowledge management system 220 in FIG. 2A. In another embodiment, the process of FIG. 5E may be implemented using a cloud-based computing platform or cloud-based computing services.

In step 502, a search query is acquired. The search query may be acquired by a search and knowledge management system, such as the search and knowledge management system 220 in FIG. 2A. The search query may be acquired from a computing device, such as computing device 154 in FIG. 1. The search query may be entered on the computing device and submitted to a search and knowledge management system. In step 504, a user identifier for the search query is identified. The search query may be inputted and submitted by a user of a computing device, such as computing device 154 in FIG. 1, using a search bar, such as the search bar 312 in FIG. 3A. The user identifier may correspond with a username for the user, such as the username 314 in FIG. 3A. In step 506, a set of terms for the search query is determined. The set of terms may comprise a set of words or a set of tokens that derive from the search query. In one embodiment, the search query may be acquired as a string of characters and machine learning and/or natural language processing techniques may be used to determine the set of terms from the string of characters.

In step 508, a set of relevant documents is identified from a search index using the set of terms. The set of relevant documents may comprise searchable documents within the search index with at least a threshold relevance score or at least a threshold number of matching terms from the set of terms (e.g., at least two terms within the set of terms are found in each of the set of relevant documents). The relevance score may be calculated for each indexed document within the search index using a number of factors or criteria, such as the presence of one or more terms from the set of terms within a title or summary of an indexed document, whether one or more terms from the set of terms have particular formatting within an indexed document (e.g., whether a term has been underlined or italicized), how recently an indexed document was updated and whether one or more terms of the set of terms were added within a particular period of time (e.g., a searched term was added within the past week), the term frequency or the number of times that one or more terms from the set of terms appears within an indexed document, the source rating for an indexed document (e.g., a word processing document or presentation slides may have a higher source rating than an electronic message), and a term proximity for the set of terms within an indexed document.

In step 510, a set of owner identifiers for the set of relevant documents is identified. Each document within the search index may correspond with one or more document owners. The document owner of a particular document may be identified based on file permissions or access rights to the particular document. In one example, metadata for the particular document may specify a document owner or specify one or more document owners with read and write access to the particular document. In another example, an access control list for the particular document may specify the document owner or specify one or more usernames with read and write access to the particular document.

In step 512, a set of pinned search queries for the set of relevant documents is determined. In one embodiment, at least a subset of the set of relevant documents may have corresponding pinned search queries that were attached by their document owners. In one example, a pinned search query may correspond with the user-specified search query 344 depicted in FIG. 3D. Each pinned search query of the set of pinned search queries may correspond with a pin expiration date. In step 514, a first set of time periods corresponding with durations for the set of pinned search queries is determined. The first set of time periods may correspond with time durations during which the set of pinned search queries are valid. In one example, a first pinned search query of the set of pinned search queries may expire within a week while a second pinned search query of the set of pinned search queries may expire within a month. In another example, a first pinned search query of the set of pinned search queries may correspond with a first time period (e.g., for 15 days) of the first set of time periods during which the first pinned search query is valid and a second pinned search query of the set of pinned search queries may correspond with a second time period (e.g., for 60 days) of the first set of time periods during which the second pinned search query is valid.

In step 516, a set of relationship distances between the user identifier for the search query identified in step 504 and the set of owner identifiers for the set of relevant documents identified in step 510 is determined. In this case, the set of relationship distances may include a first relationship distance that corresponds with the number of edges between a first individual associated with the user identifier and a second individual associated with an owner identifier for one of the set of relevant documents. In step 518, the set of relevant documents is ranked based on the set of pinned search queries for the set of relevant documents, the first set of time periods, and/or the set of relationship distances. The set of relevant documents may be ranked based on search query affinity or similarity with the set of pinned search queries for the set of relevant documents. The ranking of the set of relevant documents may boost documents with recent pinned search queries over other documents with older pinned search queries, may boost documents with pinned search queries that match or have a high degree of similarity with the search query or the set of terms for the search query, and may boost documents with pinned search queries that have a high degree of similarity with the search query that were created by individuals assigned to the same group as the individual with the user identifier for the search query. A pinned search query may have a high degree of similarity with the search query if at least a threshold number of terms (e.g., at least two) appear in both the pinned search query and the search query submitted by the individual with the user identifier.

In one embodiment, documents with pinned search queries from individuals assigned to the same group as the user associated with the user identifier for the search query may be boosted over other documents without pinned search queries or that have pinned search queries from other individuals with relationship distances greater than one. In another embodiment, documents with pinned search queries that were pinned within a past threshold period of time (e.g., within the past week) may be boosted over other documents that were pinned prior to the past threshold period of time (e.g., that were pinned more than a month ago) or that have never been pinned.

In step 520, a subset of the set of relevant documents is displayed based on the ranking of the set of relevant documents. In one example, the subset of the set of relevant documents may comprise the first ten documents with the highest rankings. The subset of the set of relevant documents may be displayed using a display of a computing device, such as the computing device 154 in FIG. 1.

In some embodiments, the set of pinned search queries for the set of relevant documents may comprise one pinned search query for each of the set of relevant documents. In one example, each relevant document of the set of relevant documents may correspond with only one pinned search query (e.g., that was set by a document owner of a relevant document). In other embodiments, a relevant document may correspond with a plurality of pinned search queries that were set by a plurality of users of the search and knowledge management system. In one example, the relevant document may comprise a spreadsheet with a first document pin set by a document owner of the spreadsheet, a second document pin set by a co-worker of the document owner, and a third document pin set by another user of the search and knowledge management system different from the document owner and the co-worker. In some embodiments, a first set of relevant documents that each have at least a first number of document pins (e.g., at least five pins per document) may be boosted over a second set of relevant documents that each have less than the first number of document pins. A higher number of pins per document may correspond with documents with higher value or greater interest within an organization. In other embodiments, a first set of relevant documents that each have had at least a first number of document pins set within a first period of time (e.g., have had at least four pins set within the past week) may be boosted over a second set of relevant documents that have not had at least the first number of document pins set within the first period of time.

FIG. 5F depicts a flowchart describing an alternative embodiment of a process for generating and displaying search results for a given search query. In one embodiment, the process of FIG. 5F may be performed by a search and knowledge management system, such as the search and knowledge management system 120 in FIG. 1 or the search and knowledge management system 220 in FIG. 2A. In another embodiment, the process of FIG. 5F may be implemented using a cloud-based computing platform or cloud-based computing services.

In step 532, a set of pinned search queries corresponding with a set of searchable documents is stored within a search index. The search index may correspond with search index 204 in FIG. 2B. Each searchable document of the set of searchable documents may be pinned to one of the set of pinned search queries. The set of pinned search queries may comprise a first pinned search query that is attached to a first document of the set of searchable documents. The first pinned search query may correspond with the pinned user-specified search query 344 in FIG. 3D. In step 534, a search query string associated with a search query is acquired. The search query string may be entered and submitted via a search bar, such as the search bar 312 in FIG. 3A. In step 536, a set of tokens is identified from the search query string. The set of tokens may comprise a set of words or a set of terms that are derived from the search query string. Natural language processing techniques may be used to identify the set of tokens. In step 538, a user identifier associated with the search query is identified. The user identifier may correspond with a username for the user, such as the username 314 in FIG. 3A. In step 540, a set of search results is identified from the search index using the set of tokens and the user identifier. The set of search results may comprise a set of relevant documents that are classified as relevant to the search query. The set of search results may correspond with searchable content within the search index including electronic files, word processing documents, database records, web pages, and electronic messages. The set of search results may be identified by generating a relevance score for each document within the search index based on the set of tokens and the user identifier and then identifying documents within the search index with a relevance score above a threshold score (e.g., with a relevance score of at least 1500). The user identifier may be used to calculate relationship distances or to determine which documents are owned by other individuals with the same group assignment (e.g., that are in the same group) as the individual with the user identifier in order to boost their relevance scores.

The set of search results may include a first document with a pinned search query of the set of pinned search queries that includes at least one term that is not derivable from the first document. A technical benefit of allowing a search user or a document owner to pin a document to a user-specified search query is that terms that are not found in the document or that cannot be derived from the contents of the document may be specified and subsequently searched in order to find the document or increase the likelihood of finding the document within search results. A term may be deemed to not be derivable from the contents of the document if the term does not comprise a semantic match with at least a portion of the contents or if the term does not comprise a synonym for the contents of the document.

In step 542, a set of verified states corresponding with the set of search results is identified. Each search result (e.g., comprising a link to an electronic document, web page, or message) of the set of search results may be associated with one or more verified states that specify whether the content of the entire search result has been verified and is currently in a verified state or whether only a portion of the content of the search result is currently in the verified state. In step 544, a set of time periods corresponding with time durations for the set of verified states is determined. The set of time periods may be used to determine when a document was verified and how much longer the document will remain in a verified state before the document verification expires. In step 546, the set of search results is ranked based on the set of verified states and the set of time periods. In one embodiment, the ranking of the set of search results may comprise a ranked list of documents from the search index that are ranked based on whether the contents of a document are currently verified, the amount of time that remains until expiration of document verification, and/or the amount of time that has passed since expiration of document verification. In one example, the ranking of the set of search results may boost the ranking scores of documents that are currently verified. In another example, the ranking of the set of search results may boost the ranking scores of documents that are currently verified by a first amount and boost the ranking scores of other documents that were verified and that have not been expired for more than a threshold period of time (e.g., the document verification expired less than a week ago) by a second amount less than the first amount. In some embodiments, the ranking of the set of search results based on their document verification status may be performed as a last stage ranking that boosts the rank of highly relevant documents that were verified by individuals within the same group as the search query submitter.

In step 548, at least a subset of the set of search results is displayed and/or outputted. The subset of the set of search results may comprise the twenty highest ranking search results out of fifty search results. The subset of the set of search results may be displayed using a display of a computing device, such as computing device 154 in FIG. 1.

Modern enterprise knowledge systems primarily operate as repositories or retrieval tools that capture documents, communications, and structured records created within an organization. These systems often rely on keyword or graph-based search functions, workflow dashboards, and analytic reporting to help users locate information and track progress across projects. While such systems have improved access to stored data, they remain largely passive. They respond to explicit queries or manually defined workflows, but they do not reason about the relationships among activities, people, and digital artifacts occurring across the enterprise. As a result, leadership and employees must still interpret raw information, infer organizational state, and decide on appropriate actions without real-time, system-level guidance.

Concurrently, recent advances in artificial intelligence (AI) and large language models (LLMs) have demonstrated remarkable capabilities in generating text, summarizing content, and answering isolated questions. However, these technologies remain largely disconnected from the persistent and heterogeneous context of an enterprise environment. Conventional AI assistants lack awareness of enterprise structure, roles, policies, and the temporal evolution of work. They process inputs statelessly and cannot maintain continuity across applications, departments, or long-running initiatives. Moreover, their training typically depends on static datasets and does not adapt automatically as enterprise conditions change. Consequently, existing AI systems cannot manage, anticipate, or coordinate the ongoing operations of a complex organization.

Embodiments described herein address the above and other limitations by providing a context-aware action orchestration system that continuously observes digital activity across the enterprise and maintains a dynamic contextual representation of organizational state. The system aggregates data from multiple enterprise sources, such as collaboration platforms, workflow tools, communication systems, and knowledge repositories, and constructs a unified model that captures relationships among users, resources, and operational entities. This dynamic context model may take the form of a graph-based structure that evolves in real time as new events occur. Predictive and reasoning models (e.g., artificial intelligence models, machine learning models, etc. trained on the graph-based structure or that reference the graph-based structure) operate upon the context model to infer future actions, identify emerging dependencies, and generate task or decision recommendations relevant to ongoing work.

In some embodiments, the action orchestration system serves as an intelligent coordination layer situated above conventional applications. For example, the action orchestration system monitors enterprise signals, invokes trained predictive and reasoning models, and produces context-aware outputs that influence or perform enterprise operations. The orchestration layer may integrate multiple specialized components, such as a prediction engine, an agentic reasoning engine, and an action execution framework. These components cooperate to translate inferred objectives into executable plans, assign actions to appropriate agents or resources, and monitor execution outcomes. The orchestration layer may further enforce enterprise policy constraints and access controls when generating or implementing recommendations.

In some embodiments, the action orchestration system may implement a closed learning loop that continuously refines its models and contextual understanding based on observed outcomes. As tasks are completed or recommendations are accepted, modified, or ignored, the orchestration layer collects implicit and explicit feedback and updates the dynamic context model accordingly. Over time, the system may learn behavioral patterns, organizational rhythms, and preferred collaboration styles, allowing the action orchestration system to anticipate needs and adjust predictive accuracy. Additional capabilities may include simulation or “what-if” evaluation of alternate decisions, adaptive prioritization of tasks according to organizational objectives, and explainability features that provide human-readable rationales for generated guidance.

Using these coordinated functions, embodiments described herein may transform enterprise knowledge management from a reactive information-retrieval paradigm into an active, adaptive framework for organizational intelligence. Embodiments provide continuous situational awareness, accelerate decision-making, and enhance alignment between individual actions and enterprise goals. By unifying structured and unstructured data under a dynamic contextual model and coupling that model with predictive and orchestration technologies, the action orchestration system enables enterprises to operate with foresight, agility, and transparency that may not be achievable using traditional search, analytics, or standalone AI assistants.

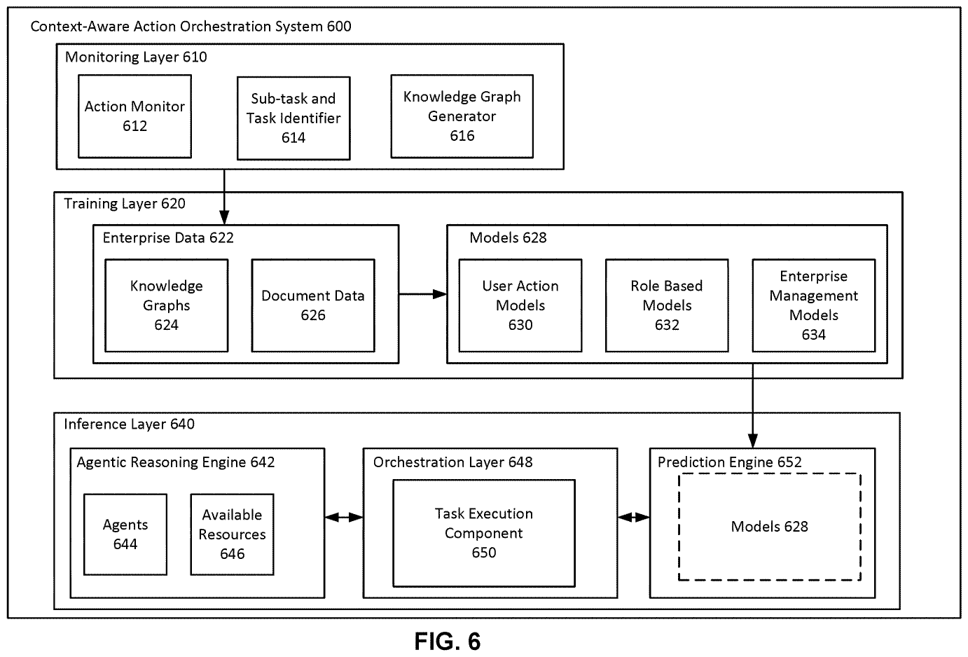

FIG. 6 is a block diagram illustrating a context-aware action orchestration system 600 configured to observe, learn from, and act upon operational signals generated throughout an enterprise computing environment. The context-aware action orchestration system 600 may include multiple cooperating functional layers, such as a monitoring layer 610, a training layer 620, and an inference layer 640. Together, these layers may form an adaptive framework that continually transforms enterprise activity into predictive and actionable intelligence. Although FIG. 6 depicts specific logical divisions among the layers and functionality for explanatory purposes, the described functions may be combined or distributed among multiple physical or virtual computing resources.

In some embodiments, the context-aware action orchestration system 600 may be deployed across any platform, device, or computing environment capable of network communication. The orchestration, prediction, and reasoning components may execute on distributed cloud infrastructure, private virtual-private-cloud environments, on-premises servers, edge devices, or any other computing environment or platform. Execution of the various models may occur locally, remotely, or through hybrid configurations that delegate portions of computation to external accelerators or large-model providers. A platform-agnostic design (e.g., via one or more application programming interfaces (APIs)) may ensure that the context-aware action orchestration system 600 can integrate seamlessly with existing enterprise infrastructure regardless of operating system, programming environment, or hardware class.

In some embodiments, the monitoring layer 610 may provide persistent visibility into user and system activity within the enterprise. For example, the monitoring layer 610 may connect to collaboration tools, file systems, project-tracking platforms, communication applications, and other operational systems to collect fine-grained action and event data. An action monitor 612 may capture low-level events such as document edits, task completions, message exchanges, and code commits, while maintaining timestamps, source identifiers, and context tags for each observed action. A sub-task and task identifier 614 may analyze the incoming event stream to cluster related actions and infer hierarchical task relationships. For example, sub-task and task identifier 614 may recognize that a sequence of code commits and review comments correspond to a single feature-development effort. A knowledge-graph generator 616 may translate the observed activities into a graph-based structure that encodes entities (e.g., users, teams, documents, projects) as nodes and their temporal or logical relationships as edges. The monitoring layer 610 may normalize heterogeneous input formats into a consistent feature representation, perform noise filtering, and apply access-control policies to limit propagation of unauthorized data to subsequent layers. In some implementations, the monitoring layer 610 may operate asynchronously across distributed data sources and may cache intermediate updates of collected actions and inputs for periodic synchronization with the training layer 620. In some embodiments, the monitoring layer 610 operates as an always-on observation network that functions continuously across user devices, mobile clients, and server-side applications. Because the monitoring process is not confined to a specific platform or interface, the system may detect and correlate events that originate from any connected environment (e.g., desktop, mobile, web, IoT, etc.). The continuous monitoring allows the orchestration layer 648 to anticipate upcoming actions proactively, rather than responding solely to explicit user input or scheduled queries.

The training layer 620 may transform the monitored contextual information into predictive and reasoning models. The training layer 620 may draw upon enterprise data 622, including curated knowledge graphs 624, as discussed above, and document data 626, to derive multidimensional features representing both behavioral and structural aspects of enterprise operations. The training layer 620 may instantiate a collection of models 628, such as user-action models 630, role-based models 632, and enterprise-management models 634. The user-action models 630 may learn personal work patterns or communication habits, the role-based models 632 may generalize these patterns across users with similar responsibilities, and the enterprise-management models 634 may capture aggregate trends reflecting organizational health or workflow efficiency. Training may employ machine-learning techniques including neural networks, probabilistic graphical models, or graph-embedding methods. The training layer 620 may schedule retraining cycles triggered by data-freshness thresholds or performance metrics, and may implement federated-learning protocols that allow local models to be trained near their respective data sources while contributing gradients or parameters to a centralized model repository. In some embodiments, the training layer 620 may also maintain versioned model archives and evaluation pipelines for validating new model iterations before deployment to the inference layer 640. During model training and inference, temporal freshness may be incorporated through time-decay weighting applied to both graph relationships and model-training samples. In the training process, the training layer 620 may apply exponentially decaying weights to older data so that recent enterprise behavior contributes more heavily to model updates.

In some embodiments, the training layer 620 may maintain comprehensive model-versioning, validation, and governance controls to ensure reliability and auditability of the predictive infrastructure. Each model instance and pipeline configuration may be stored in a version-controlled registry along with metadata describing training datasets, parameter settings, and evaluation results. A validation framework may benchmark newly trained models against standardized test suites before deployment, verifying accuracy and compliance with enterprise policies. Historical versions may remain accessible for forensic analysis or rollback in the event of performance degradation. These governance mechanisms provide a transparent record of model lineage and ensure that the predictive foundation of the context-aware action orchestration system 600 remains verifiable and trustworthy over time.

The inference layer 640 may apply the trained models to current enterprise context to generate actionable recommendations and orchestrate their execution. The inference layer 640, for example, may include an agentic reasoning engine 642 that interprets predictions and decomposes complex objectives into executable sub-tasks. An available-agent identification component 644 may determine which software or human agents are capable of performing each sub-task based on skill attributes, permissions, or system interfaces, while an available-resources component 646 may evaluate computational or temporal constraints. A task-execution component 650 may coordinate dispatch and monitor progress of the assigned tasks. Central to the inference layer 640 is an orchestration layer 648 that manages data flow between the trained models and the execution environment. The orchestration layer 648 may invoke a prediction engine 652 to evaluate the dynamic context graph and produce ranked forecasts of likely next actions or enterprise events. Based on these forecasts, the orchestration layer 648 may generate context-aware guidance, select suitable agents or applications for implementation, and issue commands or notifications through corresponding interfaces. In some embodiments, the orchestration layer 648 may also perform policy enforcement, conflict resolution among concurrent recommendations, and aggregation of outcome telemetry for return to the training layer 620.

The layered architecture of the context-aware action orchestration system 600 may enable continuous learning and adaptive orchestration across the enterprise environment. The monitoring layer 610 may capture real-time context, the training layer 620 may transform accumulated context into predictive capability, and the inference layer 640 may leverage the predictive capabilities to guide or perform actions within the computing environment. Each layer may feed inputs to the next layer in a closed operational loop that allows the context-aware action orchestration system 600 to evolve as enterprise behavior changes. Over successive cycles, the context-aware action orchestration system 600 may improve task prediction accuracy, refine prioritization strategies, and provide increasingly relevant and efficient orchestration of enterprise activities.

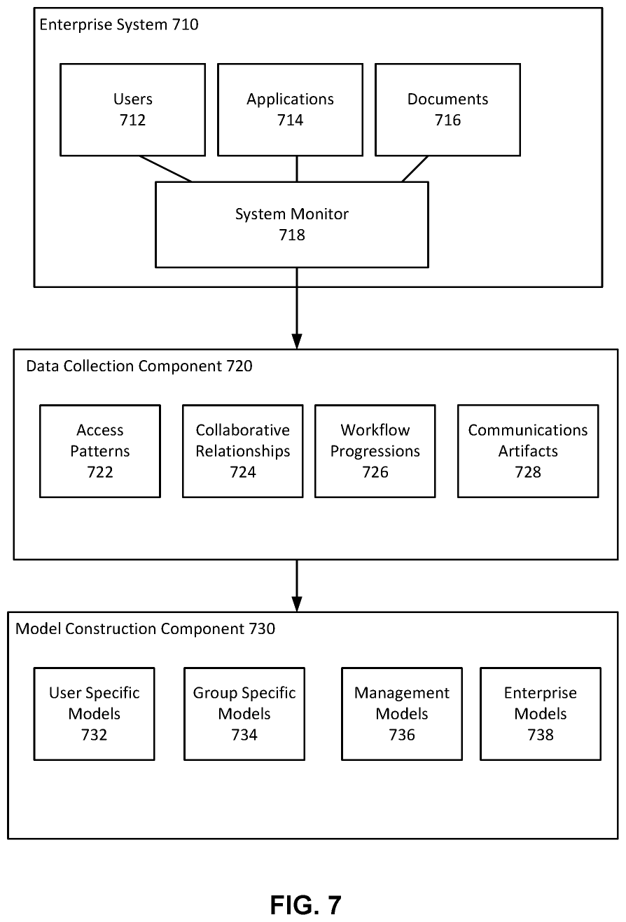

FIG. 7 is a block diagram illustrating an enterprise system 710 incorporating a data-collection and model-construction architecture for generating predictive and reasoning models based on observed enterprise activity. The enterprise system 710 may be a computing environment that integrates numerous user-facing applications and backend applications across an organization, and that continuously produces operational data reflecting how work is performed. The components depicted in FIG. 7 enable the capture, normalization, and transformation of this data into a structured contextual foundation suitable for model training and inference as described with respect to FIG. 6.

In some embodiments, the enterprise system 710 may include a plurality of users 712, applications 714, and documents 716 that collectively define the digital workspace of the organization. The users 712 may include employees, contractors, automated agents, or any other entity operating under unique roles or permissions within the enterprise system 710. The applications 714 may include productivity suites, collaboration tools, messaging platforms, source-code management systems, customer-relationship management systems, project-tracking platforms, or any other application. The documents 716 may include structured records such as spreadsheets and databases, as well as unstructured artifacts such as emails, chat messages, technical designs, and reports. Each of these elements may emit telemetry or change events that collectively reflect the ongoing operational state of the enterprise.

A system monitor 718 may continuously observe interactions among the users 712, applications 714, and documents 716 to identify data suitable for model-construction. The system monitor 718 may capture, for example, login and access patterns, document-edit histories, comment threads, task assignments, meeting participation, and any other user actions. The system monitor 718 may also extract relationships among entities (e.g., users, accounts, etc.) implied by communication networks, shared file ownership, workflow dependencies, recurring collaboration sequences, or the like. Each observed interaction may be timestamped and associated with identifiers for participating entities, thereby creating a temporally ordered event stream representative of enterprise behavior.

In some embodiments, a data-collection component 720 may aggregate the event streams from multiple data sources and perform preprocessing operations to prepare data collected from the event streams for contextual modeling. The data-collection component 720 may normalize the captured data from the multiple data sources into a consistent feature schema regardless of originating platform, remove redundant or transient events, and resolve conflicting identifiers across systems. The data-collection component 720 may further classify each event according to high-level categories such as access patterns 722, collaborative relationships 724, workflow progressions 726, and communications artifacts 728. For example, access patterns 722 may include frequency and recency of resource interactions, collaborative relationships 724 may encode co-editing or co-attendance graphs, workflow progressions 726 may describe task dependencies and completion rates, and communications artifacts 728 may represent semantic topics extracted from natural language exchanges. These data categories collectively define a multi-dimensional representation of enterprise context from which structural and behavioral correlations can be derived. Any number of additional categories may be identified and stored by the data-collection component 720.

In some embodiments, the system monitor 718 may establish cross-application continuity by linking context across heterogeneous enterprise platforms. For example, an email referencing a project milestone, a calendar meeting discussing that milestone, and a subsequent task created in a project-management system may all be correlated as part of a single contextual thread. The data-collection component 720 may assign persistent identifiers to such threads, enabling the model-construction component 730 to learn relationships that span multiple applications. This capability allows the enterprise system 710 to maintain a unified understanding of user intent and workflow progression even as work transitions between different digital environments.

A model-construction component 730 processes the collected and categorized data to build a family of predictive and reasoning models that capture different facets of enterprise operation. The model-construction component 730 may use graph-based machine-learning methods to embed the observed entities and relationships into vector spaces that preserve proximity according to functional interaction or communication frequency. From these embeddings, the model-construction component 730 may generate user-specific models 732, group-specific models 734, management models 736, and enterprise models 738. Each model type focuses on a distinct contextual scale or analytic objective.

The user-specific models 732 may capture individual behavioral signatures such as working hours, preferred collaboration partners, or task-completion cadence. The group-specific models 734 may generalize those patterns across teams or departments to identify shared practices or bottlenecks in coordination. The management models 736 may synthesize performance indicators and communication dynamics to estimate project health or resource alignment. The enterprise models 738 may aggregate and abstract information across all subordinate models to provide a holistic representation of organizational structure, dependencies, and operational tempo. Each model may be parameterized using features derived from the context graphs produced by the data-collection component 720 and may be trained using a combination of supervised and unsupervised techniques to learn correlations between past actions and subsequent outcomes.

In some embodiments, the model-construction component 730 may maintain a layered hierarchy among the models to enable multi-level reasoning. For example, predictions generated by the user-specific models 732 may be propagated upward as input signals to the group-specific models 734, while organizational trends detected by the enterprise models 738 may feedback downward to recalibrate individual or team-level models. The component 730 may further perform continual retraining or incremental updating of the models as new data becomes available from the system monitor 718. Training may occur periodically, on demand, or in response to detected changes in enterprise behavior exceeding predetermined thresholds.

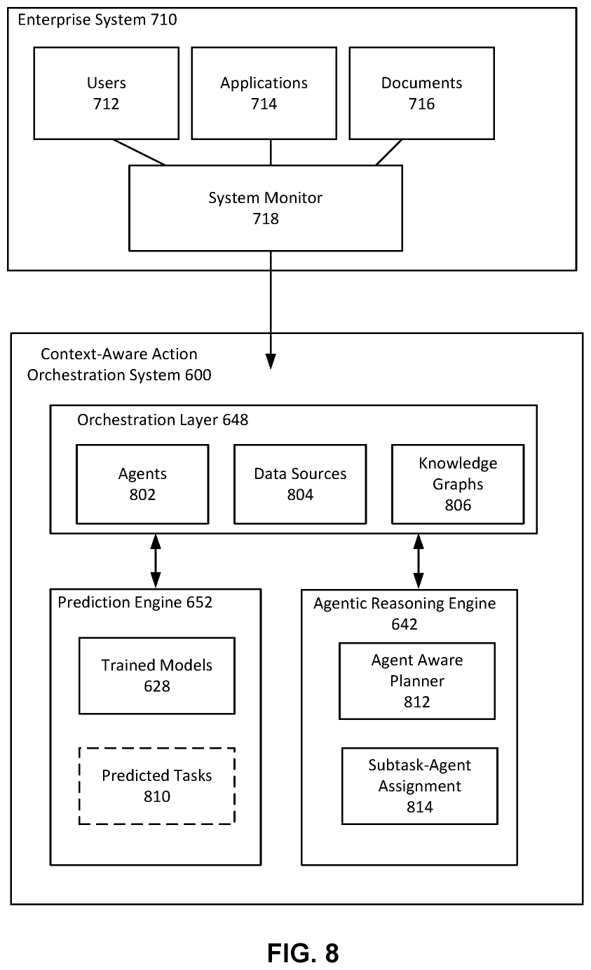

The operations illustrated in FIG. 7 may enable the enterprise system 710 to evolve from a passive data-collection environment into a self-updating contextual modeling framework. By generating multiple interrelated models from normalized, graph-based representations of enterprise activity, the system 710 provides a foundation for higher-level orchestration processes, such as those described in FIGS. 8-11, which leverage the trained models to infer, plan, and execute context-aware actions within the enterprise computing environment.

FIG. 8 is a block diagram illustrating operational relationships among a context-aware action orchestration system 600, an orchestration layer 648, a prediction engine 652, and an agentic reasoning engine 642. In some embodiments, the orchestration layer 648, prediction engine 652, and agentic reasoning engine 642 may cooperate to translate context derived from enterprise data into predicted tasks and coordinated actions. While FIG. 8 depicts a logical arrangement of subsystems for clarity, the illustrated components may execute together or separate within a distributed computing environment, and communication among them may occur through programmatic interfaces, message queues, or shared data structures.

In some embodiments, the orchestration layer 648 may serve as the central coordination framework responsible for governing information flow between the predictive and reasoning subsystems. The orchestration layer 648 may receive continuous contextual updates from the monitoring and training layers described with respect to FIGS. 6 and 7 and maintain state awareness of the enterprise system 710 based on various data sources 804. Based on the received inputs and updates, the orchestration layer 648 may selectively activate one or more trained models contained within the prediction engine 652 to evaluate current conditions and forecast likely future actions. The orchestration layer 648 may then pass the outputs of the prediction engine 652 to the agentic reasoning engine 642 for interpretation, decomposition, and planning.

In some embodiments, the orchestration layer 648 may support persistent job spaces that maintain memory of multi-day or multi-stage workflows across devices and sessions. A job space may track state information, task progress, and associated artifacts regardless of where the user reconnects (e.g., from a mobile client, desktop interface, remote API session, etc.). The persistent context allows predictions and reasoning to continue seamlessly across heterogeneous environments and user devices without loss of continuity.

The prediction engine 652 may operate as a computational subsystem configured to generate predictive inferences from the trained models 628. Upon receiving contextual data and triggers from the orchestration layer 648, the prediction engine 652 may access knowledge graphs 806, model parameters, and behavioral embeddings to determine probable next tasks or decision points. The prediction engine 652 may output ranked predicted tasks 810, each accompanied by confidence scores and contextual justifications. These predictions represent candidate actions or events that are likely to occur or require attention within the enterprise environment. In some embodiments, the prediction engine 652 may operate asynchronously and may continually update its predictions as new enterprise signals are ingested, allowing the orchestration layer 648 to maintain a rolling forecast of organizational activity.

The agentic reasoning engine 642 receives the predicted tasks 810 from the prediction engine 652 and applies higher-order reasoning to determine how those tasks should be performed, by whom or what, and in what sequence. The agentic reasoning engine 642 may analyze dependencies among predicted tasks, identify required resources or approvals, and generate multi-step execution strategies. An agent-aware planner 812 within the agentic reasoning engine 642 may assign specific agents 802 to sub-tasks based on capability, availability, or authorization levels, while a sub-task-agent assignment component 814 may formalize these pairings into actionable plans. The agentic reasoning engine 642 may also verify that each proposed action aligns with organizational policies and constraints received from the orchestration layer 648. In some embodiments, the agentic reasoning engine 642 may produce a task graph or plan that the orchestration layer 648 subsequently transforms into concrete execution commands.

In some embodiments, the orchestration architecture may support an open agent platform in which internal or third-party developers can register capabilities through standardized APIs. Agent registration and discovery may occur from any environment (e.g., cloud service, on-prem module, embedded application, etc.) and the orchestration layer 648 may ensure safe execution through sandboxing, authentication, and policy enforcement. This extensibility allows organizations to incorporate specialized domain agents while maintaining consistent governance and interoperability across devices and deployment platforms.

The orchestration layer 648 may integrate the outputs of both the prediction engine 652 and the agentic reasoning engine 642 to produce coherent, policy-compliant action orchestration. The orchestration layer 648 may arbitrate among competing predictions, prioritize actions according to enterprise objectives, and merge overlapping task plans. The orchestration layer 648 may further maintain feedback channels that collect execution results and performance metrics from the agents 802, enabling the context-aware action orchestration system 600 to evaluate effectiveness and update future predictions. Through this bi-directional interaction, the orchestration layer 648 effectively couples predictive modeling with dynamic reasoning, forming an adaptive decision loop capable of both anticipating and executing tasks across the enterprise computing environment.

The coordinated operation shown in FIG. 8 enables the context-aware action orchestration system 600 to function as an intelligent intermediary between passive data analytics and active enterprise automation. The prediction engine 652 provides foresight into emerging needs or opportunities, while the agentic reasoning engine 642 transforms those forecasts into executable plans. The orchestration layer 648 supervises and harmonizes both processes, ensuring that model-driven insights result in meaningful, contextually appropriate enterprise actions.

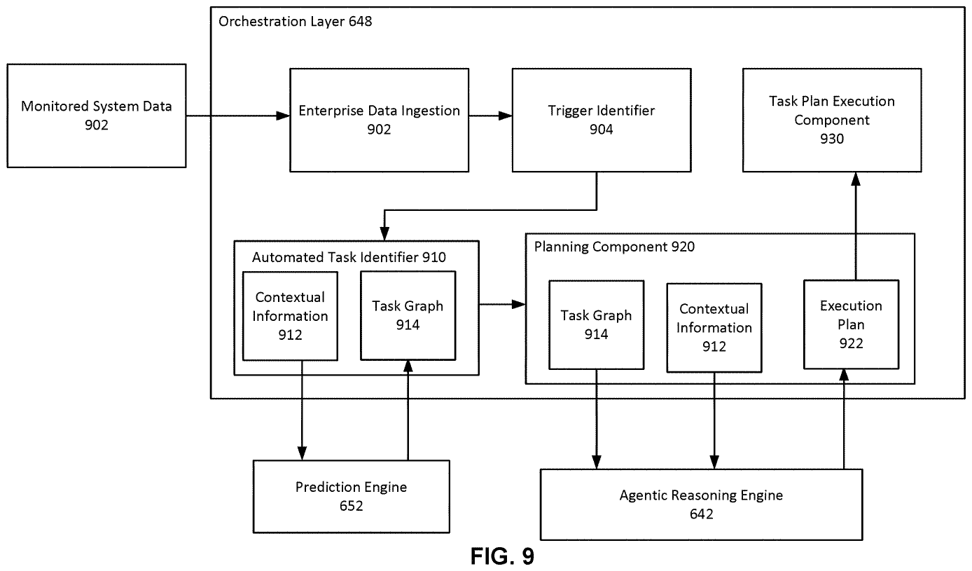

FIG. 9 is a block diagram illustrating the internal components and data flow of an orchestration layer 648 within the context-aware action orchestration system 600. The orchestration layer 648 may function as the supervisory control system that connects real-time enterprise data with predictive models and execution mechanisms. Through continuous monitoring, task identification, and plan generation, the orchestration layer 648 may provide recommendations or actions produced by the context-aware action orchestration system 600 that are contextually accurate, policy-compliant, and aligned with ongoing enterprise operations. Although shown as a single logical component, the orchestration layer 648 may be implemented using distributed services, containerized processes, or parallel task coordinators operating in concert.

In some embodiments, the orchestration layer 648 may include an enterprise data ingestion component 902 that serves as the entry point for real-time operational data. The enterprise data ingestion component 902 may aggregate monitored signals from various systems described previously, including collaboration tools, project-tracking systems, communication platforms, document repositories, and so forth. Each signal may correspond to a discrete enterprise event, such as the creation or modification of a document, assignment of a task, initiation of a workflow, update of an analytics dashboard, or any other action. The enterprise data ingestion component 902 may normalize incoming signals into structured records, attaches metadata such as timestamps, user identifiers, and originating applications, and may transmit the normalized data to downstream modules within the orchestration layer 648. In some configurations, the enterprise data ingestion component 902 may employ streaming interfaces or event buses to handle continuous updates, ensuring minimal latency between the occurrence of an enterprise event and its availability for inference processing.

The orchestration layer 648 may further include a trigger identifier 904 configured to evaluate the ingested enterprise data and determine when conditions exist that warrant predictive or reasoning operations. The trigger identifier 904 may analyze monitored system data to detect predefined or learned patterns indicative of pending tasks, risks, or opportunities. Example triggers may include completion of a major project milestone, a surge in communication frequency on a particular topic, divergence between planned and actual workflow metrics, or the like. The trigger identifier 904 may use both rule-based conditions and model-based anomaly detectors to identify significant context changes. Upon detection of such conditions, the trigger identifier 904 activates the prediction engine 652 to generate updated forecasts or directs the agentic reasoning engine 642 to re-evaluate ongoing task plans.

An automated task identifier 910 may operate in coordination with the trigger identifier 904 to determine which specific actions or tasks are implicated by the detected enterprise events. The automated task identifier 910 may correlate contextual information 912 from the knowledge graph with historical model outputs to classify event patterns into known task categories. For instance, a spike in document revisions combined with a scheduled product-launch date may be recognized as a “release-preparation” task. The automated task identifier 910 thus bridges raw contextual signals with semantically meaningful enterprise activities, forming the input for predictive analysis and subsequent orchestration.

In some embodiments, a planning component 920 may generate structured task graphs 914 and corresponding execution plans 922 based on predictions produced by the prediction engine 652 and reasoning strategies from the agentic reasoning engine 642. The planning component 920 may decompose high-level objectives into hierarchically organized task nodes linked by dependency relationships. For example, each node may reference required resources, responsible agents, and preconditions for execution. The planning component 920 may also assign weights or priorities to nodes according to confidence levels or enterprise goal alignment. The output of the planning component 920 may be a machine-interpretable representation of the recommended actions, which can be subsequently consumed by execution systems or user interfaces.

A task plan execution component 930 may manage the implementation of the execution plans 922 produced by the planning component 920. The task plan execution component 930 may coordinate with available agents, applications, or robotic process tools to initiate corresponding operations. In some embodiments, the task plan execution component 930 may generate commands, API calls, task tickets, etc. in downstream enterprise systems, and may monitor acknowledgment or completion signals to verify successful execution. The task plan execution component 930 may also record outcomes and operational metrics that feed back to the orchestration layer 648 for ongoing model refinement and performance tracking.

Throughout these processes, the orchestration layer 648 continuously exchanges contextual information 912 between its internal components and the connected predictive and reasoning engines. The contextual information 912 may include structured graph data, learned embeddings, or semantic tags representing the current enterprise state. By maintaining this shared context, the orchestration layer 648 provides and maintains a consistent understanding across all layers of the context-aware action orchestration system 600 and enables coherent transitions between prediction, reasoning, and execution phases.

In some embodiments, the orchestration layer 648 may also enforce policy-aware and permission-based controls across all inference and execution activities. Each data item ingested through the enterprise data ingestion component 902 may carry access-control metadata that defines user- and group-level privileges, data-sensitivity designations, compliance classifications, or the like. The orchestration layer 648 may evaluate these attributes prior to invoking predictive or reasoning models, ensuring that contextual information 912 exposed to each component remains consistent with enterprise governance and confidentiality requirements. When generating execution plans, the orchestration layer 648 may further apply fine-grained access filters, redaction rules, and data-masking policies to restrict agents and downstream systems to only those resources authorized for their respective roles. These safeguards enable secure orchestration across multi-tenant or regulated environments while maintaining traceability for all automated decisions.

Accordingly, the orchestration layer 648 may act as an intelligent control hub. The enterprise data ingestion component 902 provides situational awareness, the trigger identifier 904 and automated task identifier 910 detect actionable conditions, and the planning component 920 and task plan execution component 930 translate model predictions into concrete enterprise operations. Through this layered coordination, the orchestration layer 648 may convert continuously evolving enterprise data into context-aware actions that advance organizational objectives while maintaining adaptive responsiveness to changing conditions.

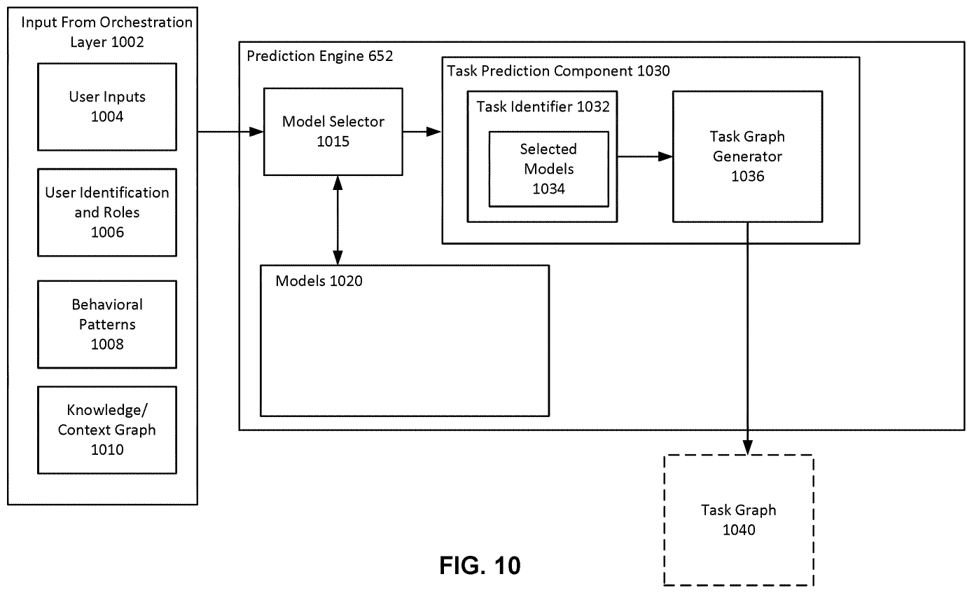

FIG. 10 is a block diagram illustrating internal components of a prediction engine 652 of the context-aware action orchestration system 600. The prediction engine 652 operates as an adaptive analytical subsystem configured to evaluate contextual enterprise data and generate forecasts, recommendations, or inferred tasks representative of expected future actions within the enterprise computing environment. In some embodiments, the prediction engine 652 may function as the inference core of the orchestration layer 648 described with reference to FIG. 9, receiving current contextual information and model parameters, applying trained predictive algorithms, and outputting structured task predictions for downstream processing by the agentic reasoning engine 642.

In some embodiments, the prediction engine 652 may receive a combination of user inputs 1004 and input from the orchestration layer 1002. The user inputs 1004 may include, for example, explicit queries, user-initiated tasks, or priority modifications that guide the predictive process. The input from the orchestration layer 1002 may include dynamic context data aggregated by the enterprise data ingestion component 902 of FIG. 9, as well as system triggers and environmental indicators detected by the trigger identifier 904. The prediction engine 652 may combine these inputs with internal context representations derived from the knowledge or context graph 1010, which encodes entities, relationships, and recent activities across the enterprise environment.

In some embodiments, the prediction engine 652 includes a model selector 1015 that identifies which trained predictive models should be invoked for a given analysis cycle. The model selector 1015 may access a repository of models 1020, including user-specific models, role-based models, and enterprise-level models generated by the training layer 620 of FIG. 6. The selection process may consider contextual factors such as the type of trigger event, domain of activity, or the identity and role of the requesting user. For example, if the incoming context pertains to sales operations, the model selector 1015 may choose a model trained on historical sales-cycle patterns. In some implementations, the model selector 1015 may ensemble multiple models to produce blended predictions when enterprise activities involve overlapping domains. Thus, the model selector 1015 may generate or identify selected models 1034 for performing action prediction.

In some embodiments, a behavioral patterns component 1008 may analyze recent and historical activity data to detect correlations, anomalies, or emerging trends that inform the predictive process. This component may compute temporal statistics, extract sequence patterns, and generate embeddings that describe user or team behavior. The behavioral patterns component 1008 may integrate with the model selector 1015 to fine-tune model parameters in real time based on current activity context. For example, when the system detects a shift in work cadence or communication frequency, the behavioral patterns component 1008 may adjust weighting functions within the selected model to emphasize recent observations over long-term averages.

In some embodiments, the model selector 1015 and orchestration layer 648 together implement model-agnostic orchestration, permitting simultaneous use of heterogeneous predictive and reasoning models. The model repository may include deep-learning architectures, probabilistic graphical models, rule-based systems, external large-language-model interfaces, or any combination of such. The orchestration layer 648 may determine which model or ensemble of models is most appropriate for a given context and aggregates their respective outputs into unified predictions. This design allows the system to leverage diverse analytical techniques within a single inference framework, improving robustness and adaptability across varied enterprise domains.

A user identification and roles component 1006 may provide personalization and access awareness to the predictive process. The user identification and roles component 1006 associates each context instance with corresponding user identifiers, organizational roles, and permission sets, ensuring that task predictions and recommendations align with the authority and responsibilities of each user. In some embodiments, the user identification and roles component 1006 interacts with enterprise directories or authentication systems to retrieve hierarchical relationships, allowing predictions to reflect both individual and managerial perspectives.

During operation, the prediction engine 652 may generate task predictions 1030 through a combination of learned model inference and contextual reasoning. A task identifier 1032 may label or classify predicted actions according to enterprise taxonomies, such as “document approval,” “project escalation,” or “budget adjustment.” A task graph generator 1036 may construct a task graph 1040 that captures dependencies among predicted actions, their triggers, and the relevant contextual elements. Each node in the task graph 1040 may represent an action, entity, or resource, and each edge may denote causal, temporal, or collaborative relationships. The task graph generator 1036 may also calculate confidence levels or priority rankings for each predicted node and may encode these as edge weights or metadata.

In some embodiments, the prediction engine 652 may employ an iterative prediction-refinement loop. The task graph 1040 may be evaluated by the orchestration layer 648 to validate consistency with enterprise policies or ongoing projects. Feedback from the orchestration layer 648 or the agentic reasoning engine 642 may be used to update the model selector 1015 and recalibrate prediction scores. This closed-loop architecture enables the prediction engine 652 to learn dynamically from both user interactions and system outcomes, improving prediction accuracy over time.

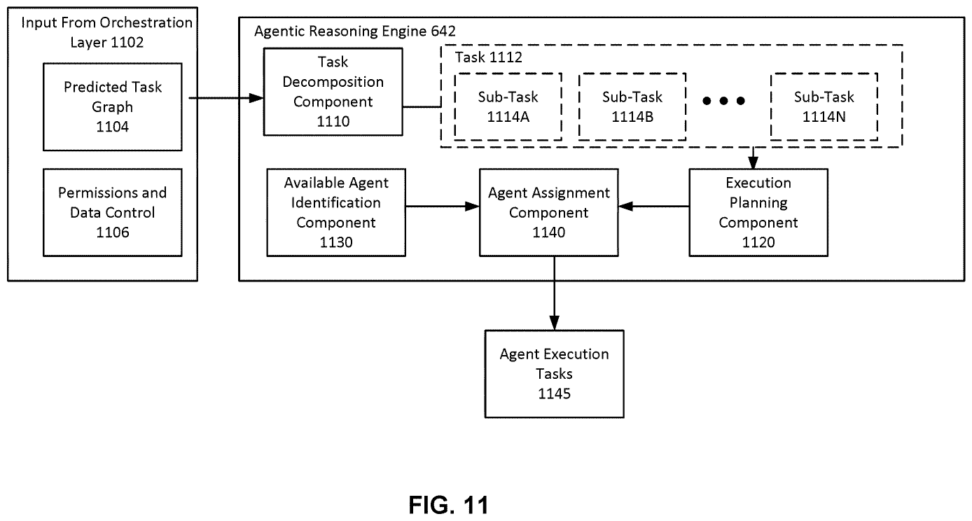

The configuration shown in FIG. 10 allows the prediction engine 652 to act as a continuously adaptive forecasting mechanism. By integrating user inputs, contextual signals, behavioral analytics, and trained model outputs, the prediction engine 652 provides the orchestration layer 648 with precise and situationally relevant foresight into forthcoming tasks, dependencies, and enterprise developments. The predicted actions and task graphs generated by the prediction engine 652 form the foundation for the multi-agent planning and execution processes implemented by the agentic reasoning engine 642, as described in greater detail with reference to FIG. 11.

FIG. 11 is a block diagram illustrating the internal components of an agentic reasoning engine 642 of the context-aware action orchestration system 600. The agentic reasoning engine 642 may function as a planning and coordination subsystem configured to transform predicted actions or task graphs produced by the prediction engine 652 (see FIG. 10) into structured execution strategies that can be performed by automated or human agents. While the prediction engine 652 anticipates what actions are likely or necessary within the enterprise, the agentic reasoning engine 642 determines how those actions should be carried out, by whom, and in what sequence.

In some embodiments, the agentic reasoning engine 642 may receive, as input, a predicted task graph 1104 generated by the prediction engine 652. The predicted task graph 1104 may include nodes representing tasks, dependencies, resources, and contextual parameters derived from the enterprise knowledge graph and model outputs. The agentic reasoning engine 642 may analyze this task graph to understand relationships among tasks and to determine appropriate decomposition strategies. An input from the orchestration layer 1102 may provide additional situational context, such as real-time system states, current workloads, or policy constraints that influence the planning process.

A task decomposition component 1110 may interpret the predicted task graph 1104 and divide complex objectives into granular tasks 1112 and sub-tasks 1114A and 1114B, through 1114N suitable for parallel or sequential execution. Task decomposition may be guided by dependency hierarchies encoded in the task graph, by historical data indicating how similar objectives were previously accomplished, or by heuristic rules optimized for efficiency and compliance. For example, a high-level objective such as “prepare quarterly financial report” may be decomposed into discrete sub-tasks involving data aggregation, review, and approval workflows across multiple teams. In some embodiments, the task decomposition component 1110 may also evaluate which sub-tasks can be executed concurrently and which must await completion of prerequisite actions.

The agentic reasoning engine 642 further includes an available-agent identification component 1130 that determines which computational or human agents are capable of performing each sub-task. The available-agent identification component 1130 may query registries of available software agents, application programming interfaces (APIs), or user directories to identify resources having the appropriate functionality, permissions, or expertise. Agents may include system-level automation scripts, application-specific connectors, or individuals assigned specific roles within the enterprise. The available-agent identification component 1130 may evaluate attributes such as skill classification, current load, geographic or organizational location, and historical task performance to select optimal candidates for each sub-task.

In some embodiments, an agent assignment component 1140 may formalize the mapping between sub-tasks and identified agents, creating structured task-agent pairs that collectively define an executable plan. The agent assignment component 1140 may resolve conflicts where multiple agents are capable of performing the same sub-task by applying decision criteria such as efficiency, proximity to relevant data, or past reliability. In some implementations, the assignment process may consider multi-agent collaboration patterns, allowing certain sub-tasks to be distributed across cooperating agents operating in parallel. The resulting task-agent mapping may be represented as an annotated graph or serialized plan that is returned to the orchestration layer 648 for approval and scheduling.

In some embodiments, a permissions and data control component 1106 ensures that all planned actions conform to enterprise access rules, data-governance policies, and security constraints. This component may validate that each assigned agent possesses the appropriate access rights to the resources required for its sub-tasks. When necessary, the permissions and data control component 1106 may request temporary access tokens, route actions through trusted intermediaries, or anonymize sensitive data before execution. By enforcing these controls at the reasoning layer, the system may prevent unauthorized operations while maintaining transparency and compliance with enterprise governance requirements.

An execution-planning component 1120 may synthesize the outputs of the preceding components to generate a comprehensive execution schedule and workflow specification. The execution-planning component 1120 may order sub-tasks based on dependency constraints, allocate time or computational resources, and assign synchronization points for coordination among agents. The resulting plan may include metadata such as expected durations, confidence scores, and rollback procedures. In some embodiments, the execution-planning component 1120 may also simulate execution scenarios using stored performance statistics to estimate completion times and detect potential conflicts before plan initiation.

Once the execution-planning component 1120 finalizes a workflow, the agentic reasoning engine 642 may output agent execution tasks 1145 that are communicated to the orchestration layer 648. The orchestration layer 648 may then initiate the actual task executions through the task plan execution component 930 (see FIG. 9), monitor progress, and collect completion feedback. The agentic reasoning engine 642 may remain active throughout execution, dynamically updating the plan when conditions change. For example, the agentic reasoning engine 642 may alter the plan if a resource becomes unavailable or if a sub-task completes earlier than expected.

In some embodiments, the execution-planning component 1120 supports multi-agent collaboration, enabling multiple agents to operate concurrently or cooperatively on shared sub-tasks. The execution-planning component 1120 may coordinate message passing, shared-state synchronization, and conflict-resolution mechanisms among agents executing interdependent tasks. Collaboration patterns, such as producer-consumer chains or peer review loops, may be modeled explicitly within the execution plan so that outputs generated by one agent become contextual inputs for another. By orchestrating collaborative behavior, the agentic reasoning engine 642 may facilitate complex workflows that require interaction among several specialized systems or users while maintaining overall plan coherence and accountability.

Thus, the agentic reasoning engine 642 may function as an intelligent intermediary between predictive modeling and operational execution. By decomposing complex goals, assigning agents based on contextual capabilities, and enforcing policy compliance, the agentic reasoning engine 642 may transform abstract predictions into executable, auditable, and adaptive task plans. The interaction among the agentic reasoning engine 642, prediction engine 652, and orchestration layer 648 enables the system to deliver coordinated, context-aware enterprise actions that evolve in response to ongoing organizational dynamics.

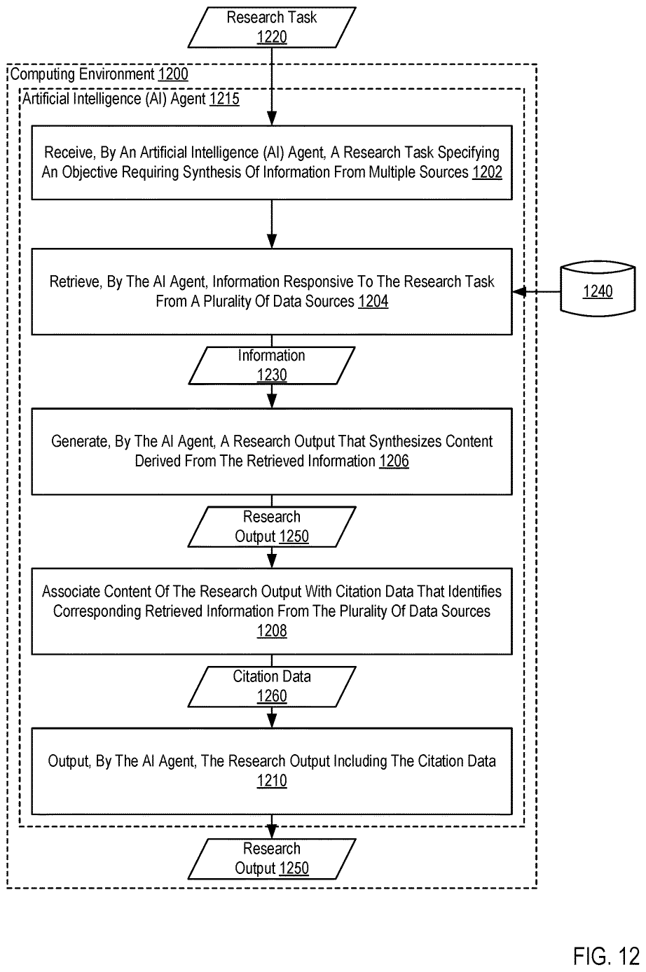

For further explanation, FIG. 12 sets forth a flowchart of an example method of agentic information retrieval and synthesis in accordance with some embodiments of the present disclosure. The method illustrated in FIG. 12 is carried out, for example, by an artificial intelligence (AI) agent 1215 executed in a computing environment 1200. As used herein, an AI agent 1215 refers to a software-based entity that is configured to perform a sequence of actions by combining automated reasoning, interaction with external computational resources, and model driven inference. The AI agent 1215 is capable of maintaining internal state across multiple actions and of selecting subsequent actions based on outputs generated during prior actions.

In some embodiments, the AI agent 1215 is configured to interact with one or more generative artificial intelligence models by generating prompts, structured requests, or contextual inputs, and by interpreting responses generated by the generative artificial intelligence models. The AI agent 1215 can interact with different generative artificial intelligence models that are configured for different types of inference, including natural language generation, summarization, classification, or embedding generation. Outputs produced by such models can be stored as part of internal state maintained by the AI agent 1215 and can influence subsequent actions performed by the AI agent 1215.

In some embodiments, the AI agent 1215 is further configured to invoke tools or services while performing the method illustrated in FIG. 12. Invoking a tool can include issuing a request to an application programming interface, executing a function, performing a search operation, querying a data system, initiating execution of another software component, or performing a computational operation. The AI agent 1215 can determine when to invoke a tool based on internal reasoning, based on outputs received from a generative artificial intelligence model, based on retrieved information, or based on combinations thereof. Results returned by invoked tools can be incorporated into internal state maintained by the AI agent 1215 and can be used as input to subsequent retrieval operations, subsequent interactions with generative artificial intelligence models, or subsequent tool invocations.

In some embodiments, the AI agent 1215 is configured to perform retrieval augmented generation by retrieving information from one or more data sources and supplying retrieved information as contextual input to one or more generative artificial intelligence models, including one or more large language models. In such embodiments, the AI agent 1215 can determine what information to retrieve, how retrieved information is formatted, and how retrieved information is incorporated into inputs provided to a large language model. Outputs generated by the large language model using the retrieved information can be received by the AI agent 1215 and used as part of subsequent reasoning, decision making, or generation performed by the AI agent 1215.

In some embodiments, the AI agent 1215 is embodied as a collection of computer program instructions executed by one or more processors within the computing environment 1200. The computing environment 1200 can include physical hardware, virtualized hardware, container-based execution environments, serverless execution environments, or combinations thereof. The AI agent 1215 can be instantiated as a long-lived process, a session scoped process, or an on demand process, and can operate autonomously or in coordination with other software components while executing the method illustrated in FIG. 12.

The method of FIG. 12 includes receiving 1202, by the AI agent 1215, a research task 1220 specifying an objective requiring synthesis of information from multiple sources. Receiving 1202 the research task 1220 can be carried out, for example, by the AI agent 1215 obtaining input that defines a goal, question, or problem statement for which information from more than one data source is to be combined, compared, analyzed, or otherwise synthesized. The research task 1220 can be received in a variety of forms, including as natural language text, as a structured request containing one or more fields, as a machine generated instruction produced by another software component, or as a combination thereof.

In some embodiments, the research task 1220 is provided directly by a user through a user interface that is coupled to the computing environment 1200. In such embodiments, the research task 1220 can include free form text entered by the user that describes an information need, an analysis objective, or a synthesis objective. In other embodiments, the research task 1220 is generated programmatically by another software component and transmitted to the AI agent 1215 through an application programming interface, a message queue, or another inter process communication mechanism. For example, the research task 1220 can be generated in response to detection of a triggering event, execution of a scheduled workflow, or completion of a prior processing step performed by another software component.

In some embodiments, the research task 1220 specifies an objective that inherently requires synthesis of information from multiple sources by identifying a topic, subject area, or analytical goal for which relevant information is expected to be distributed across different data sources. The research task 1220 can explicitly identify that multiple sources are to be consulted, or the need for multiple sources can be inferred by the AI agent 1215 based on the nature of the objective specified by the research task 1220. For example, an objective that involves comparing competing technologies, summarizing a body of technical literature, analyzing an incident using data from different systems, or generating a comprehensive overview of a subject can require retrieval and synthesis of information from multiple distinct sources.

In some embodiments, upon receiving the research task 1220, the AI agent 1215 can parse or interpret the research task 1220 to identify one or more parameters associated with the objective. Such parameters can include a subject matter of interest, a desired scope or depth of analysis, constraints on timeliness or completeness, or other characteristics that influence how subsequent steps of the method are carried out. Information derived from the research task 1220 can be stored as part of internal state maintained by the AI agent 1215 and can be referenced during later stages of the method illustrated in FIG. 12.

As an example, the research task 1220 can specify an objective to generate a synthesized overview of a technical issue by incorporating information drawn from internal documentation and external publications. In this example, the AI agent 1215 can receive the research task 1220 as natural language text submitted through a user interface, interpret the objective as requiring synthesis across multiple sources, and proceed to subsequent steps of the method in order to retrieve, analyze, and synthesize information responsive to the research task 1220. This example is provided for purposes of illustration and is not intended to limit the manner in which the research task 1220 can be received or interpreted.

The method of FIG. 12 also includes retrieving 1204, by the AI agent 1215, information 1230 responsive to the research task 1220 from a plurality of data sources 1240. Retrieving 1204 the information 1230 can be carried out, for example, by the AI agent 1215 identifying one or more data sources that are likely to contain information relevant to the objective specified by the research task 1220 and obtaining content from those data sources for use in subsequent processing. The plurality of data sources 1240 can include heterogeneous sources that differ in format, location, access mechanism, or type of information provided.

In some embodiments, retrieving 1204 the information 1230 includes issuing one or more queries to the plurality of data sources 1240. Such queries can be formulated by the AI agent 1215 based on an interpretation of the research task 1220, based on intermediate reasoning performed by the AI agent 1215, or based on a combination thereof. Queries can be expressed in natural language, as structured query expressions, as keyword based searches, or using other query formats supported by the respective data sources. The AI agent 1215 can adapt query parameters across multiple retrieval operations in order to broaden, narrow, or otherwise refine the information that is retrieved.

In some embodiments, the plurality of data sources 1240 includes data sources that are internal to an organization as well as data sources that are external to the organization. Internal data sources can include document repositories, databases, knowledge bases, messaging systems, ticketing systems, or other systems that store organization specific information. External data sources can include publicly accessible databases, web based content sources, application programming interfaces provided by third parties, or other externally maintained information systems. The AI agent 1215 can retrieve information 1230 from different data sources using different access mechanisms appropriate to each data source.

In some embodiments, retrieving the information 1230 is performed as part of a retrieval augmented generation process in which retrieved information is intended to be incorporated into subsequent interactions with one or more generative artificial intelligence models. In such embodiments, the AI agent 1215 can retrieve information 1230 in a form suitable for inclusion as contextual input to a large language model, such as text passages, structured data representations, summaries, or extracted excerpts. The AI agent 1215 can also perform preprocessing of retrieved information 1230, including filtering, normalization, deduplication, or segmentation, prior to using the retrieved information in later stages of the method.

In some embodiments, retrieving the information 1230 is performed iteratively, such that the AI agent 1215 retrieves information from the plurality of data sources 1240 in multiple retrieval operations over time. For example, initial retrieval operations can be performed to obtain a broad set of information responsive to the research task 1220, and subsequent retrieval operations can be performed to obtain more specific information based on intermediate results, intermediate reasoning, or gaps identified in previously retrieved information. Information retrieved during retrieving 1204 can be stored as part of internal state maintained by the AI agent 1215 and can be subsequently referenced or reused.

As an example, the AI agent 1215 can retrieve 1204 information 1230 from a plurality of data sources 1240 by querying an internal document repository for relevant reports and querying an external content source for related publications. In this example, the AI agent 1215 can combine information retrieved from both sources to form a corpus of information responsive to the research task 1220. This example is provided for purposes of illustration and is not intended to limit the manner in which retrieving 1204 can be performed.

The method of FIG. 12 also includes generating 1206, by the AI agent 1215, a research output 1250 that synthesizes content derived from the retrieved information 1230. Generating 1206 the research output 1250 can be carried out, for example, by the AI agent 1215 processing the retrieved information 1230 to produce a coherent output that integrates, combines, or relates information obtained from multiple data sources. The research output 1250 can be generated to reflect analysis, comparison, summarization, or other forms of synthesis that go beyond reproducing individual pieces of retrieved information in isolation.

In some embodiments, generating the research output 1250 includes supplying at least a portion of the retrieved information 1230 as contextual input to one or more generative artificial intelligence models, including one or more large language models. The AI agent 1215 can construct prompts or structured inputs that incorporate retrieved information 1230 along with instructions that guide how the generative artificial intelligence model is to synthesize the information. For example, the AI agent 1215 can instruct a large language model to generate a narrative explanation, a comparative analysis, or a structured summary that reflects relationships among information drawn from different data sources.

In some embodiments, the AI agent 1215 generates the research output 1250 in a structured form that includes multiple sections, portions, or logical groupings of content. Such structure can be determined by the AI agent 1215 based on the nature of the retrieved information 1230, based on an inferred organization of subject matter, or based on internal reasoning performed by the AI agent 1215 during generation. The AI agent 1215 can generate different portions of the research output 1250 in separate generation steps and can combine those portions into a unified output.

In some embodiments, generating the research output 1250 includes synthesizing content that reflects relationships among different pieces of retrieved information 1230, such as similarities, differences, trends, or dependencies. The AI agent 1215 can perform intermediate reasoning over the retrieved information 1230 to identify such relationships and can incorporate results of that reasoning into the research output 1250. Intermediate versions generated during this process, such as outlines, intermediate summaries, or analytical notes, can be maintained as internal state by the AI agent 1215 while generating the research output 1250.

As an illustrative example, the AI agent 1215 can generate the research output 1250 by synthesizing content derived from retrieved information 1230 that includes internal reports and external publications related to a subject area. In this example, the AI agent 1215 can generate a consolidated output that integrates findings from the internal reports with context provided by the external publications, thereby producing a synthesized research output 1250 that reflects information drawn from multiple sources.

In some embodiments, generating 1206 the research output 1250 includes the AI agent 1215 performing multi step reasoning over the retrieved information 1230 in order to synthesize content that reflects relationships among information obtained from different data sources 1240. Multi step reasoning, as used herein, refers to a process in which the AI agent 1215 derives intermediate reasoning results that are used to guide subsequent reasoning steps during generation of the research output 1250. Rather than producing the research output 1250 in a single inferential operation, the AI agent 1215 can decompose the generation process into a sequence of reasoning steps, where outputs of earlier steps inform later steps.

In some embodiments, the AI agent 1215 performs multi step reasoning by generating intermediate conclusions, interpretations, or analytical constructs based on subsets of the retrieved information 1230. Such intermediate conclusions can include, for example, identifying themes present across multiple retrieved sources, determining points of agreement or divergence among retrieved information, inferring causal relationships, or organizing retrieved information into conceptual groupings. The AI agent 1215 can store such intermediate conclusions as part of internal state and can reference them when generating subsequent portions of the research output 1250. By doing so, the AI agent 1215 can ensure that later generated content is informed by reasoning performed earlier in the generation process.

In some embodiments, multi-step reasoning performed by the AI agent 1215 includes alternating between interactions with one or more generative artificial intelligence models and internal reasoning performed by the AI agent 1215. For example, the AI agent 1215 can supply retrieved information 1230 to a large language model to generate an initial analytical passage, examine the generated passage to derive an intermediate conclusion, and then use that intermediate conclusion to formulate additional inputs to the large language model for generating subsequent content. This iterative reasoning process allows the AI agent 1215 to progressively build the research output 1250 in a manner that reflects accumulated reasoning rather than isolated generation events.

In some embodiments, multi-step reasoning enables the AI agent 1215 to generate the research output 1250 in a structured and logically coherent manner, even when the retrieved information 1230 originates from heterogeneous data sources 1240. By reasoning across multiple steps, the AI agent 1215 can reconcile differences in terminology, perspective, or scope among retrieved sources and can generate content that integrates such information into a unified research output 1250. This approach improves the technical quality of the generated research output 1250 by allowing the AI agent 1215 to reason explicitly over retrieved information rather than relying solely on implicit reasoning performed by a generative model in a single pass.

The method of FIG. 12 also includes associating 1208 content of the research output 1250 with citation data 1260 that identifies corresponding retrieved information 1230 from the plurality of data sources 1240. Associating 1208 the content of the research output 1250 with the citation data 1260 can be carried out, for example, by the AI agent 1215 establishing links between portions of the research output 1250 and specific items of retrieved information 1230 that were used to generate those portions. The citation data 1260 can serve to indicate the origin of information reflected in the research output 1250 and to provide traceability between generated content and underlying source material.

In some embodiments, associating 1208 includes identifying one or more portions of the research output 1250 and determining which retrieved information 1230 contributed to generation of those portions. Portions of the research output 1250 can include individual statements, sentences, paragraphs, sections, or other logical groupings of content. For each such portion, the AI agent 1215 can associate citation data 1260 that identifies one or more corresponding items of retrieved information 1230 from the plurality of data sources 1240. The association can be recorded in a structured form that enables later inspection, auditing, or evaluation of the research output 1250.

In some embodiments, the citation data 1260 includes identifiers, references, or metadata associated with the retrieved information 1230. Such identifiers can include document identifiers, uniform resource identifiers, database record identifiers, timestamps, source names, or other information sufficient to identify the source of the retrieved information 1230. The AI agent 1215 can generate the citation data 1260 during generation of the research output 1250, after generation of the research output 1250, or incrementally as different portions of the research output 1250 are generated.

In some embodiments, associating 1208 is performed as part of the retrieval augmented generation process. For example, when retrieved information 1230 is supplied as contextual input to a large language model, the AI agent 1215 can track which portions of the retrieved information 1230 are included in prompts or structured inputs used during generation. Outputs generated by the large language model can then be correlated with the retrieved information 1230 that was supplied as context, allowing the AI agent 1215 to associate citation data 1260 with corresponding portions of the research output 1250. As an illustrative example, the AI agent 1215 can associate content of the research output 1250 with citation data 1260 by linking a generated summary paragraph to one or more documents retrieved from the plurality of data sources 1240 that provided information reflected in that paragraph.

The method of FIG. 12 also includes outputting 1210, by the AI agent 1215, the research output 1250 including the citation data 1260. Outputting the research output 1250 can be carried out, for example, by the AI agent 1215 causing the research output 1250 to be made available to another software component, a user interface, a storage system, or another destination within or external to the computing environment 1200. The research output 1250 is output in a form that includes the citation data 1260 such that associations between generated content and corresponding retrieved information 1230 are preserved.

In some embodiments, outputting 1210 includes transmitting the research output 1250 to a user interface for presentation to a user. In such embodiments, the citation data 1260 can be rendered alongside corresponding portions of the research output 1250, embedded within the research output 1250, or otherwise presented in a manner that allows a recipient to identify source information associated with generated content. The AI agent 1215 can format the research output 1250 and the citation data 1260 in accordance with display constraints, presentation preferences, or output requirements associated with the destination.

In some embodiments, outputting 1210 includes storing the research output 1250 in a data store, document repository, or other storage system. In such embodiments, the research output 1250 can be stored together with the citation data 1260 in a structured representation that enables later retrieval, review, or reuse. For example, the research output 1250 and the citation data 1260 can be stored as a document that includes embedded references, as a data structure that includes separate fields for generated content and citation information, or in another representation that preserves the association between content and citations.

In some embodiments, outputting 1210 includes transmitting the research output 1250 to another software component for further processing. For example, the AI agent 1215 can output the research output 1250 to a downstream workflow that performs evaluation, verification, review, or approval of the research output 1250. In such embodiments, the inclusion of the citation data 1260 enables subsequent components to assess the provenance of generated content and to perform additional processing based on the identified sources. As an illustrative example, the AI agent 1215 can output the research output 1250 including the citation data 1260 by presenting a synthesized report through a user interface, where each section of the report includes references to corresponding retrieved information 1230 from the plurality of data sources 1240. In this example, the citation data 1260 allows a user to inspect the sources underlying the generated content.

The approaches set forth herein provide concrete technical benefits over conventional information retrieval and generation systems. By enabling an AI agent 1215 to retrieve information from a plurality of data sources 1240, synthesize content derived from retrieved information 1230, and associate generated content with citation data 1260 that identifies corresponding source material, the described approach improves traceability, reliability, and usefulness of generated outputs. The inclusion of citation data 1260 within the research output 1250 allows downstream consumers, whether human or machine, to evaluate the provenance of generated content and to understand how the content relates to underlying source information. Additionally, the use of retrieval augmented generation and iterative processing by the AI agent 1215 enables more comprehensive synthesis of information distributed across multiple sources, reducing reliance on isolated data repositories and mitigating limitations of single pass generation. As a result, the described method improves the technical functioning of computer-based information synthesis systems by enabling generation of structured, source linked outputs that support auditing, reuse, and further automated processing within complex computing environments.

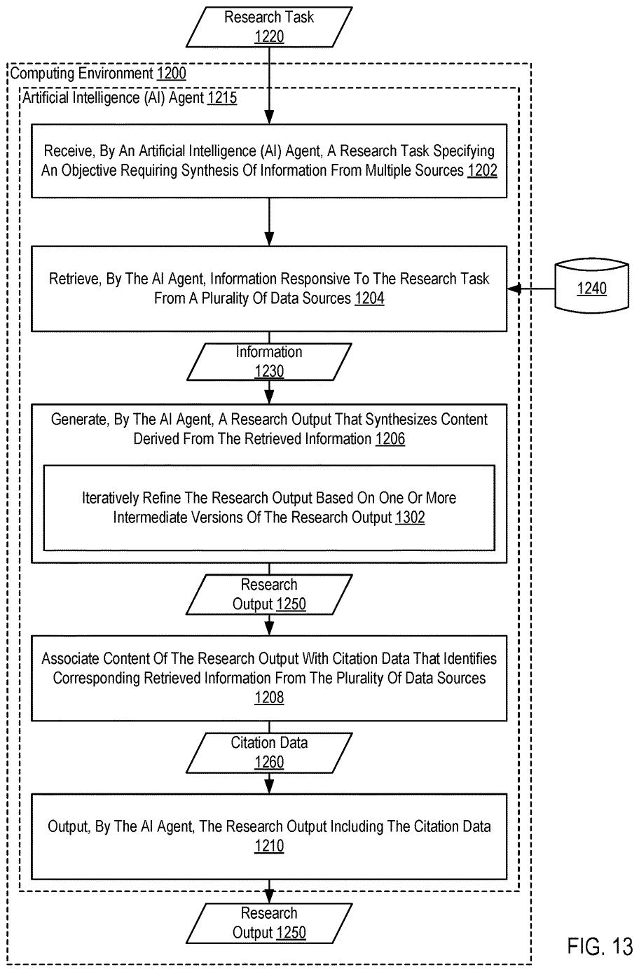

For further explanation, FIG. 13 sets forth a flowchart of another example method of agentic information retrieval and synthesis in accordance with some embodiments of the present disclosure. The method of FIG. 13 is similar to FIG. 12, differing in that generating 1206 the research output 1250 includes iteratively refining 1302 the research output 1250 based on one or more intermediate versions of the research output 1250. In these embodiments, the research output 1250 is produced through a sequence of generation stages rather than through a single generation step.

In some embodiments, iteratively refining 1302 the research output 1250 includes generating an initial version of the research output 1250 and then producing one or more subsequent intermediate versions in which content of the research output 1250 is modified based on information available at that stage of execution. Each intermediate version of the research output 1250 can represent a provisional form of the final research output 1250 and can include content that is incomplete, subject to further analysis, or subject to verification. The AI agent 1215 can maintain intermediate versions of the research output 1250 as part of internal state and can reference one or more prior versions when generating subsequent versions.

In some embodiments, iterative refinement 1302 includes performing verification of content included in an intermediate version of the research output 1250. Such verification can include evaluating correspondence between generated content and retrieved information associated with that content, as described in further detail below. When verification indicates that one or more portions of an intermediate version of the research output 1250 are unsupported, inconsistent, or otherwise deficient, the AI agent 1215 can treat the verification outcome as a signal to further refine the research output 1250. In response, the AI agent 1215 can modify existing content, generate additional content, remove content, or trigger additional information retrieval prior to generating a subsequent intermediate version of the research output 1250.

In some embodiments, iterative refinement 1302 enables the AI agent 1215 to progressively improve technical quality of the research output 1250 by alternating between generation and evaluation. Early intermediate versions of the research output 1250 can focus on broad synthesis of retrieved information, while later intermediate versions can incorporate results of verification, additional retrieval, or more detailed reasoning. By using verification outcomes to guide refinement, the AI agent 1215 can converge toward a final research output 1250 that more accurately reflects retrieved information and that is better aligned with the intended objective of the method.

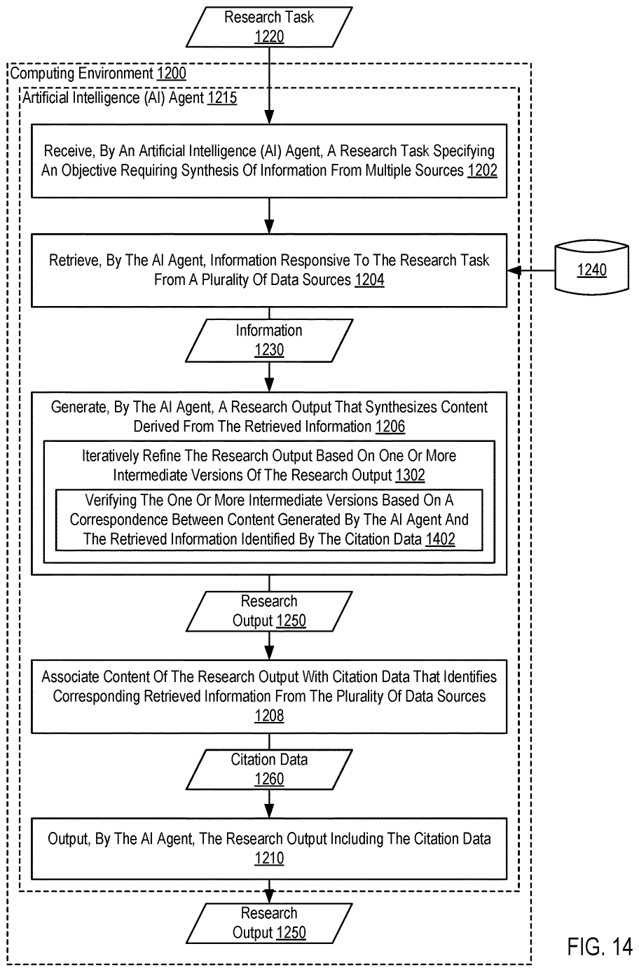

For further explanation, FIG. 14 sets forth a flowchart of another example method of agentic information retrieval and synthesis in accordance with some embodiments of the present disclosure. The method of FIG. 14 is similar to FIG. 13, differing in that iteratively refining 1302 the research output 1250 includes verifying 1402 the one or more intermediate versions based on a correspondence between content generated by the AI agent 1215 and the retrieved information 1230 identified by the citation data 1260. In some embodiments, verifying 1402 includes evaluating whether content included in an intermediate version of the research output 1250 is supported by retrieved information 1230 that has been associated with that content through the citation data 1260. The AI agent 1215 can perform this evaluation by examining the citation data 1260 associated with a portion of the research output 1250 and determining whether the retrieved information 1230 identified by the citation data 1260 provides sufficient support for the generated content. Verification can be performed at different levels of granularity, including at the level of individual statements, groups of statements, paragraphs, or sections of the research output 1250.

In some embodiments, verifying 1402 is performed after generation of an intermediate version of the research output 1250 and prior to generation of a subsequent intermediate version. In such embodiments, verification results can be used by the AI agent 1215 to determine whether additional refinement is required before the research output 1250 progresses toward a final form. Verification can also be performed incrementally as portions of the research output 1250 are generated, allowing the AI agent 1215 to assess correspondence between generated content and retrieved information 1230 during generation rather than only after generation is complete.

In some embodiments, verification 1402 enables the AI agent 1215 to assess reliability of generated content in a manner that is grounded in retrieved information 1230 rather than solely in model output. By relying on citation data 1260 to identify corresponding retrieved information 1230, the AI agent 1215 can perform verification in a structured and traceable manner that supports later auditing, review, or further automated processing. Results of verifying 1402 can be recorded as part of internal state maintained by the AI agent 1215 and can influence subsequent refinement, retrieval, or generation steps as the method illustrated in FIG. 14 proceeds.

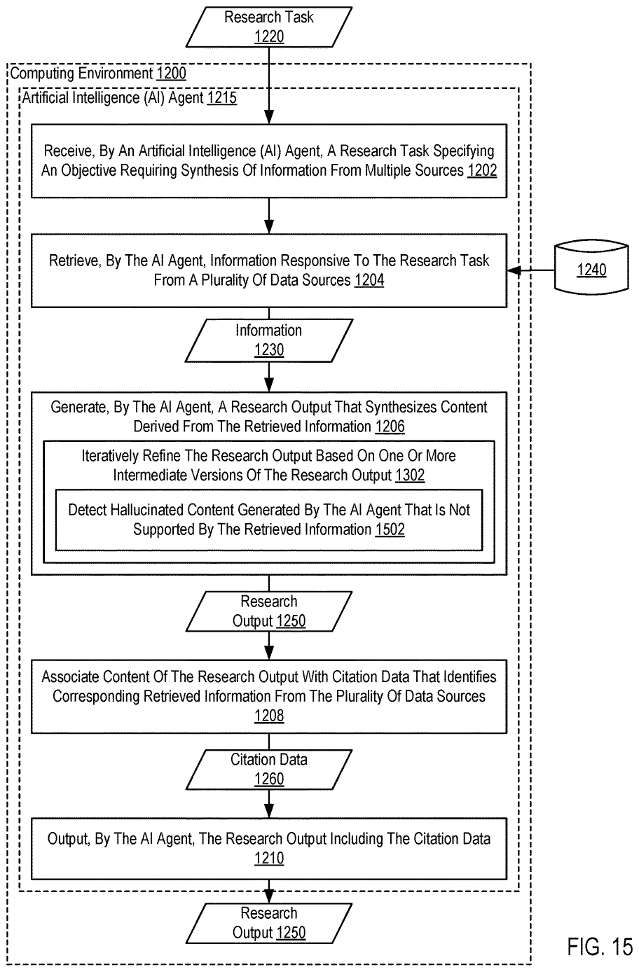

For further explanation, FIG. 15 sets forth a flowchart of another example method of agentic information retrieval and synthesis in accordance with some embodiments of the present disclosure. The method of FIG. 15 is similar to FIG. 13, differing in that iteratively refining 1302 the research output 1250 includes detecting 1502 hallucinated content generated by the AI agent 1215 that is not supported by the retrieved information 1230. In some embodiments, detecting 1502 hallucinated content includes identifying portions of an intermediate version of the research output 1250 for which corresponding retrieved information 1230 cannot be identified or for which retrieved information 1230 identified by citation data 1260 does not adequately support the generated content. The AI agent 1215 can perform this detection by comparing generated content against retrieved information 1230 associated with that content and determining whether the generated content extends beyond, contradicts, or is otherwise inconsistent with the retrieved information 1230.

In some embodiments, hallucinated content is detected when generated content includes factual assertions, relationships, or conclusions that are not present in the retrieved information 1230 or that cannot be reasonably inferred from the retrieved information 1230. Detection can be performed at different levels of granularity, including at the level of individual statements, sentences, paragraphs, or sections of the research output 1250. The AI agent 1215 can flag detected hallucinated content for further processing, modification, or removal during subsequent refinement steps.

In some embodiments, detecting 1502 hallucinated content is performed as part of or distinct from the verification process described above. In some embodiments, detection of hallucinated content provides an explicit signal to the AI agent 1215 that additional refinement of the research output 1250 is required. The AI agent 1215 can record detection results as part of internal state and can use those results to guide subsequent actions, including additional retrieval, regeneration of content, or modification of existing content.

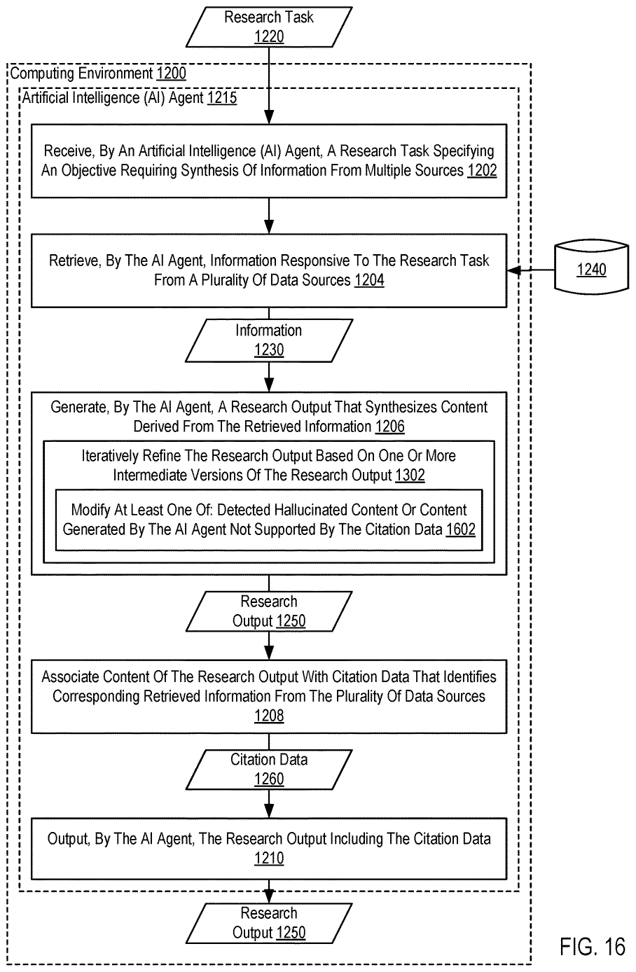

For further explanation, FIG. 16 sets forth a flowchart of another example method of agentic information retrieval and synthesis in accordance with some embodiments of the present disclosure. The method of FIG. 16 is similar to FIG. 13, differing in that iteratively refining 1302 the research output 1250 includes modifying 1602 a portion of an intermediate version of the research output 1250 comprising at least one of: detected hallucinated content or content generated by the AI agent 1215 not supported by the citation data 1260. In some embodiments, the intermediate version of the research output 1250 corresponds to a provisional or partial form of the research output 1250 that is generated prior to completion of the final output. Such an intermediate version can include one or more statements, sections, or other portions of generated content that are subject to further evaluation and refinement. The AI agent 1215 can identify portions of the intermediate version that have been flagged during verification or hallucination detection and can select those portions for modification 1602.

In some embodiments, modifying 1602 the portion of the intermediate version includes altering the identified portion of the intermediate version in a manner that increases correspondence between the generated content and retrieved information 1230 identified by the citation data 1260. This can include revising the content to more closely reflect retrieved information 1230, removing unsupported assertions, or regenerating the content using retrieved information 1230 as contextual input to one or more generative artificial intelligence models. The AI agent 1215 can incorporate the modified content into a subsequent intermediate version of the research output 1250.

In some embodiments, modifying 1602 the portion of the intermediate version is performed as part of an iterative cycle in which the intermediate version of the research output 1250 is repeatedly evaluated and adjusted until detected hallucinated content or unsupported content is reduced or eliminated. By modifying 1602 portions of the intermediate version rather than regenerating the research output 1250 in its entirety, the AI agent 1215 can incrementally refine the research output 1250 while preserving supported content generated during earlier stages of execution.

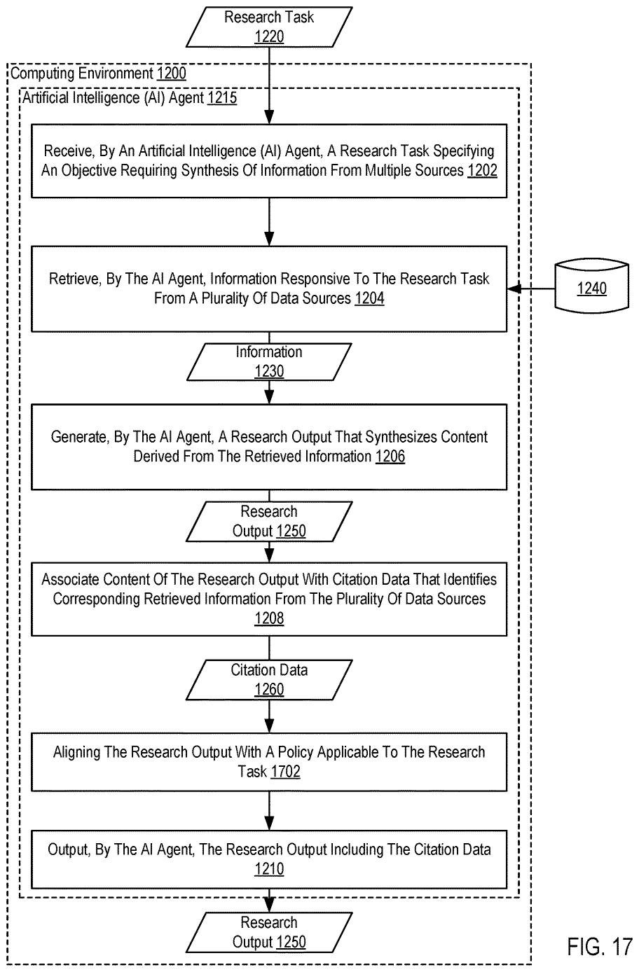

For further explanation, FIG. 17 sets forth a flowchart of another example method of agentic information retrieval and synthesis in accordance with some embodiments of the present disclosure. The method of FIG. 17 is similar to FIG. 12, differing in that the method of FIG. 17 also includes aligning 1702 the research output 1250 with a policy applicable to the research task 1220. In some embodiments, aligning 1702 the research output 1250 with the policy includes evaluating the content of the research output 1250 against one or more rules, constraints, or requirements defined by the policy. The policy applicable to the research task 1220 can specify conditions related to content inclusion, content exclusion, formatting, level of detail, source usage, or other characteristics that the research output 1250 is expected to satisfy. The AI agent 1215 can determine whether portions of the research output 1250 comply with the policy by examining generated content and associated citation data 1260.

In some embodiments, aligning 1702 includes modifying the research output 1250 in response to identifying content that does not satisfy the policy. Such modification can include removing content, revising content, restructuring portions of the research output 1250, or constraining generation of additional content during iterative refinement. The AI agent 1215 can perform such modification using techniques similar to those described with respect to modifying unsupported or hallucinated content, thereby incorporating policy considerations into the refinement process.

In some embodiments, the policy applicable to the research task 1220 is determined based on context associated with the research task 1220, such as an identity of a requester, a domain associated with the research task 1220, or an intended use of the research output 1250. Alignment 1702 can be performed after iterative refinement based on verification and hallucination detection, or alignment 1702 can be interleaved with earlier refinement stages such that policy considerations influence how the research output 1250 is generated and modified. By aligning the research output 1250 with the policy prior to output, the AI agent 1215 can ensure that the research output 1250 satisfies applicable constraints while retaining the earlier synthesized content.

In some embodiments, actions described herein, including verification of generated content, detection of hallucinated content, modification of unsupported content, and alignment of the research output 1250 with an applicable policy, are performed directly by the AI agent 1215 as part of the approaches set forth above. In such embodiments, the AI agent 1215 performs these actions using internal reasoning, internal state, and interactions with one or more generative artificial intelligence models as described above. The AI agent 1215 can evaluate correspondence between generated content and retrieved information, identify unsupported content, and modify the research output 1250 without reliance on external components beyond those already invoked during retrieval augmented generation.

In other embodiments, one or more of the actions described herein are performed by the AI agent 1215 by querying or invoking other computational entities. For example, the AI agent 1215 can request verification, hallucination detection, or policy alignment to be performed by another AI agent, by a specialized artificial intelligence model, by a remote service, or by another software component that is configured to perform a specific subset of functionality. In such embodiments, the AI agent 1215 can transmit portions of the research output 1250, citation data 1260, retrieved information 1230, or intermediate representations to the other entity and can receive results that indicate whether generated content is supported, whether hallucinated content has been detected, or whether the research output 1250 satisfies an applicable policy.

In some embodiments, the AI agent 1215 coordinates execution of these actions across multiple entities by acting as an orchestrator. In such embodiments, the AI agent 1215 determines which actions are to be performed locally and which actions are to be delegated, based on internal reasoning, configuration information, characteristics of the research output 1250, or other contextual information. Results returned from delegated actions can be incorporated into internal state maintained by the AI agent 1215 and can influence subsequent refinement, modification, or outputting of the research output 1250. By supporting both direct execution and delegated execution of verification, hallucination detection, and policy alignment, the described embodiments provide flexibility in how the AI agent 1215 carries out the methods described herein while preserving the functional behavior recited in the claims.

In some embodiments, agentic information retrieval and synthesis is performed over an extended research session that spans multiple interactions between one or more actors. In such embodiments, the AI agent 1215 maintains session state data within the computing environment 1200 that associates a previously generated research output 1250 with contextual information such as the original research task 1220, retrieved information 1230, citation data 1260, intermediate reasoning artifacts, and interaction history. The session state can be stored in volatile memory, persistent storage, or a session-scoped data structure accessible to the AI agent 1215.

In some embodiments, interactive interrogation of the research output 1250 is initiated by a follow-up input received from a user interface, an application programming interface, or another software component. Such follow-up input can include natural language queries, structured requests, or machine-generated instructions that reference the existing research output 1250. Upon receiving such input, the AI agent 1215 can identify one or more target portions of the research output 1250, such as a section, paragraph, statement, or conclusion, and determine whether additional retrieval, reasoning, or generation is required to respond to the follow-up input. In some embodiments, the AI agent 1215 performs interactive interrogation by issuing one or more messages to internal reasoning modules, generative artificial intelligence models, or retrieval services. For example, the AI agent 1215 can extract citation data 1260 associated with a targeted portion of the research output 1250, retrieve corresponding retrieved information 1230, and generate additional content that elaborates, clarifies, or refines that portion. Generated content can be incorporated into a revised version of the research output 1250 or provided as a supplemental response while preserving associations to source material.

In some embodiments, generation of the research output 1250 includes adapting the synthesized content based on a role, function, or organizational context associated with the research task 1220. Such context can be identified by the AI agent 1215 based on metadata associated with the research task 1220, identity information associated with a requester, or configuration data accessible within the computing environment 1200. The AI agent 1215 can store such contextual information as part of its internal state and reference it during generation and refinement of the research output 1250.

In some embodiments, role-specific adaptation is performed by selecting different prompt templates, generation parameters, or reasoning strategies when interacting with generative artificial intelligence models. For example, the AI agent 1215 can generate structured instructions that specify a level of technical depth, vocabulary preference, or analytical framing appropriate for a particular role. Outputs returned by the generative models can be evaluated and refined by the AI agent 1215 to ensure alignment with the identified role context while maintaining correspondence with retrieved information 1230 and citation data 1260.

In some embodiments, template alignment is performed by mapping synthesized content into a predefined document structure stored in a template repository or configuration store. The AI agent 1215 can retrieve a template definition that specifies required sections, headings, formatting rules, or data fields and can populate such template elements with generated content. During this process, citation data 1260 can be embedded within the template structure or associated with corresponding content fields, enabling the research output 1250 to conform to organizational standards while preserving traceability.

In some embodiments, retrieval and synthesis performed by the AI agent 1215 is influenced by one or more trust policies that govern how information from different data sources 1240 is selected and incorporated. Such trust policies can be represented as configuration rules, access control metadata, or policy objects stored within the computing environment 1200. The AI agent 1215 can evaluate such policies when selecting data sources, formulating queries, or weighting retrieved information 1230 during synthesis.

In some embodiments, trust-aware blending is performed by classifying data sources 1240 as internal or external and applying different retrieval or synthesis behaviors to each class. For example, the AI agent 1215 can prioritize retrieval from internal data sources and use external data sources as supplemental inputs when internal coverage is incomplete. During generation, the AI agent 1215 can associate source identifiers and confidence indicators with generated content via citation data 1260, enabling downstream actors to distinguish between internal and external contributions. In some embodiments, trust-aware blending further includes filtering, weighting, or annotating retrieved information 1230 based on trust-related attributes such as recency, provenance, or reliability scores. The AI agent 1215 can propagate such attributes through citation data 1260 and can use them as inputs to verification, hallucination detection, or policy alignment processes.

In some embodiments, verification of generated content and detection of hallucinated content are performed using one or more evaluation models that are distinct from generative artificial intelligence models used to generate the research output 1250. Such evaluation models can be implemented as separate software modules, machine learning models, or remote services accessible via application programming interfaces. The AI agent 1215 can invoke such evaluation models by transmitting portions of the research output 1250, citation data 1260, and corresponding retrieved information 1230 as evaluation inputs. In some embodiments, evaluation models produce outputs that include confidence scores, classification results, or indicators identifying unsupported or inconsistent content. The AI agent 1215 can receive such outputs as structured messages and store them as part of internal state. Based on the evaluation outputs, the AI agent 1215 can determine whether to modify generated content, trigger additional retrieval, or regenerate portions of the research output 1250 using updated contextual inputs.

In some embodiments, evaluation models are invoked iteratively during refinement, enabling the AI agent 1215 to assess improvements across successive intermediate versions of the research output 1250. By separating evaluation from generation, the AI agent 1215 enables modular verification workflows and allows evaluation logic to evolve independently from generation logic. In some embodiments, the research output 1250 is transmitted by the AI agent 1215 to one or more downstream software components for automated processing. Such transmission can occur via message queues, service calls, event streams, or data storage systems. The research output 1250 can be transmitted together with citation data 1260 in a structured representation that enables downstream components to parse, analyze, or act upon synthesized content.

In some embodiments, downstream workflows include other AI agents, rule-based systems, or orchestration engines that consume the research output 1250 as an input artifact. For example, a downstream agent can analyze the research output 1250 to generate recommendations, initiate planning workflows, or trigger alerts based on synthesized findings. Citation data 1260 enables such downstream actors to verify assumptions, retrieve source material, or perform additional processing based on identified data sources.

In some embodiments, the AI agent 1215 dynamically adapts retrieval behavior based on an inferred intent associated with the research task 1220 or intermediate reasoning results. Such intent can be determined by analyzing task parameters, intermediate outputs, or classification results produced by internal reasoning modules or auxiliary models. Based on inferred intent, the AI agent 1215 can select among different retrieval strategies, query formulations, or retrieval scopes. In some embodiments, adaptive retrieval expansion is performed when intermediate reasoning or verification identifies insufficient support for generated content. In response, the AI agent 1215 can issue additional retrieval requests to the plurality of data sources 1240, refine query parameters, or consult alternative data sources. Retrieved information obtained through such expanded retrieval can be incorporated into subsequent generation or refinement steps, enabling the AI agent 1215 to progressively improve completeness and support of the research output 1250.

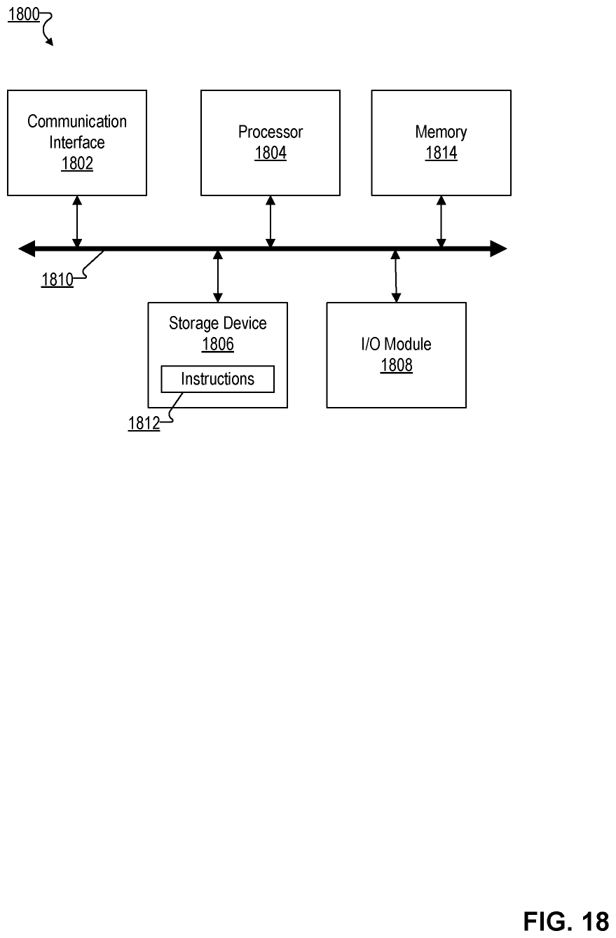

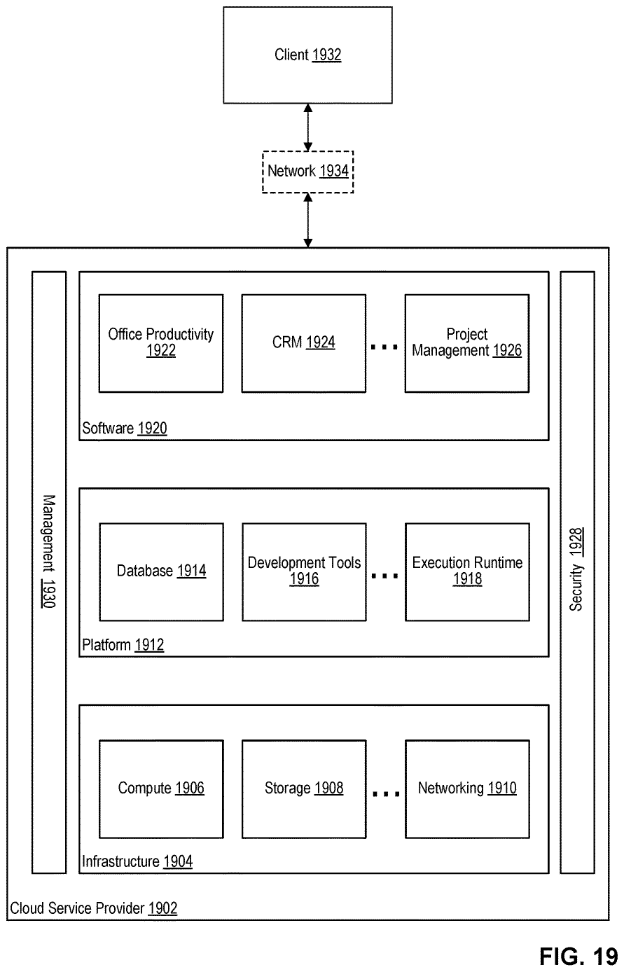

For further explanation, the sections included below provide some details regarding technologies that may be used in accordance with some embodiments. For example, FIG. 18 sets forth an example of a computing device that may be used in accordance with some embodiments. As an additional example of technologies that may be used in some embodiments, FIG. 19 sets forth a block diagram of a cloud service provider 1902 service architecture in accordance with some embodiments of the present disclosure.

For further explanation, FIG. 18 illustrates an exemplary computing device 1800 that may be specifically configured to perform one or more of the processes described herein. As shown in FIG. 18, computing device 1800 may include a communication interface 1802, a processor 1804, a storage device 1806, an input/output (I/O) module 1808, and computer memory 1814 communicatively connected (i.e., operatively coupled) to each other via a communication infrastructure 1810. While an exemplary computing device 1800 is shown in FIG. 18, the components illustrated in FIG. 18 are not intended to be limiting. Additional or alternative components may be used in other embodiments. Components of computing device 1800 shown in FIG. 18 will now be described in additional detail.

Communication interface 1802 may be configured to communicate with one or more computing devices. Examples of communication interface 1802 include a wired network interface (such as a network interface card), a wireless network interface (such as a wireless network interface card), a modem, an audio/video connection, and any other suitable interface.

Processor 1804 generally represents any type or form of processing unit capable of processing data and/or interpreting, executing, and/or directing execution of one or more of the instructions, processes, and/or operations described herein. Processor 1804 may perform operations by executing computer-executable instructions 1812 (e.g., an application, software, code, and/or other executable data instance) stored in storage device 1806.

Storage device 1806 may include one or more data storage media, devices, or configurations and may employ any type, form, and combination of data storage media and/or device. For example, storage device 1806 may include any combination of non-volatile media and/or volatile media. Electronic data, including data described herein, may be temporarily and/or permanently stored in storage device 1806. For example, data representative of computer-executable instructions 1812 configured to direct processor 1804 to perform any of the operations described herein may be stored within storage device 1806. In some examples, data may be arranged in one or more databases residing within storage device 1806.

I/O module 1808 may include one or more I/O modules configured to receive user input and provide user output. I/O module 1808 may include any hardware, firmware, software, or combination thereof supportive of input and output capabilities. For example, I/O module 1808 may include hardware and/or software for capturing user input, including a keyboard or keypad, a touchscreen component (e.g., touchscreen display), a receiver (e.g., an RF or infrared receiver), motion sensors, and/or one or more input buttons.

I/O module 1808 may include one or more devices for presenting output to a user, including a graphics engine, a display (e.g., a display screen), one or more output drivers (e.g., display drivers), one or more audio speakers, and one or more audio drivers. In certain embodiments, I/O module 1808 is configured to provide graphical data to a display for presentation to a user. The graphical data may be representative of one or more graphical user interfaces and/or any other graphical content as may serve a particular implementation. In some examples, any of the systems, computing devices, and/or other components described herein may be implemented by computing device 1800.

For further explanation and as an additional example of a supporting technology for some embodiments, FIG. 19 sets forth a block diagram of a cloud service provider service architecture in accordance with some embodiments. The cloud service provider 1902 can deliver a variety resources through a services-based consumption model where resources are consumed on-demand and as-a-service. Cloud service providers can provide services via cloud platforms such as, for example, Microsoft Azure™, Amazon Web Services (‘AWS’)™, Google Cloud Platform (‘GCP’)™, and others. In FIG. 19, the cloud service provider 1902 is accessed from a client device 1934 via a network 1932.

FIG. 19 depicts an embodiment where software 1920 is delivered as a service. Software-as-a-service (‘SaaS’) is a model where software applications are delivered over the internet as-a-service. Rather than installing and maintaining software locally, users can access software via a web browser or other network connected interface, eliminating the need for complex software and hardware management on the client-side. In FIG. 19, as examples of software 1920 that can be delivered as-a-service, the illustrated embodiment includes office productivity 1922 software, customer relationship management (‘CRM’) 1924 software, and project management 1926 software. The office productivity 1922 software can include applications designed to facilitate common business and personal tasks, including word processing applications, applications for spreadsheet creation, presentation design applications, and many others. The CRM 1924 software can include applications for managing a business organization's relationships and interactions with customers and potential customers. The project management 1926 software can include applications designed to help teams plan, organize, and manage projects efficiently by facilitating collaboration and tracking the progress of projects. Readers will appreciate that in other embodiments, other types of software may be delivered using a SaaS model.

FIG. 19 depicts an embodiment where platforms 1912 can be delivered as a service. Platform-as-a-service (‘PaaS’) is a model that provides cloud customers with platform resources that they can use to develop, run, and manage applications without the complexity of such deploying and managing such infrastructure on their own. In FIG. 19, as examples of platform 1912 resources that can be delivered as-a-service, the illustrated embodiment includes database 1914 services, development tools 1916 services, and execution runtime 1918 services. The database 1914 services can be used to provide access to databases without management overhead for the user as the cloud service provider manages the provisioning, scaling, and maintenance of the databases. The development tools 1916 services can provide developers with tools to design, develop, test, and deploy applications without needing to manage the underlying infrastructure. The execution runtime 1918 services can provide environments where applications or other forms of computer program code can be executed, including services to scale the execution environment. Readers will appreciate that in other embodiments, other platform resources may be delivered using a PaaS model.

FIG. 19 depicts an embodiment where infrastructure 1904 can be delivered as a service. Infrastructure-as-a-Service (‘IaaS’) is a model that provides virtualized computing resources over the internet, such that infrastructure such as servers, storage, networks, and others may be leased on demand rather than purchasing and maintaining physical hardware. In FIG. 19, as examples of infrastructure 1904 resources that can be delivered as-a-service, the illustrated embodiment includes compute 1906 services, storage 1908 services, and networking 1910 services. The compute 1906 services can be used to provide on-demand access to computational resources such as VMs, containers, and serverless functions, where the cloud service provider manages the provisioning, scaling, and maintenance of such resources. The storage 1908 services can provide storage resources that can be used to store and access data, without the need for customers to purchase and manage on-premises physical storage resources. The networking 1910 services can provide the ability to create and manage virtualized networking resources such as, for example, virtual private networks (‘VPNs’), firewalls, load balancers, and more. Readers will appreciate that in other embodiments, other infrastructure resources may be delivered using a IaaS model.

The cloud service provider of FIG. 19 also provides management 1930 resources. The management 1930 resources can include, for example, tools and interfaces that enable customers to efficiently deploy, monitor, and manage, their cloud services. Such tools can include web-based management consoles, command-line interfaces (‘CLIs’), APIs, automation tools, and other tools.

The cloud service provider of FIG. 19 also provides security 1928 resources. The security 1928 resources can include, for example, tools and services to help customers protect their cloud environments and ensure compliance with security standards. These tools and services may provide specific aspects of security, including identity and access management, network security, threat detection, compliance management, and others.

Readers will appreciate that many of the components described above may be delivered as services from a cloud service provider. For example, the virtual machines, containers, and pods described above may all be delivered via a cloud service provider. In other embodiments, other forms of compute resources may be used in place of the virtual machines or other compute resource. For example, AWS EC2 instances or other form of cloud compute instances may be utilized in place of the virtual machines.

In some embodiments, a system is provided for enabling interoperability between artificial intelligence (AI) assistants, external tools, and enterprise data sources through the use of a standardized communication protocol. The protocol defines a common interface through which heterogeneous AI agents and applications may exchange data, request services, and invoke workflows without requiring custom integrations. The system may be deployed in a distributed computing environment where various actors operate across networked machines. As used herein, an “MCP server” refers to a software service that resides within an enterprise computing environment and is responsible for exposing tools and workflows through the standardized protocol. An “MCP host” refers to a software service, which may be a component of an AI assistant, that is configured to connect to MCP servers and invoke tools exposed by those servers. An “MCP client” refers to any external agent, application, or service that consumes functionality made available by an MCP server. These actors may reside on-premises within enterprise infrastructure, in cloud environments managed by third-party providers, or in hybrid environments combining both.

The Model Context Protocol (MCP) is, in some embodiments, an open and standardized framework for enabling interoperability between artificial intelligence (AI) systems, external data sources, and digital tools. MCP provides a common interface through which AI assistants and client applications may exchange context, invoke services, and retrieve information in a structured and reliable manner. Rather than relying on custom-built integrations, MCP defines a uniform message format and communication flow, allowing diverse agents to interact seamlessly. Several versions of MCP may be employed in different embodiments, including early draft specifications intended for local agent experimentation, as well as enterprise-focused revisions that incorporate advanced features such as OAuth 2.0 or 2.1 authentication, multi-tenancy support, and compatibility layers for backward interoperability. Future versions of MCP may further evolve to support large-scale distributed deployments, standardized tool discovery mechanisms, and cross-protocol bridging with other agent communication standards.

In some embodiments, MCP is used to enable AI agents to query knowledge bases, invoke task-specific workflows, and orchestrate actions across heterogeneous digital environments. For example, an AI assistant implementing MCP may request a “search” tool from an MCP server to obtain information from a knowledge repository, or it may invoke a workflow exposed through MCP to perform a multi-step task such as document summarization or issue tracking. MCP thus serves as a unifying layer, abstracting away the differences between underlying systems and providing a consistent protocol surface for agents and applications.

While MCP offers significant advantages in standardization, alternative approaches may also be leveraged in some embodiments. For instance, proprietary application programming interfaces (APIs) may be employed to connect AI systems to external services, albeit at the cost of interoperability and maintainability. Other emerging agent communication frameworks, such as agent-specific protocols developed by open-source communities or commercial vendors, may also serve as alternatives or complements to MCP. These alternatives may provide narrower capabilities but can be integrated through adapters or compatibility layers. In some embodiments, a hybrid approach may be used in which MCP serves as the primary protocol for interoperability, while proprietary APIs or other protocols provide fallback support for specialized integrations.

In some embodiments, the MCP server exposes tools by maintaining a registry of available functions, each described with metadata such as tool name, required input parameters, expected output formats, and version information. When a client initiates a request, the MCP server receives the request over a network interface, parses the standardized message structure, and maps the request to the appropriate tool in the registry. The tool may then be executed either natively by the MCP server or by invoking a downstream service or workflow stored within the enterprise environment. For example, in one embodiment, a search tool may be executed by querying an enterprise knowledge index. This action may be carried out by the MCP server issuing structured queries to a backend search engine, retrieving a ranked set of documents, formatting the results into a standardized response, and returning that response to the client. In another embodiment, a conversational tool may be executed by forwarding user input to an AI model hosted locally or in a cloud service, receiving a generated response, and returning that response to the client through the protocol.

In certain embodiments, the MCP server is deployed in a hosted configuration to eliminate the need for local installation and manual configuration by end-users. In these embodiments, the server is instantiated as a managed service that runs on virtualized infrastructure. Authentication and authorization are centrally managed by the hosted service. When an MCP client attempts to connect, the server may redirect the client to an OAuth endpoint where the client authenticates using enterprise credentials. Upon successful authentication, the client receives an access token, which it includes in subsequent requests. The server validates each token against an authorization service before allowing access to tools. In alternative embodiments, authentication may be implemented using API keys generated for each user or client, with key validity checked against a secure store. In further variations, the hosted server may integrate with enterprise single sign-on systems to leverage existing identity providers.

In some embodiments, the hosted server supports multi-tenant environments. In these embodiments, the server assigns each tenant an isolated namespace in which their tools, workflows, and data reside. A tenant identifier may be included in every client request, and the server enforces isolation by routing requests to the correct tenant namespace. In some implementations, tenant isolation may be enforced at the data storage layer through the use of separate databases, while in others, logical separation within a shared database is achieved using row-level security policies. In yet other implementations, each tenant may be assigned a dedicated MCP server instance provisioned by an orchestration layer. In all cases, the server enforces data isolation so that one tenant cannot access another tenant's tools or data.

In some embodiments, the MCP server further provides mechanisms for dynamically exposing workflows created within the enterprise. An “agent workflow” may be defined as a sequence of steps or instructions, possibly persona-specific, that carry out a particular task. These workflows may be stored in a prompt library or workflow repository accessible to the server. An administrator may configure a workflow as “externally invokable,” which causes the MCP server to add it to its registry of tools. Once published, an MCP client may invoke the workflow just like any other tool by submitting a standardized request. The server retrieves the workflow definition, instantiates an execution environment, and runs each step of the workflow. Steps may include sending queries to data stores, invoking external APIs, or generating responses with AI models. The output of each step may be passed to the next step until a final result is produced and returned to the client. In some variations, workflows may be grouped by persona, and each persona group may be exposed through a distinct MCP endpoint.

In some embodiments, persona-specific toolkits are constructed to group related tools into coherent collections tailored for particular user roles. For example, a toolkit for software developers may include tools that query source code repositories, analyze diffs, and identify subject matter experts. In such embodiments, when a client invokes a tool like “analyze diff,” the server retrieves the code snippet provided as input, runs a code analysis module to determine the context, queries a repository index to find related documents, and generates a structured report. In alternative embodiments, a project management toolkit may include tools that transform design documents into implementation roadmaps. In this case, a workflow tool may parse a requirements document, extract high-level features, decompose them into tasks, assign ownership metadata, and return an ordered implementation plan. By organizing tools into persona-specific toolkits, the server allows external clients to access role-optimized functionality, increasing efficiency and relevance.

In some embodiments, the system also acts as an MCP host, enabling its AI assistant component to consume external MCP servers. For instance, when a user requests an action outside of the server's native capabilities, such as creating a task in a third-party project management tool, the host component may consult its registry of connected external MCP servers. Upon locating an appropriate server, the host establishes a connection using stored credentials or OAuth tokens. The host then constructs a standardized request message containing the task details, transmits the message to the external server, and awaits the response. The external server executes the action, such as creating the task in the project management system, and returns a confirmation message. The host receives this confirmation and incorporates it into its response back to the user. In this manner, the system orchestrates tasks across both its own MCP tools and those of external providers.

In some embodiments, administrators configure connections to external MCP servers using a graphical user interface provided by the host. The interface may allow the administrator to enter the server's URL, specify authentication details such as client IDs and secrets, and select which external tools are made available. Once configured, the host stores the connection details in a secure credential vault. When a client request requires invoking an external tool, the host retrieves the relevant credentials, obtains an access token if necessary, and establishes a secure session with the external server. In some variations, the host supports multiple authentication schemes, including OAuth, API keys, and certificate-based authentication.

In some embodiments, the system supports real-time communication with external servers through server-sent events or WebSockets. In such embodiments, the host subscribes to an event stream from the external server. When the external server pushes updates, such as status notifications or results of long-running workflows, the host receives the updates in real time and incorporates them into its processing pipeline. This event-driven model allows the host to orchestrate workflows across multiple MCP servers in a responsive and efficient manner.

In some embodiments, the system provides mechanisms for tool discovery and compatibility management. The MCP server may expose a discovery endpoint that returns metadata describing the available tools, including their names, input parameters, supported data types, and expected outputs. Clients may call the discovery endpoint at runtime to determine what functionality is available. In some variations, the metadata may include version information, allowing clients to adjust their behavior based on the version of the tool. In other embodiments, the system supports compatibility layers that map older client requests to newer tool definitions, thereby ensuring backward compatibility.

In some embodiments, the system includes monitoring and governance components. Each tool invocation may be logged with metadata including the requesting client's identity, the tool invoked, input parameters, timestamps, and outcomes. These logs may be stored in secure audit repositories. In some variations, administrators may define policies that restrict which tools can be invoked by which clients, with the server enforcing these policies at runtime. In further variations, quotas may be imposed on clients or tenants to control resource consumption, with quota enforcement carried out by a resource manager module integrated with the MCP server.

In some embodiments, the system includes resilience features. When an external MCP server fails to respond within a timeout period, the host may retry the request, failover to a backup server, or queue the request for later execution. In some variations, the host may return a partial result to the client, indicating that some parts of the workflow succeeded while others are pending. These mechanisms ensure robustness in distributed environments where external dependencies may be unreliable.

Although some embodiments are described largely in the context of a system, method, or in some other way, readers will recognize that embodiments of the present disclosure may also take the form of a computer program product disposed upon computer readable storage media for use with any suitable processing system. Such computer readable storage media may be any storage medium for machine-readable information, including magnetic media, optical media, solid-state media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps described herein as embodied in a computer program product, where the computer program product has computer program instructions stored therein for execution by an appropriate system, device, processor, virtual execution environment, and so on. Persons skilled in the art will recognize also that, although some of the embodiments described in this specification are oriented to software installed and executing on computer hardware, nevertheless, alternative embodiments implemented as firmware or as hardware are well within the scope of the present disclosure.

Readers will appreciate that some embodiments are described in which computer program instructions are executed on computer hardware such as, for example, one or more computer processors. Readers will appreciate that in other embodiments, computer program instructions may be executed on virtualized computer hardware (e.g., one or more virtual machines), in one or more containers, in one or more cloud computing instances (e.g., one or more AWS EC2 instances), in one or more serverless compute instances offered such as those offered by a cloud service provider, in one or more event-driven compute services such as those offered by a cloud service provider, or in some other execution environment.

In some examples, a computer-readable storage device storing computer-readable instructions may be provided in accordance with the principles described herein. The instructions, when executed by a processor of a computing device, may direct the processor and/or computing device to perform one or more operations, including one or more of the operations described herein. Such instructions may be stored and/or transmitted using any of a variety of known computer-readable media.

A computer-readable storage device as referred to herein may include any non-transitory storage medium that participates in providing data (e.g., instructions) that may be read and/or executed by a computing device (e.g., by a processor of a computing device). For example, a computer-readable storage device may include any combination of non-volatile storage media and/or volatile storage media. Exemplary non-volatile storage media include read-only memory, flash memory, a solid-state drive, a magnetic storage device (e.g., a hard disk, a floppy disk, magnetic tape, etc.), ferroelectric random-access memory (“RAM”), and an optical disc (e.g., a compact disc, a digital video disc, a Blu-ray disc, etc.). Exemplary volatile storage media include RAM (e.g., dynamic RAM).

One or more embodiments may be described herein with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

While particular combinations of various functions and features of the one or more embodiments are expressly described herein, other combinations of these features and functions are likewise possible. The present disclosure is not limited by the particular examples disclosed herein and expressly incorporates these other combinations.

What is claimed is:

1. A computer-implemented method for agentic information retrieval and synthesis, comprising:
receiving, by an artificial intelligence (AI) agent, a research task specifying an objective requiring synthesis of information from multiple sources;
retrieving, by the AI agent, information responsive to the research task from a plurality of data sources;
generating, by the AI agent, a research output that synthesizes content derived from the retrieved information;
associating content of the research output with citation data that identifies corresponding retrieved information from the plurality of data sources; and
outputting, by the AI agent, the research output including the citation data.

2. The computer-implemented method of claim 1, wherein generating the research output comprises iteratively refining the research output based on one or more intermediate versions of the research output.

3. The computer-implemented method of claim 2, wherein iteratively refining the research output comprises verifying the one or more intermediate versions based on a correspondence between content generated by the AI agent and the retrieved information identified by the citation data.

4. The computer-implemented method of claim 2, wherein iteratively refining the research output comprises detecting hallucinated content generated by the AI agent that is not supported by the retrieved information.

5. The computer-implemented method of claim 2, wherein iteratively refining the research output comprises modifying at least one of: detected hallucinated content or content generated by the AI agent not supported by the citation data.

6. The computer-implemented method of claim 1, further comprising aligning the research output with a policy applicable to the research task.

7. The computer-implemented method of claim 1, wherein the research output is generated using multi-step reasoning.

8. An apparatus for agentic information retrieval and synthesis, comprising:
a memory; and
one or more processing devices, operatively coupled to the memory, the one or more processing devices configured to:
receive, by an artificial intelligence (AI) agent, a research task specifying an objective requiring synthesis of information from multiple sources;
retrieve, by the AI agent, information responsive to the research task from a plurality of data sources;
generate, by the AI agent, a research output that synthesizes content derived from the retrieved information;
associate content of the research output with citation data that identifies corresponding retrieved information from the plurality of data sources; and
output, by the AI agent, the research output including the citation data.

9. The apparatus of claim 8, wherein, to generate the research output, the one or more processing devices are configured to iteratively refine the research output based on one or more intermediate versions of the research output.

10. The apparatus of claim 9, wherein, to iteratively refine the research output, the one or more processing devices are configured to verify the one or more intermediate versions based on a correspondence between content generated by the AI agent and the retrieved information identified by the citation data.

11. The apparatus of claim 9, wherein, to iteratively refine the research output, the one or more processing devices are configured to detect hallucinated content generated by the AI agent that is not supported by the retrieved information.

12. The apparatus of claim 9, wherein, to iteratively refine the research output, the one or more processing devices are configured to modify at least one of: detected hallucinated content or content generated by the AI agent not supported by the citation data.

13. The apparatus of claim 8, wherein the one or more processing devices are configured to align the research output with a policy applicable to the research task.

14. The apparatus of claim 8, wherein the research output is generated using multi-step reasoning.

15. A computer program product for agentic information retrieval and synthesis, the computer program product including a computer readable storage medium storing instructions which, when executed, cause a processing device to:
receive, by an artificial intelligence (AI) agent, a research task specifying an objective requiring synthesis of information from multiple sources;
retrieve, by the AI agent, information responsive to the research task from a plurality of data sources;
generate, by the AI agent, a research output that synthesizes content derived from the retrieved information;
associate content of the research output with citation data that identifies corresponding retrieved information from the plurality of data sources; and
output, by the AI agent, the research output including the citation data.

16. The computer program product of claim 15, wherein, to generate the research output, the instructions, when executed, further cause the processing device to iteratively refine the research output based on one or more intermediate versions of the research output.

17. The computer program product of claim 16, wherein, to iteratively refine the research output, the instructions, when executed, further cause the processing device to verify the one or more intermediate versions based on a correspondence between content generated by the AI agent and the retrieved information identified by the citation data.

18. The computer program product of claim 16, wherein, to iteratively refine the research output, the instructions, when executed, further cause the processing device to detect hallucinated content generated by the AI agent that is not supported by the retrieved information.

19. The computer program product of claim 16, wherein, to iteratively refine the research output, the instructions, when executed, further cause the processing device to modify at least one of: detected hallucinated content or content generated by the AI agent not supported by the citation data.

20. The computer program product of claim 15, wherein the instructions, when executed, further cause the processing device to align the research output with a policy applicable to the research task.
